(19) United States
(12) Patent Application Publication
(10) Pub. No.: US 2025/0004302 A1
(43) Pub. Date: Jan. 2, 2025

(54) PRESBYOPIA-CORRECTING LENS SYSTEM HAVING HYPEROPIC / MYOPIC CORRECTION-DEPENDENT DESIGNS

(71) Applicant: Johnson & Johnson Vision Care, Inc., Jacksonville, FL (US)

(72) Inventors: Derek Nankivil, Jacksonville, FL (US); Julia Zangoulos, Kitchener (CA)

(21) Appl. No.: 18/753,251

(22) Filed: Jun. 25, 2024

Related U.S. Application Data
(60) Provisional application No. 63/523,418, filed on Jun. 27, 2023.

(51) Int. Cl. G02C 7/04

(52) U.S. Cl. CPC G02C 7/044; G02C 2202/24

(57) ABSTRACT

Presbyopia-correcting multifocal contact lens systems having hyperopic/myopic refractive error correction dependent designs. The multifocal contact lenses are part of a multifocal contact lens system (“lens system”) that includes a plurality of myopic-correcting and hyperopic-correcting lenses that each have an add optical zone for presbyopia correction and that can be selected and fitted to a patient wearer based on their refractive error. To improve far-distance vision of hyperopes, the spherical aberration (SPHA) profile, the add optical zone diameter, and/or the add power of the hyperopic-correcting lenses in the lens system are optimized based on hyperope patient characteristics, which may be different than myope patient characteristics used to optimize the myopic-correcting lenses in the lens system. Such design optimizations may also be refractive error dependent for even further enhanced far-distance vision.

### PRIORITY APPLICATION

This application claims priority to U.S. Provisional Patent Application No. 63/523,418, filed Jun. 27, 2024, and entitled “PRESBYOPIA-CORRECTING LENS SYSTEMS HAVING HYPEROPIC/MYOPIC CORRECTION-DEPENDENT DESIGNS,” which is incorporated herein by reference in its entirety.

### FIELD OF THE DISCLOSURE

The field of the disclosure relates to ophthalmic lenses useful for the correction of presbyopia.

### BACKGROUND

As an individual ages, the eye is less able to accommodate or adjust the natural crystalline lens of the eye to focus on objects that are relatively near to the observer. This condition is known as presbyopia. Presbyopia is the gradual loss of the eyes' ability to focus on nearby objects. Similarly, the ability to accommodate is absent in persons who have had their natural lens crystalline removed (e.g., as a result of cataract surgery). Presbyopia usually becomes noticeable in a person's age of early to mid-40s and continues to worsen until around age 55 to 65.

A known method for correction of presbyopia is to use a bifocal or multifocal lens on or in a patient wearer's eyes. A multifocal lens is designed to have particular surface shapes to achieve multiple optical focal distances. Some multifocal lenses are designed to have an extended depth-of-focus (DOF) that “spreads” the focus along a wider range as a single elongated focal point to enhance range of vision or DOF instead of multiple optical focal distances. Multifocal lenses may also have higher intermediate-distance vision performance because of their extended-depth-of-focus (EDOF) with a peak performance for intermediate-distance focused objects.

For example, FIG. 1 is a schematic diagram of an exemplary multifocal lens 100 that has multifocality and an extended EDOF for correction of presbyopia for near-distance vision and correction of intermediate-distance and far-distance vision. The multifocal lens 100 has a center-near add optical zone 102 of diameter D_{CZ} and transition optical zones 104(1)-104(3), each disposed around and extending outward from a center optical axis A₁ of the multifocal lens 100. The add optical zone 102 has an add zone power profile of a paraxial power selected to substantially correct refractive error and an add power to correct presbyopia. The add optical zone 102 may be spherical or have some target spherical aberration that is dependent on the corrective first power in the add optical zone 102. The transitional optical zones 104(1)-104(3) each include a respective refractive error correction power profile for correction of light rays (“light”) passing through the multifocal lens 100 that are different radiuses R_{C} outside of the add optical zone 102 relative to the optical axis A₁. For example, each transitional optical zone 104(1)-104(3) may have a progressive power profile that provides an overall multifocality to the wearer as a function of the distance of a focused object. The second transitional optical zone 104(2) surrounds the first transitional optical zone 104(1). The third transitional optical zone 104(3) surrounds the second transitional optical zone 104(2) and extends to the edge 106 of the optic zone of the multifocal lens 100. The multifocal lens 100 has an overall optic zone diameter Dc.

DOF is a measure of performance used in the optimization of lens designs. DOF is defined as the total range of vergences (accommodative demands) over which performance does not drop by more than 3-lines of visual acuity relative to the peak performance. Thus, lens designs use DOF to deliver adequate near-distance performance while delivering quality vision through focus. For example, FIG. 2A is a diagram of the multifocal lens 100 in FIG. 1 that illustrates its EDOF. As shown in FIG. 2A, light 200 received by the multi-focal lens 100 is refracted and focused at a plurality of focal lengths due to its power profile provided by its multiple optical zones discussed above. The power profile of the multifocal lens 100 is such that the received light 200 is focused over an elongated focal point 202 in an EDOF 204 to enhance range of vision. This is opposed to a single vision lens 206 shown in FIG. 2B that focuses received light 200 to nominally single point 208 with a smaller DOF 210. However, multifocal lens designs typically tradeoff performance among far-distance, intermediate-distance, and near-distance vision. Thus, use of multifocal lenses could result in reduced visual acuity (i.e., image resolution) and image contrast at near-distance vision compared to a single-vision lens with readers.

FIG. 3 is graph 300 illustrating a minimum angular resolution (MAR) curve 302 as a function of viewing distance in diopters (D) for the multifocal lens 100 in FIG. 1 worn in a patient's dominant eye. As shown in the through focus visual performance curve 302 in FIG. 3, the example lens 100 achieves a DOF region 304 between approximately 0.8 and 2.6 D viewing distance and an effective add of approximately 0.8 D.

Broadly, most multifocal and EDOF lens designs can be grouped into one or a combination of two styles: center-near or center-distance designs. Specifically, lens designs adhere to one or some combination of the following design types: ring bifocal, ring multifocal, step bifocal, ramp bifocal, discontinuous asphere, and continuous asphere. Lens fit guides adhere to one or some combination of the following strategies: pure simultaneous vision, modified monovision, or single lens system. In general, lens designs attempt to balance the trade-off between a desire for uncompromised vision through focus and the limits of the human binocular visual system when presented with a simultaneous vision solution.

### SUMMARY OF THE DISCLOSURE

Aspects disclosed herein include presbyopia-correcting multifocal contact lens systems having hyperopic/myopic refractive error correction-dependent designs. Related multifocal contact lens systems and patient fitting methods are also disclosed. The multifocal contact lenses are part of a multifocal contact lens system (“lens system”) that includes a plurality of refractive error correction-dependent multifocal contact lenses that can be selected and fitted to a patient wearer based on their refractive error. As discussed in more detail below, the contact lens designs differ by effective add/or depth-of-focus (DOF) between myopic and hyperopic refractive error, where those refraction-dependent differences are driven by differences in the ocular optics and visual diet of myopes and hyperopes. For example, if a patient is a myope, multifocal contact lenses from among the available lenses in the lens system can be selected for the patient's oculus dexter (OD) and oculus sinister (OS) based on their myopic refractive error. Likewise, if a patient is a hyperope, multifocal contact lenses from among the available lenses in the lens system can be selected for the patient's OD and OS based on their hyperopic refractive error. The multifocal contact lenses can also include a center add optical zone and surrounding transitional optical zones that provide an additional add power to deliver an effective add to the refractive error correction to correct presbyopia.

It has been found that hyperopes fitted with correction lenses sometimes feel their far-distance vision is compromised due to having a natural higher expectation of superior far-distance vision than myopes. This is because, typically, myopes have already experienced compromised far-distance vision due to their natural refractive error over a period of time in their life and over a number of successive refraction error corrections (i.e., refractive error correction prescriptions). Myopes may not have the same expectation of corrected far-distance vision with a multifocal contact lens as hyperopes. It has also been discovered that hyperopes generally have more positive spherical aberration (SPHA) than myopes. However, if, for example, both the myopic and hyperopic-correcting lenses in the lens system were designed to the target residual SPHA generally observed in myopes, then the hyperopic-correcting lenses will result in more residual SPHA in the average hyperope. This can result in compromised far-distance vision in the hyperope fitted with the hyperopic-correcting lenses in the lens system compared to myopes fitted with myopic-correcting lenses in the same lens system. Thus, in one exemplary aspect, the hyperopic-correcting lenses in the lens system are designed with a SPHA that is more negative as compared to the SPHA in the myopic-correcting lenses in the same lens system. For example, the hyperopic-correcting lenses in the lens system may be designed to have a SPHA that is 10-20% more negative than the SPHA in the myopic-correcting lenses in the same lens system. In this manner, the SPHA in the multifocal contact lenses in the lens system are myopic/hyperopic correction dependent to be better matched to the target residual SPHA of myopes and hyperopes.

It has been further discovered that not only do hyperopes generally have more positive ocular SPHA than myopes, but that ocular SPHA may further increase in hyperopes as a function of the increase in refractive error. Thus, in other exemplary aspects, the SPHA in the hyperopic-correcting lenses in the lens system can be refractive error correction dependent (i.e., refractive error correction prescription or refractive error correction label power dependent) for even further optimization for enhanced far-distance vision. The SPHA of the hyperopic-correcting lenses being refractive error correction dependent means that the SPHA further varies between different hyperopic error corrections within the different hyperopic-correcting lenses in the lens system. For example, the SPHA of hyperopic-correcting lenses in a multifocal contact lens system can be designed to add more negative SPHA to the hyperopic-correcting lenses as the hyperopic refractive error correction of the hyperopic-correcting lenses increase in diopter. The SPHA of the myopic-correcting lenses in a multifocal contact lens system can also be made to be refractive error correction dependent to enhance far-distance vision. For example, the SPHA in the myopic-correcting lenses can be designed to add more negative SPHA to the myopic-correcting lenses as the myopic refractive error correction prescription of the myopia-correcting lenses increases in diopter (that is, as the refractive error correction prescription becomes increasingly negative).

For all patients, whether myopes or hyperopes, their pupil size constricts when a person focuses on near-distance objects, and their pupil size dilates when a person focuses on longer-distance objects. However, it has been recognized that hyperopes generally have smaller pupils than myopes for the same or similar conditions of luminance, spherical refraction, age, and vergence. If, for example, both the myopic and hyperopic-correcting lenses in the lens system were both designed with a center optical zone modeled on the average pupil size of myopes for presbyopia correction, this may provide a more compromised far-distance vision for hyperopes as compared to myopes wearing multifocal contact lenses from the same lens system with the same or similar add power. This is due to the larger diameter add zone in the multifocal contact lenses (modeled on myope pupil size) intersecting a greater percentage of a hyperope's pupil as compared to a myope's pupil when focused on far-distance objects and both wearing multifocal lenses from the lens system. Thus, a hyperope's pupil, being of an average smaller size than myopes, may receive less light into their pupil from the transitional zones of the multifocal contact lens that provide multifocality than a myope wearing a multifocal lens from the lens system.

Thus, in other exemplary aspects, the hyperopic-correcting lenses in the lens system are designed with a center-near add optical zone having a smaller, optimized diameter as compared to myopic-correcting multifocal lenses in the lens system. This myopic/hyperopic refractive error-correction dependent optimized diameter of the center-near add optical zone in the hyperopic-correcting multifocal lenses provides for an increased percentage of light to be received in the hyperope's pupil through the transitional optical zones when focused on far-distance objects.

In yet other exemplary aspects, the diameter of the center-near add optical zone in the hyperopic-correcting lenses in the lens system can be refractive error correction dependent for even further optimization for enhanced far-distance vision. The diameter of the center-near add optical zone of the hyperopic-correcting lenses being refractive error correction dependent means that the diameter of the center-near add optical zone further varies between different hyperopic error corrections within the different hyperopic-correcting lenses in the lens system. For example, it has been discovered that the pupil size in hyperopes gets smaller as hyperopic refractive error increases. Thus, as an example, the diameter of the center-near add optical zone of the hyperopic-correcting lenses can be designed such that the center-near add optical zone decreases in diameter as the hyperopic refractive error correction prescription of the hyperopic-correcting lenses increases in diopter. The diameter of the center-near add optical zone of the myopic-correcting lenses in the lens system can also be made to be refractive error correction dependent. For example, it has been discovered that the pupil size in myopes gets larger as myopic refractive error increases (that is, as refractive error correction becomes increasingly negative). Thus, as an example, the diameter of the center-near add optical zone of the myopic-correcting lenses can be designed such that the center-near add optical zone increases in diameter as the myopic refractive error correction prescription of the myopic-correcting lenses decreases in diopter.

Furthermore, it has been discovered that, in general, myopes and hyperopes have differences in the distribution of add power need. A higher proportion of hyperopes are fitted with high-add power lenses as compared to myopes of the same or similar age. Thus, a hyperope with a higher add power may experience more compromised far-distance vision as compared to a myope. Also, as discussed above, a hyperope may already have a natural disposition of feeling that their far-distance vision has been compromised when fitted with presbyopia-correcting lenses due to a greater expectation of superior far-distance vision than myopes. Thus, in exemplary aspects, to improve the far-distance vision of the hyperope, the effective add power in the hyperopic-correcting multifocal lenses in the multifocal contact lens system is reduced as compared to the effective add power in the myopic-correcting multifocal lenses in the same lens system for a given label add power. Also, it may be desired to only reduce the effective add power in specific effective add power ranges of the hyperopic-correcting multifocal lenses to improve far-distance vision, taking advantage of the binocular disparity between a patient's dominant and non-dominant eye. For example, the effective add power may be reduced in the mid-add label add power (e.g., add need of +1.5 to +1.75 D) hyperopic-correcting multifocal lenses by 0.3 D and reduced in the high-add label add power (e.g., add need of +2.0 to +2.5 D) hyperopic-correcting multifocal lenses by 0.2 D, as non-limiting examples. The effective add power in the hyperopic-correcting multifocal lenses in the lens system can be provided by adjusting its paraxial power and aspheric constants.

Additional features and advantages will be set forth in the detailed description which follows and, in part, will be readily apparent to those skilled in the art from the description or recognized by practicing the aspects as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings illustrate one or more aspects and, together with the description, serve to explain the principles and operation of the various aspects.

### BRIEF DESCRIPTION OF THE FIGURES

The foregoing and other features and advantages of the disclosure will be apparent from the following, more particular descriptions of the aspects of the disclosure, as illustrated in the accompanying drawings.

FIG. 1 is a schematic diagram of an exemplary multifocal lens that has a center-near add optical zone and transition zones and exhibits extended-depth-of-focus (EDOF) and can be worn by a contact lens wearer for correction of presbyopia for near-distance vision and correction of intermediate-distance and far-distance vision through multifocality and EDOF;

FIG. 2A is a diagram of the multifocal lens in FIG. 2A designed to provide multifocality with an EDOF;

FIG. 2B is a diagram of a lens designed to provide multifocality with a depth-of-focus (DOF);

FIG. 3 is a graph illustrating minimum angular resolution (MAR) as a function of viewing distance in diopters (D) for the lens having its DOF in FIG. 1A and the lens in FIG. 1B having its EDOF;

FIG. 4 illustrates an exemplary multifocal contact lens system that includes a respective myopic-correcting lens and hyperopic-correcting lens, each having an effective add power;

FIGS. 5A-5C are exemplary graphs that each include a plurality of myopic power profiles and hyperopic power profiles for a plurality of the myopic-correcting lenses and a plurality of hyperopic-correcting lenses in FIG. 4 for respective label add powers of +0.75 diopters (D), +1.25 D, and +1.75 D;

FIGS. 6A-6C are exemplary plots of cyclopean visual performance as a function of luminance and vergence (in diopters) of different myopic refractive error correction prescriptions in myopic-correcting lenses represented by the respective myopic power profiles in FIG. 5A for a label add power of +0.75 D;

FIGS. 6D-6F are exemplary plots of cyclopean visual performance as a function of luminance and vergence (in diopters) of different hyperopic refractive error correction prescriptions in hyperopic-correcting lenses represented by the respective hyperopic power profiles in FIG. 5A for a label add power of +0.75 D;

FIGS. 7A-7C are exemplary plots of cyclopean visual performance as a function of luminance and vergence (in diopters) of different myopic refractive error correction (i.e., label power) myopic-correcting lenses represented by the respective myopic power profiles in FIG. 5B for a label add power of +1.75 D;

FIGS. 7D-7F are exemplary plots of cyclopean visual performance as a function of luminance and vergence (in diopters) of different hyperopic refractive error correction (i.e., label power) hyperopic-correcting lenses represented by the respective myopic power profiles in FIG. 5B for a label add power of +1.75 D;

FIGS. 8A-8C are exemplary plots of cyclopean visual performance as a function of luminance and vergence (in diopters) of different myopic refractive error correction (i.e., label power) myopic-correcting lenses represented by the respective myopic power profiles in FIG. 5C for a label add power of +2.5 D;

FIGS. 8D-8F are exemplary plots of cyclopean visual performance as a function of luminance and vergence (in diopters) of different hyperopic refractive error correction (i.e., label power) hyperopic-correcting lenses represented by the respective myopic power profiles in FIG. 5C for a label add power of +2.5 D;

FIGS. 9A and 9B are graphs illustrating mean ocular spherical aberration (SPHA) in respective myopes and hyperopes as a function of refractive error correction prescription (Rx) and add power need, where add power need increases with age;

FIGS. 10A and 10B are graphs illustrating entrance pupil diameter in respective myopes and hyperopes as a function of spherical refraction and add power need, where add power need increases with age;

FIG. 11 illustrates an exemplary multifocal contact lens system that includes a respective myopic-correcting lenses and hyperopic-correcting lenses, each having an effective add power, wherein the hyperopic-correcting lenses have at least one of the following characteristics: the hyperopic-correcting lenses are designed with a SPHA that is more negative as compared to the SPHA in the myopic-correcting lenses, the hyperopic-correcting lens is designed with a center-near add optical zone having a smaller, optimized diameter as compared to myopic-correcting multifocal lenses, the effective add power in the hyperopic-correcting multifocal lens is reduced as compared to the effective add power in the myopic-correcting multifocal lens in the same lens system for a given label add power to improve longer-distance vision with the hyperopic-correcting multifocal lens;

FIG. 12 illustrates an exemplary myopic-correcting multifocal lens and hyperopic multifocal lens in the multifocal contact lens pair system in FIG. 11, as worn by a respective myope and hyperope contact lens wearer, illustrating the relative diameter of the center optical zones, and transitional optical zone(s) of the contact lenses, as compared to the constricted pupil of the respective myope and hyperope contact lens wearer when focusing on a near-distance object;

FIGS. 13A-13C are exemplary myopic power profiles for a plurality of myopic-correcting lenses designed according to the design principles of the myopic-correcting lens in FIG. 11, wherein each myopic power profile illustrates myopic power profiles for a plurality of myopic refractive error corrections and respective low, mid, and high effective add powers;

FIGS. 13D-13F are exemplary hyperopic power profiles for a plurality of hyperopic-correcting lenses designed according to the design principles of the hyperopic-correcting lens in FIG. 11, wherein each hyperopic power profile illustrates hyperopic power profiles for a plurality of hyperopic refractive error corrections and respective low, mid, and high effective add powers that differs from the respective power profiles in FIGS. 13A-13C;

FIGS. 14A-14D are tables illustrating respective monocular effective add powers (in diopters) of a hyperopic-correcting lens with a hyperopic refractive error correction (i.e., label power) of +2.0 D represented by respective hyperopic power profiles in FIGS. 13D-13F, for respective luminances;

FIGS. 15A-15C are exemplary plots of cyclopean visual performance as a function of luminance and vergence (in diopters) of myopic-correcting lenses with different myopic refractive error corrections (i.e., label powers) represented by the respective myopic power profiles in FIG. 13A for a label add power of +0.75 D;

FIGS. 15D-15F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13D for a label add power of +0.75 D;

FIGS. 16A-16C are exemplary plots of cyclopean visual performance as a function of luminance and vergence (in diopters) of myopic-correcting lenses with different myopic refractive error corrections (i.e., label powers) represented by the respective myopic power profiles in FIG. 13A for a label add power of +1.0 D;

FIGS. 16D-16F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13D for a label add power of +1.0 D;

FIGS. 17A-17C are exemplary plots of cyclopean visual performance as a function of luminance and vergence (in diopters) of myopic-correcting lenses with different myopic refractive error corrections (i.e., label powers) represented by the respective myopic power profiles in FIG. 13A for a label add power of +1.25 D;

FIGS. 17D-17F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13D for a label add power of +1.25 D;

FIGS. 18A-18C are exemplary plots of cyclopean visual performance as a function of luminance and vergence (in diopters) of myopic-correcting lenses with different myopic refractive error corrections (i.e., label powers) represented by the respective myopic power profiles in FIG. 13B for a label add power of +1.5 D;

FIGS. 18D-18F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13E for a label add power of +1.5 D;

FIGS. 19A-19C are exemplary plots of cyclopean visual performance as a function of luminance and vergence (in diopters) of myopic-correcting lenses with different myopic refractive error corrections (i.e., label power) represented by the respective myopic power profiles in FIG. 13B for a label add power of +1.75 D;

FIGS. 19D-19F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13E for a label add power of +1.75 D;

FIGS. 20A-20C are exemplary plots of cyclopean visual performance as a function of luminance and vergence (in diopters) of myopic-correcting lenses with different myopic refractive error corrections (i.e., label powers) represented by the respective myopic power profiles in FIG. 13C for a label add power of +2.0 D;

FIGS. 20D-20F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13F for a label add power of +2.0 D;

FIGS. 21A-21C are exemplary plots of cyclopean visual performance as a function of luminance and vergence (in diopters) of myopic-correcting lenses with different myopic refractive error corrections (i.e., label powers) represented by the respective myopic power profiles in FIG. 13C for a label add power of +2.25 D;

FIGS. 21D-21F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13F for a label add power of +2.25 D;

FIGS. 22A-22C are exemplary plots of cyclopean visual performance as a function of luminance and vergence (in diopters) of myopic-correcting lenses with different myopic refractive error corrections (i.e., label powers) represented by the respective myopic power profiles in FIG. 13C for a label add power of +2.5 D;

FIGS. 22D-22F are exemplary plots of cyclopean visual performance as a function of luminance and vergence (in diopters) of hyperopic-correcting lenses with different hyperopic refractive error corrections (i.e., label powers) represented by the respective myopic power profiles in FIG. 13F for a label add power of +2.5 D;

FIGS. 23A-23C are exemplary plots of the difference in cyclopean visual performance as a function of luminance and vergence (in diopters) between (1) low-add myopic-correcting lenses with different myopic refractive error corrections (i.e., label powers) represented by the respective low-add myopic power profiles in FIG. 13A for a low-add label add power of +0.75 D; and (2) visual performance for corresponding low-add myopic-correcting lenses of the myopic refractive error corrections (i.e., label powers) shown in respective FIGS. 6A-6C for a low-add label add power of +0.75 D;

FIGS. 23D-23F are exemplary plots of the difference in cyclopean visual performance as a function of luminance and vergence (in diopters) between (1) low-add hyperopic-correcting lenses with different hyperopic refractive error corrections (i.e., label powers) represented by the respective low-add hyperopic power profiles in FIG. 13D for a low-add label add power of +0.75 D; and (2) visual performance for corresponding low-add hyperopic-correcting lenses of the hyperopic refractive error corrections (i.e., label powers) shown in respective FIGS. 6D-6F for a low-add label add power of +0.75 D;

FIGS. 24A-24C are exemplary plots of the difference in cyclopean visual performance as a function of luminance and vergence (in diopters) between (1) low-add myopic-correcting lenses with different myopic refractive error corrections (i.e., label powers) represented by the respective mid-add myopic power profiles in FIG. 13B for a mid-add label add power of +1.75 D; and (2) visual performance for corresponding mid-add myopic-correcting lenses of the myopic refractive error corrections (i.e., label powers) shown in respective FIGS. 7A-7C for a mid-add label add power of +1.75 D;

FIGS. 24D-24F are exemplary plots of the difference in cyclopean visual performance as a function of luminance and vergence (in diopters) between (1) mid-add hyperopic-correcting lenses with different hyperopic refractive error corrections (i.e., label powers) represented by the respective mid-add hyperopic power profiles in FIG. 13E for a mid-add label add power of +1.75 D; and (2) visual performance for corresponding mid-add hyperopic-correcting lenses of the hyperopic refractive error corrections (i.e., label powers) shown in respective FIGS. 7D-7F for a mid-add label add power of +1.75 D;

FIGS. 25A-25C are exemplary plots of the difference in cyclopean visual performance as a function of luminance and vergence (in diopters) between (1) myopic-correcting lenses with different myopic refractive error corrections (i.e., label powers) represented by the respective high-add myopic power profiles in FIG. 13C for a label add power of +2.5 D; and (2) visual performance for corresponding high-add myopic-correcting lenses of the myopic refractive error corrections (i.e., label powers) shown in respective FIGS. 8A-8C for a label add power of +2.5 D;

FIGS. 25D-25F are exemplary plots of the difference in cyclopean visual performance as a function of luminance and vergence (in diopters) between (1) hyperopic-correcting lenses with different hyperopic refractive error corrections (i.e., label powers) represented by the respective high-add hyperopic power profiles in FIG. 13F for a high-add label add power of +2.5 D; and (2) visual performance for corresponding high-add hyperopic-correcting lenses of the hyperopic refractive error corrections (i.e., label powers) shown in respective FIGS. 8D-8F for a high-add label add power of +2.5 D;

FIG. 26 is an exemplary lens fitting guide 2600 that can be used to fit a patient with multifocal contact lenses from the multifocal contact lenses pair system in FIG. 11 and represented by the myopic and hyperopic power profiles in FIGS. 13A-13F, based on the patient's refractive error corrective prescription and add power need;

FIG. 27 illustrates another exemplary multifocal contact lens system that includes a respective myopic-correcting lens and hyperopic-correcting lens, each having an effective add power and that are based on design principles in the multifocal contact lens system in FIG. 11, but wherein the myopic and/or hyperopic-correcting lenses has at least one of the following characteristics: a refractive error correction dependent SPHA, refractive error correction dependent center add optical zone diameter, and the effective add power in the hyperopic-correcting multifocal lens is reduced as compared to the effective add power in the myopic-correcting multifocal lens in the same lens system for a given label add power to improve longer-distance vision with the hyperopic-correcting multifocal lens;

FIGS. 28A-28C are respective exemplary low-add, mid-add, and high-add myopic power profiles for a plurality of respective low-add, mid-add, and high-add myopic-correcting lenses designed according to the design principles of the myopic-correcting lens in FIG. 11;

FIGS. 28D-28F are respective exemplary low-add, mid-add, and high-add hyperopic power profiles for a plurality of low-add, mid-add, and high-add hyperopic-correcting lenses designed according to the design principles of the hyperopic-correcting lens in FIG. 11, but wherein such design principles are also dependent on a specific hyperopic refractive error correction, and wherein each hyperopic power profile illustrates hyperopic power profiles for a plurality of the hyperopic refractive error corrections and an effective add power that differs from the respective power profiles in FIGS. 28A-28C;

FIGS. 29A-29C are exemplary plots of cyclopean visual performance shown as a function of luminance and vergence (in diopters) of low-add myopic-correcting lenses with different myopic refractive error corrections (i.e., label powers) represented by the low-add respective myopic power profiles in FIG. 28A for a low-add label add power of +0.75 D;

FIGS. 29D-29F are exemplary plots of cyclopean visual performance shown as a function of luminance and vergence (in diopters) of low-add hyperopic-correcting lenses with different hyperopic refractive error corrections (i.e., label powers) represented by the respective low-add hyperopic power profiles in FIG. 28D for a low-add label add power of +0.75 D;

FIGS. 30A-30C are exemplary plots of cyclopean visual performance shown as a function of luminance and vergence (in diopters) of low-add myopic-correcting lenses with different myopic refractive error corrections (i.e., label powers) represented by the respective low-add myopic power profiles in FIG. 28A for a low-add label add power of +1.0 D;

FIGS. 30D-30F are exemplary plots of cyclopean visual performance shown as a function of luminance and vergence (in diopters) of low-add hyperopic-correcting lenses with different hyperopic refractive error corrections (i.e., label powers) represented by the respective low-add hyperopic power profiles in FIG. 28D for a low-add label add power of +1.0 D;

FIGS. 31A-31C are exemplary plots of cyclopean visual performance shown as a function of luminance and vergence (in diopters) of low-add myopic-correcting lenses with different myopic refractive error corrections (i.e., label powers) represented by the respective low-add myopic power profiles in FIG. 28A for a low-add label add power of +1.25 D;

FIGS. 31D-31F are exemplary plots of cyclopean visual performance shown as a function of luminance and vergence (in diopters) of hyperopic-correcting low-add multifocal contact lenses with different hyperopic refractive error corrections (i.e., label powers) represented by the respective mid-add hyperopic power profiles in FIG. 28D for a low-add label add power of +1.25 D;

FIGS. 32A-32C are exemplary plots of cyclopean visual performance shown as a function of luminance and vergence (in diopters) of mid-add myopic-correcting lenses with different myopic refractive error corrections (i.e., label powers) represented by the respective mid-add myopic power profiles in FIG. 28B for a mid-add label add power of +1.5 D;

FIGS. 32D-32F are exemplary plots of cyclopean visual performance shown as a function of luminance and vergence (in diopters) of mid-add hyperopic-correcting lenses with different hyperopic refractive error corrections (i.e., label powers) represented by the respective mid-add hyperopic power profiles in FIG. 28E for a mid-add label add power of +1.5 D;

FIGS. 33A-33C are exemplary plots of cyclopean visual performance shown as a function of luminance and vergence (in diopters) of mid-add myopic-correcting lenses with different myopic refractive error corrections (i.e., label powers) represented by the respective mid-add myopic power profiles in FIG. 28B for a mid-add label add power of +1.75 D;

FIGS. 33D-33F are exemplary plots of cyclopean visual performance shown as a function of luminance and vergence (in diopters) of mid-add hyperopic-correcting lenses with different hyperopic refractive error corrections (i.e., label powers) represented by the respective mid-add hyperopic power profiles in FIG. 28E for a mid-add label add power of +1.75 D;

FIGS. 34A-34C are exemplary plots of cyclopean visual performance shown as a function of luminance and vergence (in diopters) of high-add myopic-correcting lenses with different myopic refractive error corrections (i.e., label powers) represented by the respective high-add myopic power profiles in FIG. 28C for a high-add label add power of +2.0 D;

FIGS. 34D-34F are exemplary plots of cyclopean visual performance shown as a function of luminance and vergence (in diopters) of high-add hyperopic-correcting lenses with different hyperopic refractive error corrections (i.e., label powers) represented by the respective high-add hyperopic power profiles in FIG. 28F for a high-add label add power of +2.0 D;

FIGS. 35A-35C are exemplary plots of cyclopean visual performance shown as a function of luminance and vergence (in diopters) of high-add myopic-correcting lenses with different myopic refractive error corrections (i.e., label powers) represented by the respective high-add myopic power profiles in FIG. 28C for a high-add label add power of +2.25 D;

FIGS. 35D-35F are exemplary plots of cyclopean visual performance shown as a function of luminance and vergence (in diopters) of high-add hyperopic-correcting lenses with different hyperopic refractive error corrections (i.e., label powers) represented by the respective hyperopic power profiles in FIG. 28F for a high-add label add power of +2.25 D;

FIGS. 36A-36C are exemplary plots of cyclopean visual performance shown as a function of luminance and vergence (in diopters) of high-add myopic-correcting lenses with different myopic refractive error corrections (i.e., label powers) represented by the respective high-add myopic power profiles in FIG. 28C for a high-add label add power of +2.5 D;

FIGS. 36D-36F are exemplary plots of cyclopean visual performance shown as a function of luminance and vergence (in diopters) of hyperopic-correcting high-add multifocal contact lenses with different hyperopic refractive error corrections (i.e., label powers) represented by the respective high-add hyperopic power profiles in FIG. 28F for a high-add label add power of +2.5 D;

FIGS. 37A-37C are exemplary graphs that each include the respective low-add, mid-add, and high-add hyperopic power profiles for the multifocal contact lens system in FIG. 11, which are constant across hyperopia refractive error corrections and thus not dependent on either hyperopia refractive error correction or refractive error correction, plotted with the respective low-add, mid-add, and high-add hyperopic power profiles for the multifocal contact lens system in FIG. 27 that are refractive error correction dependent;

FIGS. 38A-38D are bar graphs that each include monocular effective add power for different low-, mid-, and high-add power lenses at different respective luminance levels for different multifocal contact lens systems in FIGS. 4, 11, and 27, represented by the respective power profiles in FIGS. 5A-5C, 13A-13F, and 28A-28F;

FIGS. 39A-39D are bar graphs that each include monocular DOFs for different low-, mid-, and high-add power lenses at different respective luminance levels for different multifocal contact lens systems in FIGS. 4, 11, and 27 represented by the respective power profiles in FIGS. 5A-5C, 13A-13F, and 28A-28F.

FIGS. 40A-40C are exemplary plots of the difference in cyclopean visual performance as a function of luminance and vergence (in diopters) between (1) low-add myopic-correcting lenses with different myopic refractive error corrections (i.e., label powers) represented by the respective low-add myopic power profiles in FIG. 28A for a low-add label add power of +0.75 D; and (2) cyclopean visual performance for corresponding low-add myopic-correcting lenses of the myopic refractive error corrections in respective FIGS. 6A-6C for a low-add label add power of +0.75 D;

FIGS. 40D-40F are exemplary plots of the difference in cyclopean visual performance as a function of luminance and vergence (in diopters) between (1) low-add hyperopic-correcting lenses with different hyperopic refractive error corrections (i.e., label powers) represented by the respective low-add hyperopic power profiles in FIG. 28D for a low-add label add power of +0.75 D; and (2) cyclopean visual performance for corresponding low-add hyperopic-correcting lenses of the hyperopic refractive error corrections in respective FIGS. 6D-6F for a low-add label add power of +0.75 D;

FIGS. 41A-41C are exemplary plots of the difference in cyclopean visual performance as a function of luminance and vergence (in diopters) between (1) mid-add myopic-correcting lenses with different myopic refractive error corrections (i.e., label powers) represented by the respective mid-add myopic power profiles in FIG. 28B for a mid-add label add power of +1.75 D; and (2) cyclopean visual performance for corresponding mid-add myopic-correcting lenses of the myopic refractive error corrections in respective FIGS. 7A-7C for a mid-add label add power of +1.75 D;

FIGS. 41D-41F are exemplary plots of the difference in cyclopean visual performance as a function of luminance and vergence (in diopters) between (1) mid-add hyperopic-correcting lenses with different hyperopic refractive error corrections (i.e., label powers) represented by the respective mid-add hyperopic power profiles in FIG. 28E for a label add power of +1.75 D; and (2) cyclopean visual performance for corresponding hyperopic-correcting lenses of the hyperopic refractive error corrections in respective FIGS. 7D-7F for a mid-add label add power of +1.75 D;

FIGS. 42A-42C are exemplary plots of the difference in cyclopean visual performance as a function of luminance and vergence (in diopters) between (1) high-add myopic-correcting lenses with different myopic refractive error corrections (i.e., label powers) represented by the respective high-add myopic power profiles in FIG. 28C for a label add power of +2.5 D; and (2) cyclopean visual performance for corresponding high-add myopic-correcting lenses of the myopic refractive error corrections in respective FIGS. 8A-8C for a label add power of +2.5 D; and

FIGS. 42D-42F are exemplary plots of the difference in cyclopean visual performance as a function of luminance and vergence (in diopters) between (1) high-add hyperopic-correcting lenses with different hyperopic refractive error corrections (i.e., label powers) represented by the respective high-add hyperopic power profiles in FIG. 28F for a label add power of +2.5 D; and (2) cyclopean visual performance for corresponding high-add hyperopic-correcting lenses of the hyperopic refractive error corrections in respective FIGS. 8D-8F for a high-add label add power of +2.5 D.

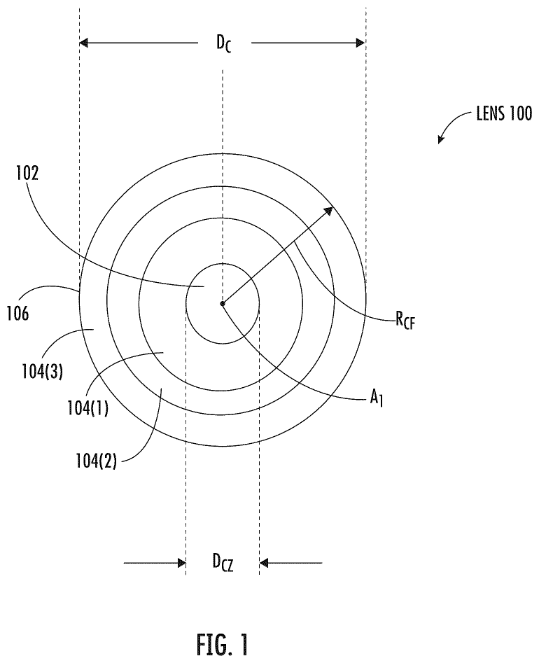

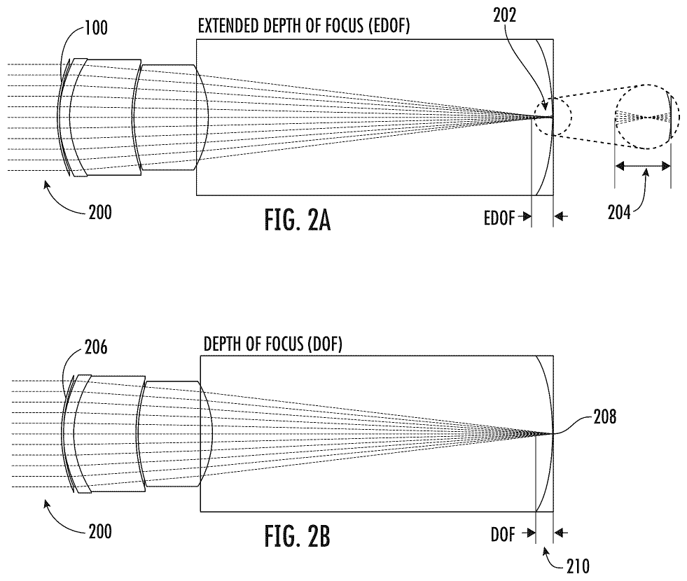

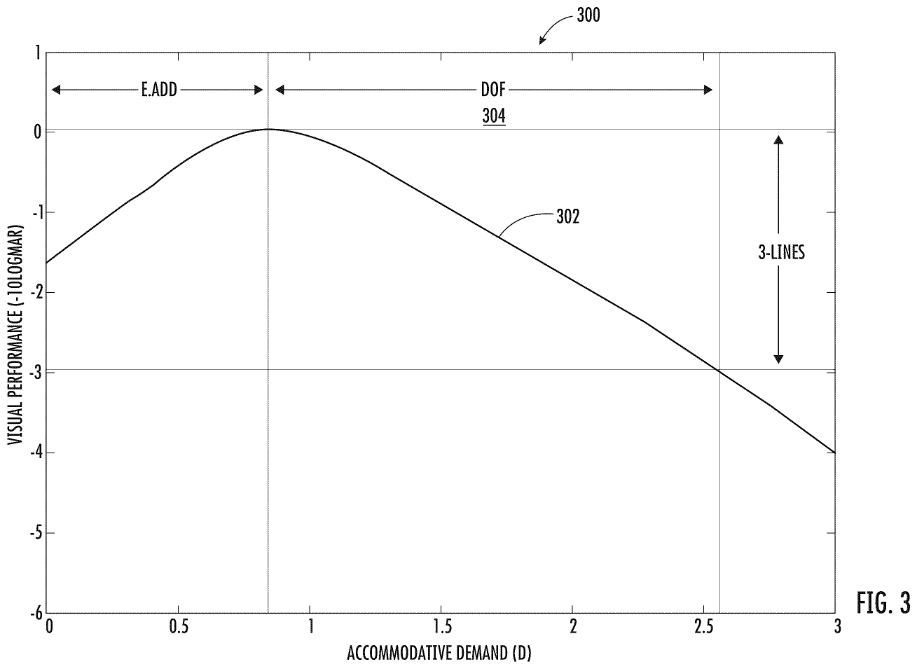

### DETAILED DESCRIPTION

Aspects disclosed herein include presbyopia-correcting multifocal contact lens systems having hyperopic/myopic refractive error correction-dependent designs. Related multifocal contact lens systems and patient fitting methods are also disclosed. The contact lens designs differ by effective add/or DOF between myopic and hyperopic refractive error, where those refraction-dependent differences are driven by differences in the ocular optics and visual diet of myopes and hyperopes. The multifocal contact lenses are part of a multifocal contact lens system (“lens system”) that includes a plurality of refractive error correction-dependent multifocal contact lenses that can be selected and fitted to a patient wearer based on their refractive error. For example, if a patient is a myope, multifocal contact lenses from among the available lenses in the lens system can be selected for the patient's oculus dexter (OD) and oculus sinister (OS) based on their myopic refractive error. Likewise, if a patient is a hyperope, multifocal contact lenses from among the available lenses in the lens system can be selected for the patient's OD and OS based on their hyperopic refractive error. The multifocal contact lenses can also include a center add optical zone and surrounding transitional optical zones that provide an additional add power to deliver an effective add to the refractive error correction to correct for presbyopia.

In certain exemplary aspects, the hyperopic-correcting lenses in the lens system are designed with a spherical aberration (SPHA) that is more negative as compared to the SPHA in the myopic-correcting lenses in the same lens system. For example, the hyperopic-correcting lenses in the lens system may be designed to have an SPHA that is 10-20% more negative than the SPHA in the myopic-correcting lenses in the same lens system. In this manner, the SPHA in the multifocal contact lenses in the lens system are myopic/hyperopic correction dependent to be better matched to the target residual SPHA of myopes and hyperopes. This is in recognition of the discovery that hyperopes generally have more positive SPHA than myopes. This can result in compromised far-distance vision in the hyperope fitted with the hyperopic-correcting lenses in the lens system, as compared to myopes fitted with myopic-correcting lenses in the same lens system. It has also been discovered that hyperopes fitted with correction lenses generally feel their far-distance vision is compromised due to having a natural higher expectation of superior far-distance vision than myopes. This is because, typically, myopes have already experienced compromised far-distance vision due to their natural refractive error over a period of time in their life and over a number of successive refraction error correction prescriptions. Myopes may not have the same expectation of corrected far-distance vision with a multifocal contact lens as hyperopes.

In other exemplary aspects, the hyperopic-correcting lenses in the lens system can be designed with a center-near add optical zone having a smaller, optimized diameter as compared to myopic-correcting multifocal lenses in the lens system. This refractive error correction-dependent optimized diameter of the center-near add optical zone in the hyperopic-correcting multifocal lenses provides for an increased percentage of light to be received in the hyperope's pupil through the transitional optical zones when focused on far-distance objects. This is in recognition of the discovery that hyperopes generally have smaller pupils than myopes for the same or similar conditions of luminance, spherical refraction, age, and vergence. If, for example, both the myopic and hyperopic-correcting lenses in the lens system were both designed with a center optical zone modeled on the average pupil size of myopes for presbyopia correction, this may provide a more compromised far-distance vision for hyperopes as compared to myopes wearing center-near multifocal contact lenses from the same lens system with the same or similar add power.

In other exemplary aspects, to improve the far-distance vision of the hyperope, the effective add power in the hyperopic-correcting multifocal lenses in the multifocal contact lens system can be reduced as compared to the effective add power in the myopic-correcting multifocal lenses in the same lens system for a given label add power prescription. This is in recognition of the discovery that, in general, myopes and hyperopes have differences in the distribution of add power need. A higher proportion of hyperopes are fitted with high-add power lenses as compared to myopes of the same or similar age. Thus, a hyperope with a higher add power may experience more compromised far-distance vision as compared to a myope. Also, as discussed above, a hyperope may already have a natural disposition of feeling that their far-distance vision has been compromised when fitted with presbyopia-correcting lenses due to a greater expectation of superior far-distance vision than myopes. Also, it may be desired to only reduce the effective add power in certain effective add power ranges of the hyperopic-correcting multifocal lenses to improve far-distance vision, taking advantage of the binocular disparity between a patient's dominant and non-dominant eye. For example, the effective add power may be reduced in the mid-add label add power (e.g., add need of +1.5 to +1.75 D) hyperopic-correcting multifocal lenses by 0.3 D and reduced in the high label add power (e.g., add need of +2.0 D to +2.5 D) hyperopic-correcting multifocal lenses by 0.2 D, as non-limiting examples. The effective add power in the hyperopic-correcting multifocal lenses in the lens system can be provided by adjusting its paraxial power and aspheric constants.

Note that presbyopia-correcting multifocal contact lens systems can include some or all of the above-stated characteristics and features.

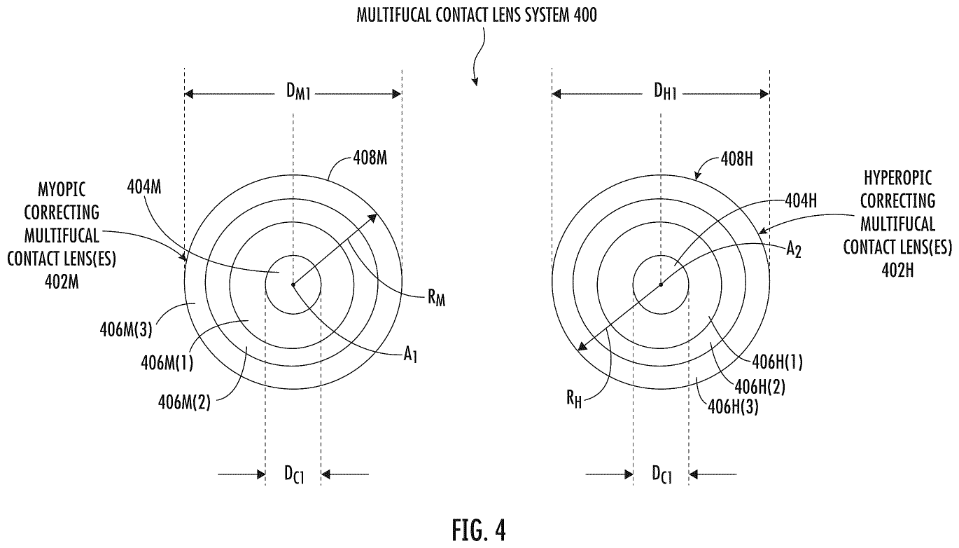

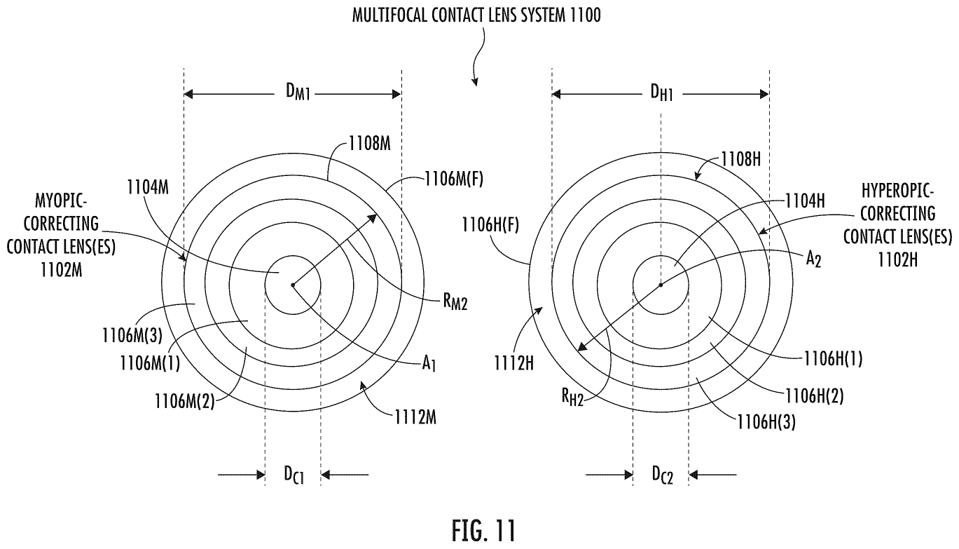

Examples of presbyopia-correcting multifocal contact lens systems having hyperopic-correcting and myopic-correcting lenses that have hyperopic/myopic refractive error correction-dependent designs start at FIG. 11, as discussed below. Before discussing these examples, an exemplary presbyopia-correcting multifocal contact lens system that includes hyperopic-correcting and myopic-correcting multifocal contacts lenses that do not have hyperopic/myopic refractive error correction dependent designs are first discussed below with regard to FIGS. 4-10B.

In this regard, FIG. 4 is an exemplary multifocal contact lens system 400 that includes respective myopic-correcting multifocal lenses 402M (also referred to as “myopic-correcting lenses 402M”) and hyperopic-correcting multifocal lenses 402H (also referred to as “hyperopic-correcting lenses 402H”) each having an effective add power that is designated with a given label add power for correction of presbyopia. In this example, the myopic-correcting lenses 402M and the hyperopic-correcting lenses 402H are multifocal contact lenses. Note that although only one (1) myopic-correcting lens 402M and one (1) hyperopic-correcting lens 402H are shown in FIG. 4, the multifocal contact lens system 400 includes a plurality of the myopic-correcting lenses 402M, each with a different myopic refractive error correction indicated by a different myopic refractive error correction prescription (e.g., −1 D, −2 D, −3 D . . . , −9 D) and for different label add powers, and a plurality of the hyperopic-correcting lenses 402H each with a different hyperopic refractive error correction prescription (e.g., +1 D, +2 D, +3 D . . . , +9 D) and for different label add powers. In this manner, one or more myopic-correcting lenses 402M and/or one or more hyperopic-correcting lenses 402H can be selected for a patient's OD and OS based on the refractive error in their eyes to provide refractive error correction for corrected vision with multifocality and presbyopia correction.

The myopic-correcting and hyperopic-correcting lenses 402M, 402H provide multifocality with corrected presbyopia for near-distances vision. In this regard, as shown in FIG. 4, the myopic-correcting lens 402M has a myopic power profile that is provided by a first add optical zone 404M and first transitional optical zones 406M(1)-406M(3) surrounding the first add optical zone 404M. The first add optical zone 404M is a center-near optical zone in this example that is disposed around a first optical axis A₁ and has first add zone power profile as part of the myopic power profile of the myopic-correcting lens 402M that has myopic paraxial power selected to substantially correct myopic refractive error for distance vision (e.g., at 0 or 0.25 D) for a wearer according to their refractive error correction prescription and a first add power to correct for presbyopia. The first add optical zone 404M has a first add zone diameter D_{C1} that is sized based on the anticipated pupil constriction due to pupil miosis when a wearer is focused on a near-distance object (e.g., at 2.5 D) to enhance presbyopia correction. In this manner, a greater percentage of light passes into the wearer's pupil from the first add optical zone 404M having the first add power when the wearer is focused on a near-distance object. The first add optical zone 404M may be spherical or have some target spherical aberration that is dependent on the myopic paraxial power in the first add optical zone 404M. In this example, there are three (3) first transitional optical zones 406M(1)-406M(3). The first transitional optical zones 406M(1)-406M(3) surround the first add optical zone 404M about the first optical axis A₁, and each includes respective myopic progressive power profiles as part of the overall myopic power profile for the myopic-correcting lens 402M. The myopic power profile is comprised of the first add zone power profile, and the myopic progressive power profile includes a first spherical aberration (SPHA) to provide correction of myopic refractive error.

With continuing reference to FIG. 4, the first transitional optical zones 406M(1)-406M(3) in the myopic-correcting lens 402M provide refractive correction of light rays (“light”) passing through the myopic-correcting lens 402M are different radiuses R_{M1} outside of the first add optical zone 404M relative to the first optical axis A₁ of the myopic-correcting lens 402M. For example, each first transitional optical zone 406M(1)-406M(3) may have a progressive power profile that provides an overall multifocality to the wearer as a function of the distance of a focused object. In this example, the power profiles of the first transitional optical zones 406M(1), 406M(2) provide a continuous change in power at their respective transitions to the respective first transitional optical zones 406M(2), 406M(3). The transitions shown in FIG. 4 between adjacent first transitional optical zones 406M(1)-406M(3) are shown as distinct optical zones for illustrative purposes only, but in this example, the change in power at these respective transitions is continuous or substantially continuous. Thus, the myopic-correcting lens 402M may have a single transitional optical zone that surrounds the first add optical zone 404M and has a continuous aspheric power profile power. Note, however, that the transitions shown in FIG. 4 between any adjacent first transitional optical zones 406M(1)-406M(3) could also be non-continuous. Note, however, that the change in power at the transitions shown in FIG. 4 between any adjacent first transitional optical zones 406M(1)-406M(3) could also be non-continuous. The myopic-correcting lens 402M has an overall optical zone diameter D_{M1}.

As also shown in FIG. 4, the hyperopic-correcting lens 402H has a hyperopic power profile that is provided by a second add optical zone 404H and second transitional optical zones 406H(1)-406H(3) surrounding the second add optical zone 404H. The second add optical zone 404H is also a center-near optical zone that is disposed around a second optical axis A₂ and has a second add zone power profile as part of the hyperopic power profile of the hyperopic-correcting lens 402H that has hyperopic paraxial power selected to substantially correct hyperopic refractive error for distance vision (e.g., at 0 or 0.25 D) for a wearer according to their refractive error correction prescription and a second add power to correct for presbyopia. The second add optical zone 404H also has the first add zone diameter D_{C1} that is sized like the first add optical zone 404M of the myopic-correcting lens 402M. This is based on the anticipated pupil constriction due to pupil miosis when a wearer is focused on a near-distance object (e.g., at 2.5 D) to enhance presbyopia correction. In this manner, a greater percentage of light passes into the wearer's pupil from the second add optical zone 404H, having the second add power when the wearer is focused on a near-distance object. The second add optical zone 404H may be spherical or have some target spherical aberration that is dependent on the hyperopic paraxial power in the second add optical zone 404H. In this example, there are three (3) second transitional optical zones 406H(1)-406H(3). The second transitional optical zones 406H(1)-406H(3) surround the second add optical zone 404H about the second optical axis A₂, and each includes respective hyperopic progressive power profiles as part of the overall hyperopic power profile for the hyperopic-correcting lens 402H. The hyperopic power profile is comprised of the second add zone power profile, and the hyperopic progressive power profile includes a second SPHA to provide correction of hyperopic refractive error.

With continuing reference to FIG. 4, the second transitional optical zones 406H(1)-406H(3) in the hyperopic-correcting lens 402H that provide refractive correction of light rays (“light”) passing through the hyperopic-correcting lens 402H are different radiuses R_{H1} outside of the second add optical zone 404H relative to the second optical axis A₂ of the hyperopic-correcting lens 402H. For example, each second transitional optical zone 406H(1)-406H(3) may have a progressive power profile that provides an overall multifocality to the wearer as a function of the distance of a focused object. The transitions shown in FIG. 4 between adjacent second transitional optical zones 406H(1)-406H(3) are shown as distinct optical zones for illustrative purposes only, but in this example, the change in power at these respective transitions is continuous or substantially continuous. Thus, the hyperopic-correcting lens 402H may have a single transitional optical zone that surrounds the second add optical zone 404H and has a continuous aspheric power profile power. Note, however, that the transitions shown in FIG. 4 between any adjacent second transitional optical zones 406H(1)-406H(3) could also be non-continuous. Note, however, that the change in power at the transitions shown in FIG. 4 between any adjacent second transitional optical zones 406H(1)-406H(3) could also be non-continuous. The hyperopic-correcting lens 402H has an overall optical zone diameter D_{H1}.

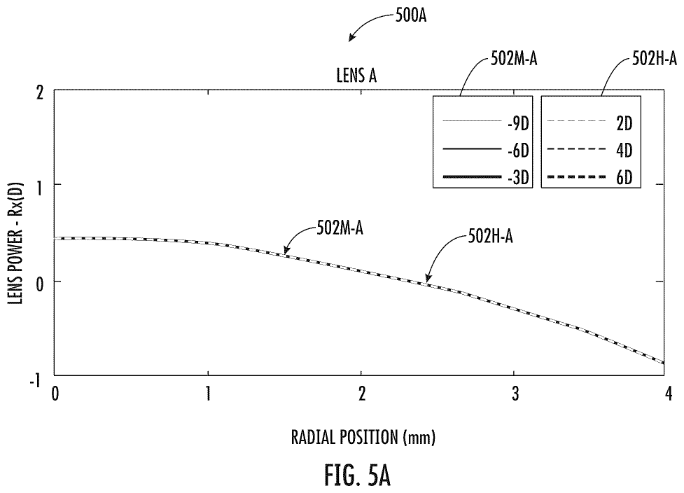

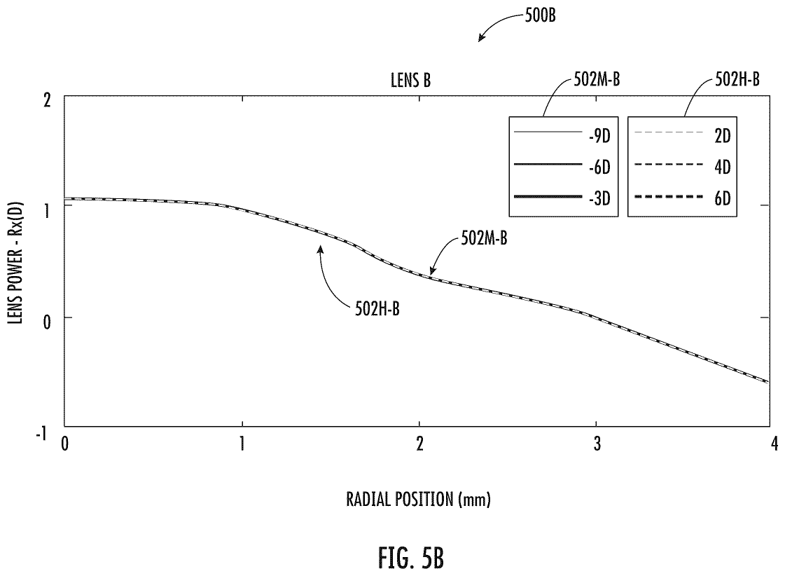

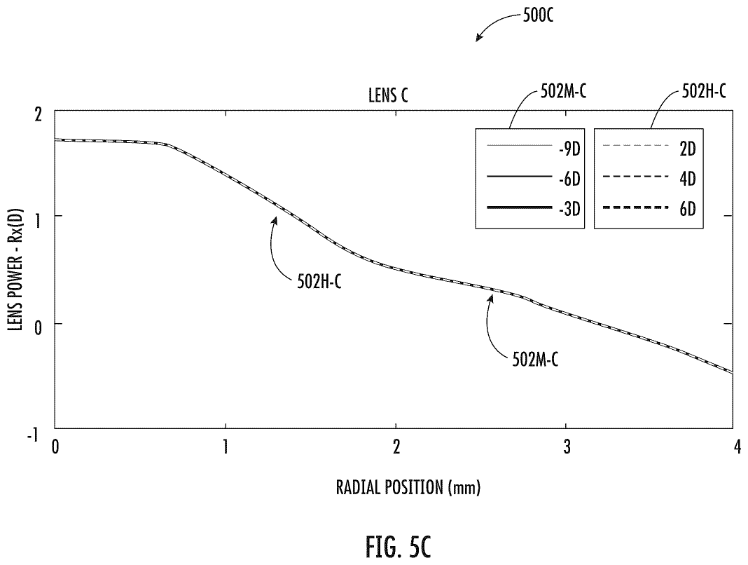

FIGS. 5A-5C are exemplary graphs 500A, 500B, 500C that each includes a respective plurality of myopic power profiles 502M-A, 502M-B, 502M-C and hyperopic power profiles 502H-A, 502H-B, 502H-C for a plurality of the myopic-correcting lenses 402M (for refractive error correction prescriptions −9 D, −6 D, −3 D) and a plurality of the hyperopic-correcting lenses 402H (for refractive error correction prescriptions+2 D, +4 D, +6 D) as shown in FIG. 4. The graphs 500A, 500B, 500C plot lens power minus prescription Rx in diopters (D) as a function of radial position from the respective first and second optical axes A₁, A₂ of the myopic-correcting and hyperopic-correcting lenses 402M, 402H in FIG. 4. The graph 500A in FIG. 5A includes a plurality of myopic power profiles 502M-A and hyperopic power profiles 502H-A for the different refractive error correction prescriptions of the myopic-correcting lenses 402M and a plurality of the hyperopic-correcting lenses 402H for a label add power of +0.75 D, which can be thought of as a low-add power for patients having a lower or initial loss of accommodation. The graph 500B in FIG. 5B includes a plurality of myopic power profiles 502M-B and hyperopic power profiles 502H-B for the different refractive error correction prescriptions of the myopic-correcting lenses 402M and a plurality of the hyperopic-correcting lenses 402H for a label add power of +1.25 D, which can be thought of as a medium or mid-add power for patients having a higher loss of accommodation. The graph 500C in FIG. 5C includes a plurality of myopic power profiles 502M-C and hyperopic power profiles 502H-C for the different refractive error correction prescriptions of the myopic-correcting lenses 402M and a plurality of the hyperopic-correcting lenses 402H for a label add power of +1.75 D.

The myopic power profiles 502M-A, 502M-B, 502M-C and hyperopic power profiles 502H-A, 502H-B, 502H-C for the myopic-correcting and hyperopic-correcting lenses 402M, 402H in FIGS. 5A-5C vary with respect to paraxial power, the radiuses R_{M1}, R_{H1} of the first and second add optical zones 404M, 404H, the effective add power (i.e., magnitude of the first and second add powers) provided by the respective first and second add optical zones 404M, 404H, and the radiuses R_{M1}, R_{H1} of the first and second add optical zones 404M, 404H. However, with each add power group shown in the myopic power profiles 502M-A, 502M-B, 502M-C and hyperopic power profiles 502H-A, 502H-B, 502H-C in FIGS. 5A-5C, the paraxial power, effective add power (i.e., magnitude of the first and second add powers) provided by the respective first and second add optical zones 404M, 404H, and the radiuses R_{M1}, R_{H1} of the first and second add optical zones 404M, 404H are relatively constant across the myopic and hyperopic refractive error correction prescriptions. In other words, for a given effective add power shown in the different add groups for the respective myopic power profiles 502M-A, 502M-B, 502M-C and hyperopic power profiles 502H-A, 502H-B, 502H-C in FIGS. 5A-5C, the paraxial power, the effective add power and the radiuses R_{M1}, R_{H1} of the first and second add optical zones 404M, 404H are almost the same for each of the myopic and hyperopic refractive error correction prescription.

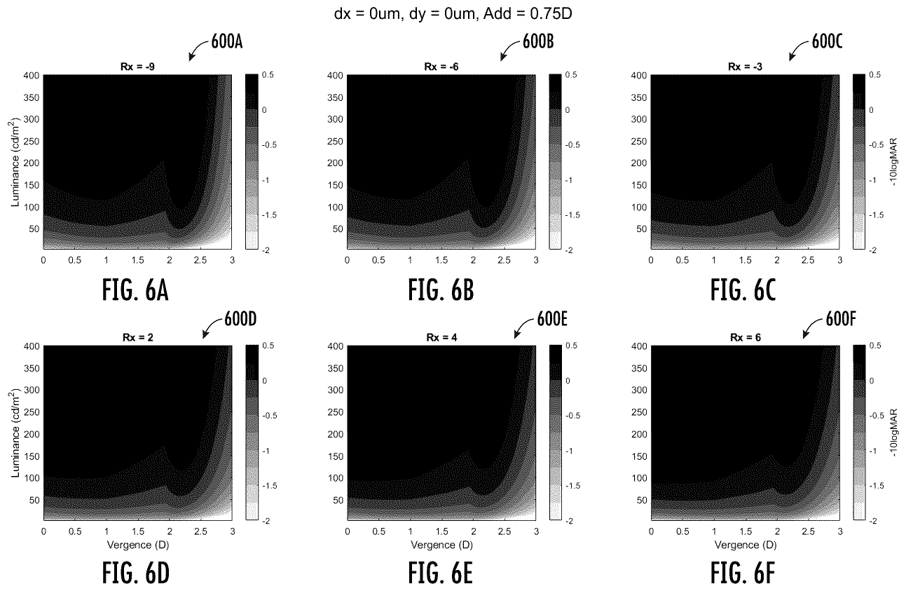

FIGS. 6A-8F illustrate exemplary cyclopean visual performance shown as MAR (as −10 log MAR) as a function of luminance (in candela (cd) per meter squared (m²) cd/m²), and vergence (in diopters) of different myopic and hyperopic refractive error correction prescriptions (Rx) of the myopic-correcting and hyperopic-correcting lenses 402M, 402H in FIG. 4 represented by the respective myopic power profiles 502M-A, 502M-B, 502M-C and hyperopic power profiles 502H-A, 502H-B, 502H-C in respective FIGS. 5A-5C. Plotting the cyclopean visual performance of the myopic-correcting and hyperopic-correcting lenses 402M, 402H in FIGS. 6A-8F enables the ability to study the total multifocal contact lens system 400.

In this regard, FIGS. 6A-6C are exemplary plots 600A, 600B, 600C of cyclopean visual performance shown as MAR (as −10 log MAR) as a function of luminance (in candela (cd) per meter squared (m2) cd/m2), and vergence (in diopters) of different myopic refractive error correction prescriptions (Rx) of the myopic-correcting lenses 402M in FIG. 4 represented by the respective low-add myopic power profiles 502M-A in FIG. 5A for a label add power of +0.75 D. FIGS. 6D-6F are exemplary plots 600D, 600E, 600F of cyclopean visual performance shown as MAR (as −10 log MAR) as a function of luminance (in candela (cd) per meter squared (m2) cd/m2), and vergence (in diopters) of hyperopic refractive error correction prescriptions (Rx) of the hyperopic-correcting lenses 402H in FIG. 4 represented by the respective low-add hyperopic power profiles 502H-A in FIG. 5A for a label add power of +0.75 D.

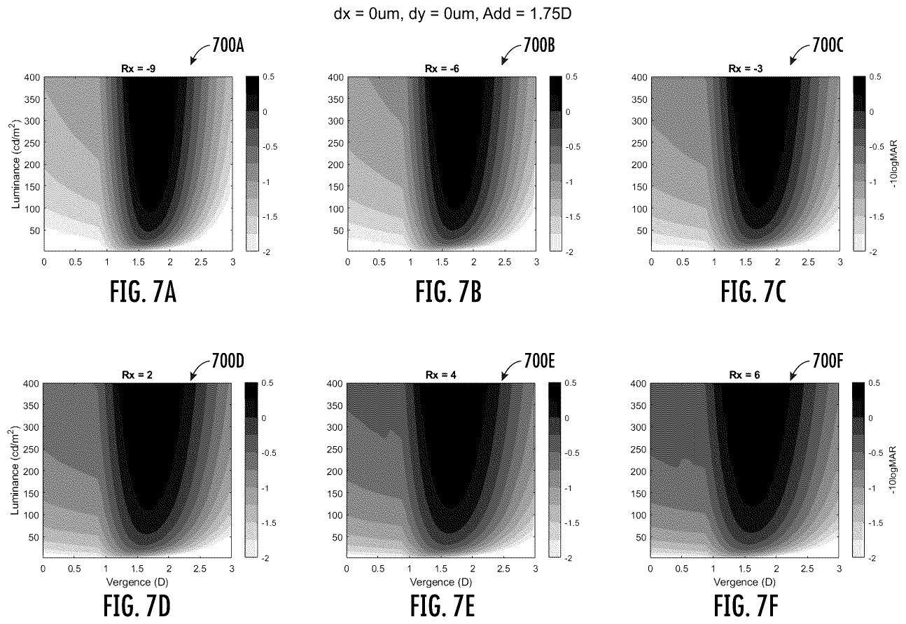

FIGS. 7A-7C are exemplary plots 700A, 700B, 700C of cyclopean visual performance shown as MAR (as −10 log MAR) as a function of luminance (in candela (cd) per meter squared (m2) cd/m2) and vergence (in diopters) of different myopic refractive error correction prescriptions (Rx) of the myopic-correcting lenses 402M in FIG. 4 represented by the respective mid-add myopic power profiles 502M-B in FIG. 5B for a label add power of +0.75 D. FIGS. 7D-7F are exemplary plots 700D, 700E, 700F of cyclopean visual performance shown as MAR (as −10 log MAR) as a function of luminance (in candela (cd) per meter squared (m2) cd/m2), and vergence (in diopters) of hyperopic refractive error correction prescriptions (Rx) of the hyperopic-correcting lenses 402H in FIG. 4 represented by the respective mid-add hyperopic power profiles 502H-B in FIG. 5B for a label add power of +1.75 D.

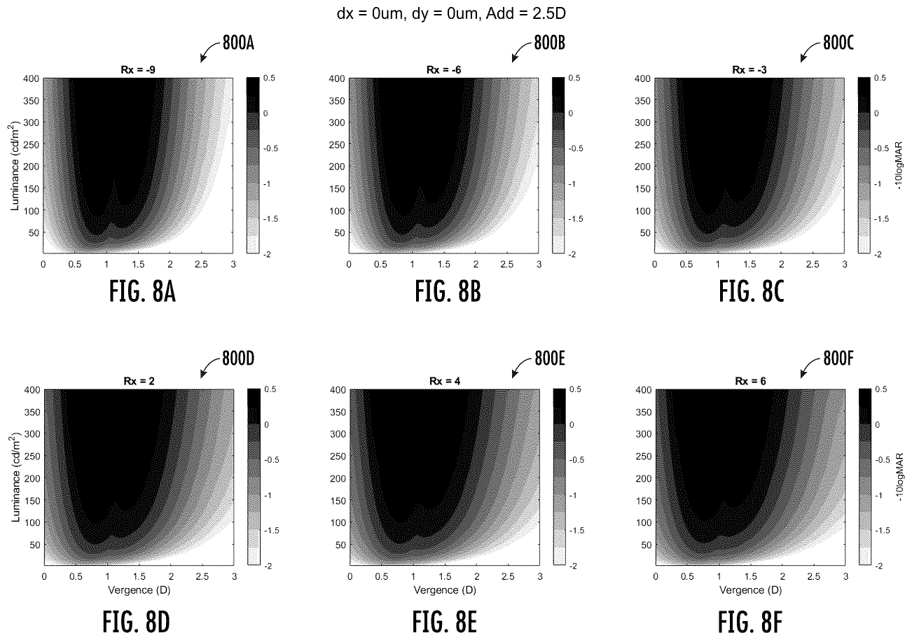

FIGS. 8A-8C are exemplary plots 800A, 800B, 800C of cyclopean visual performance shown as luminance (cd/m²) plotted and MAR (as −10 log MAR) as a function of vergence (in diopters) of different myopic refractive error correction prescriptions (Rx) of the myopic-correcting lenses 402M in FIG. 4 represented by the respective high-add myopic power profiles 502M-C in FIG. 5C for a label add power of +2.5 D. FIGS. 8D-8F are exemplary plots 800D, 800E, 800F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the hyperopic-correcting lenses 402H in FIG. 4 represented by the respective high-add hyperopic power profiles 502H-C in FIG. 5C for a label add power of +2.5 D.

The cyclopean visual performance plots 600A-600F, 700A-700F, and 800A-800F of the cyclopean visual performance of the myopic-correcting and hyperopic-correcting lenses 402M, 402H in the multifocal contact lens system 400 in FIG. 4 have noted that there are differences in cyclopean visual performance between myopic-correcting and hyperopic-correcting lenses 402M, 402H. For example, as shown in the cyclopean visual performance plots 600A-600C in FIGS. 6A-6C for myopic-correcting lenses 402M of −9 D, −6 D, and −3 D refractive error correction prescriptions with a lower label add power of +0.75 D, there is little difference in cyclopean visual performance. As shown in FIGS. 6A-6C, high visual acuity above −0.025 is realized at luminance levels above 80 cd/m² for far-distance, intermediate-distance, and near-distance vision until focal distance approaches approximately 2.5 D or greater at short-distance vision for each of the refractive error correction prescriptions of −9 D, −6 D, and −3 D (Rx) for the myopic-correcting lenses 402M. The same is essentially true for the cyclopean visual performance of the hyperopic-correcting lenses 402H of +2 D, +4 D, and +6 D (Rx) refractive error correction prescriptions (Rx) with a lower label add power of +0.75 D. As shown in FIGS. 6D-6F, visual acuity above 0 (−10 log MAR) for 20/20 vision is realized at even luminance levels above 80 cd/m² for far-distance, intermediate-distance, and near-distance vision until focal distance approaches approximately 2.5 D or greater at short distance vision for each of the refractive error correction prescriptions of +2 D, +4 D, and +6 D (Rx) for the hyperopic-correcting lenses 402H with the label add power of +0.75 D.

However, as shown in the cyclopean visual performance plots 700A-700C and 700D-700F in respective FIGS. 7A-7C and 7D-7F for myopic-correcting and hyperopic-correcting lenses 402M, 402H with a label add power of +1.75 D, far distance cyclopean visual performance is substantially reduced in an undesired manner. For example, as shown in plots 700A-700C in respective FIGS. 7A-7C for the myopic-correcting lenses 402M with +1.75 D add power, visual acuity above 0 (−10 log MAR) for 20/20 vision is realized at luminance levels at 80 cd/m² only between approximately 1.5 D and 1.9 D distances. Also, for example, as shown in plots 700D-700F in respective FIGS. 7D-7F for the hyperopic-correcting lenses 402H with +1.75 D add power, visual acuity above 0 (−10 log MAR) for 20/20 vision is realized at luminance levels at 80 cd/m² only between approximately 1.5 D and 1.8 D distances.

Also, shown in the cyclopean visual performance plots 800A-800C and 800D-800F in respective FIGS. 8A-8C and 8D-8F for myopic-correcting and hyperopic-correcting lenses 402M, 402H with a label add power of +2.5 D, near and far distance cyclopean visual performance is substantially reduced in an undesired manner. For example, as shown in plots 800A-800C in respective FIGS. 8A-8C for the myopic-correcting lenses 402M with +2.5 D add power, visual acuity above 0 (−10 log MAR) for 20/20 vision is realized at luminance levels at 80 cd/m² only between approximately 0.5 D and 1.4 D distances. Also, for example, as shown in plots 800D-800F in respective FIGS. 8D-8F for the hyperopic-correcting lenses 402H with +2.5 D add power, visual acuity above 0 (−10 log MAR) for 20/20 vision is realized at luminance levels at 80 cd/m2 only between approximately 1.5 D and 1.8 D distances.

It has been found that hyperopes fitted with correction lenses sometimes feel their far-distance vision is compromised due to having a natural higher expectation of superior far-distance vision than myopes. This is because, typically, myopes have already experienced compromised far-distance vision due to their natural refractive error over a period of time in their life and over a number of successive refraction error correction prescriptions. Myopes wearing the myopic-correcting lenses 402M in FIG. 4 may not have the same expectation of corrected far-distance vision with a multifocal contact lens as hyperopes wearing the hyperopic-correcting lenses 402M, 402H in FIG. 4.

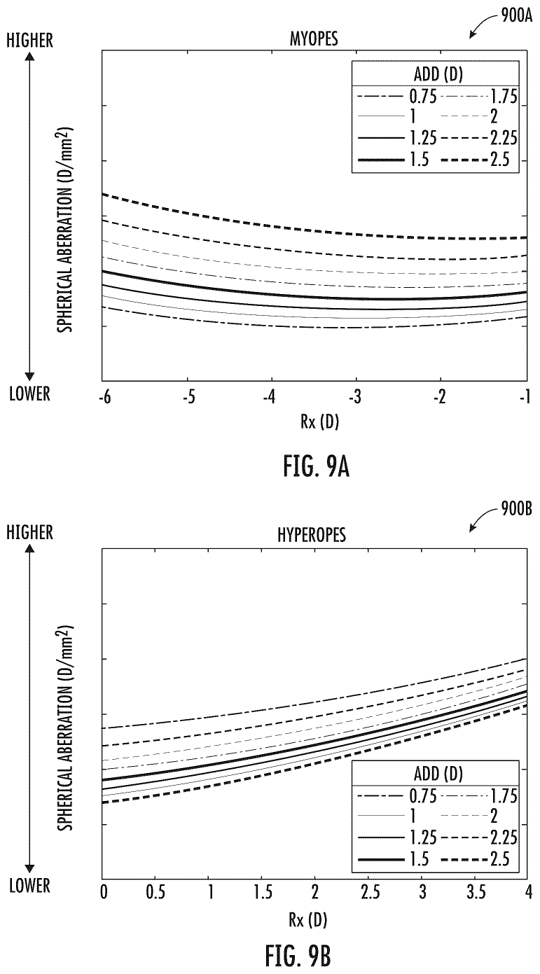

It has also been discovered that hyperopes generally have more positive SPHA than myopes. SPHA varies with spherical refraction, age (and thus add power need), and vergence. This is shown in the respective graphs 900A, 900B in FIGS. 9A and 9B illustrating respective mean ocular SPHA (in D per millimeter squared (mm²) (D/mm²)) in myopes and hyperopes as a function of refractive error correction prescription (Rx) and add power need where add power need increases with age. For example, as shown in graph 900A in FIG. 9A for myopes, a mean myopic subject with a refractive error correction prescription (Rx) of −3.25 D and add power need of +1.75 D has an expected ocular SPHA of 0.077 D/mm². However, as shown in graph 900B in FIG. 9B for hyperopes, a mean hyperopic subject with a refractive error correction prescription (Rx) of +2.0 D and add power need of +2.25 D has an expected ocular SPHA of 0.089 D/mm².

Thus, if the myopic and hyperopic power profiles of the myopic-correcting and hyperopic-correcting lenses 402M, 402H were designed to have an SPHA of −0.080 D/mm², this would provide a residual SPHA of −0.003 D/mm² (i.e., 0.077 D/mm²−0.080 D/mm²) for the myopic subject with a refractive error correction prescription (Rx) of −3.25 D and add power need of +1.75 D who has an expected ocular SPHA of 0.077 D/mm². However, this would provide a higher residual SPHA of 0.009 D/mm² (i.e., 0.089 D/mm²−0.080 D/mm²) for the hyperopic subject with a refractive error correction prescription (Rx) of +2 D and add power need of +2.25 D. Thus, the hyperopic-correcting lenses 402H will result in more residual SPHA in the average hyperope than in the average myope, resulting in compromised far-distance vision for the hyperope. Thus, it has been discovered that the design of the multifocal contact lens system 400 with the myopic-correcting and hyperopic-correcting lenses 402M, 402H in FIG. 4 using a target SPHA based on myopes results in compromised far-distance vision in hyperopes fitted with the hyperopic-correcting lenses 402H in the multifocal contact lens system 400 in FIG. 4, as compared to myopes fitted with myopic-correcting lenses 402M in the same multifocal contact lens system 400.

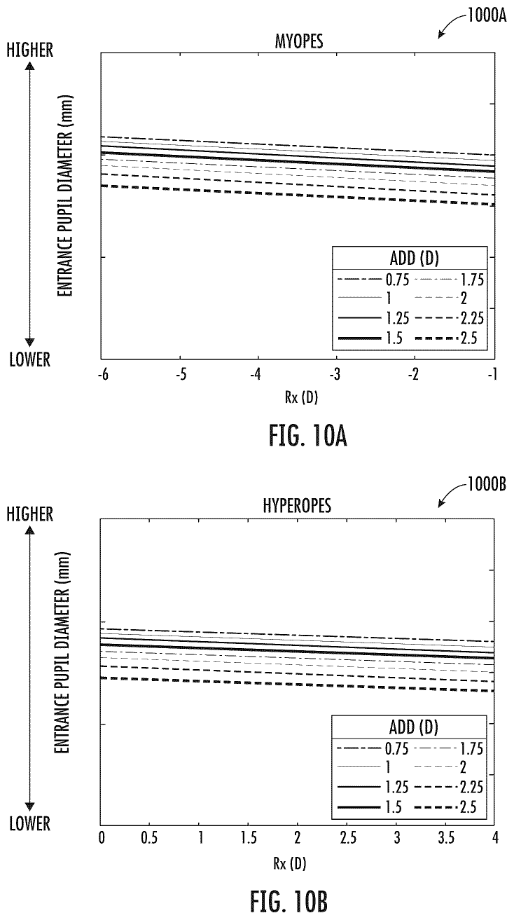

It has also been discovered that hyperopes generally have smaller pupils than myopes for the same or similar conditions of luminance, spherical refraction, age, and vergence. Thus, for example, with the myopic and hyperopic-correcting lenses 402M, 402H in the multifocal contact lens system 400 in FIG. 4 both having respective first and second optical add optical zones 404M, 404H both designed with the first add zone diameter D_{C1} modeled on the average pupil size of myopes for presbyopia correction, this may provide a more compromised far-distance vision for hyperopes as compared to myopes wearing myopic and hyperopic-correcting lenses 402M, 402H in the same multifocal contact lens system 400 with the same or similar add power. This is shown in the respective graphs 1000A, 1000B in FIGS. 10A and 10B illustrating respective mean entrance pupil diameter in millimeters (mm) in myopes and hyperopes as a function of refractive error correction prescription (Rx) and add power need. For example, as shown in graph 1000A in FIG. 10A for myopes, a mean myopic subject with a refractive error correction prescription (Rx) of −3.25 D and add power need of +1.75 D with a luminance of 120 cd/m² and vergence of 2D has an expected entrance pupil diameter of 2.428 mm. However, as shown in graph 1000B in FIG. 10B for hyperopes, a mean hyperopic subject with a refractive error correction prescription (Rx) of +2.0 D and add power need of +2.25 D with a luminance of 120 cd/m² and vergence of 2 D has an expected entrance pupil diameter of 2.251 mm.

Thus, if the first add zone diameter D_{C1} of the second add optical zone 404H of the hyperopic-correcting lenses 402H in the multifocal contact lens system 400 in FIG. 4 is designed for the average pupil size of myopes for presbyopia correction, this may provide a more compromised far-distance vision for hyperopes wearing the hyperopic-correcting lenses 402H as compared to myopes wearing the myopic-correcting lenses 402M from the same multifocal contact lens system 400. This is due to the larger first add zone diameter D_{C1} of the second add optical zone 404H in the hyperopic-correcting lenses 402H intersecting a greater percentage of a hyperope's pupil as compared to a myope's pupil when focused on far-distance objects when wearing lenses the myopic-correcting or hyperopic-correcting lenses 402M, 402H in the same multifocal contact lens system 400. Thus, a hyperope's pupil, being of an average smaller size than myopes, may receive a lower percentage of light from the second transitional optical zones 406H(1)-406H(3) of the hyperopic-correcting lens 402H that provide multifocality than a myope wearing a myopic-correcting lens 402M from the same multifocal contact lens system 400.

Thus, it is desired to provide a multifocal contact lens system that includes myopic-correcting and hyperopic-correcting lenses that are provided with a number of different refractive error correction prescriptions for vision correction and add power for presbyopia correction, but where the design provides the freedom to vary SPHA and/or add optical zone diameter for the hyperopic-correcting lenses over the myopic-correcting lenses to provide for improved far-distance vision to the hyperopes.

In this regard, FIG. 11 illustrates an exemplary multifocal contact lens system 1100 that includes a respective myopic-correcting multifocal lenses 1102M (referred to herein as “myopic-correcting lenses 1102M) and hyperopic-correcting multifocal lenses 1102H (referred to herein as “hyperopic-correcting lenses 1102H). In this example, the myopic-correcting lenses 1102M and hyperopic-correcting lenses 1102H are multifocal contact lenses. The myopic-correcting lens 1102M and hyperopic-correcting lens 1102H also each have an effective add power that is designated with a given label add power for correction of presbyopia. Note that although only one (1) myopic-correcting lens 1102M and one (1) hyperopic-correcting lens 1102H are shown in FIG. 11, the multifocal contact lens system 1100 includes a plurality of the myopic-correcting lenses 1102M, each with a different myopic refractive error correction indicated by a different myopic refractive error correction prescription (e.g., −11 D, −2 D, −3 D . . . , −9 D) and for different label add powers, and a plurality of the hyperopic-correcting lenses 1102H, each with a different hyperopic refractive error correction prescription (e.g., +1 D, +2 D, +3 D . . . , +9 D) and for different label add powers.

As discussed in more detail below, in one example, to improve the far-distance vision of hyperopes wearing a hyperopic-correcting lens 1102H in the multifocal contact lens system 1100, the hyperopic-correcting lenses 1102H in the multifocal contact lens system 1100 are designed with an SPHA that is more negative as compared to the SPHA in the myopic-correcting lenses 1102M in the same multifocal contact lens system 1100. For example, the hyperopic-correcting lenses 1102H in the multifocal contact lens system 1100 may be designed to have an SPHA that is 10-20% more negative than the SPHA in the myopic-correcting lenses 1102M in the same multifocal contact lens system 1100. In this manner, the SPHA in the myopic-correcting and hyperopic-correcting lenses 1102M, 1102H in the multifocal contact lens system 1100 are myopic/hyperopic correction dependent to be better matched to the target residual SPHA of myopes and hyperopes.

As discussed in more detail below, in another example, to improve the far-distance vision of hyperopes wearing a hyperopic-correcting lens 1102H in the multifocal contact lens system 1100, the hyperopic-correcting lenses 1102H in the multifocal contact lens system 1100 are designed with a center add optical zone having a smaller, optimized diameter as compared to myopic-correcting lenses 1102M in the multifocal contact lens system 1100. This is based on the discovery that hyperopes generally have smaller pupils than myopes for the same or similar conditions of luminance, spherical refraction, age, and vergence. This smaller, optimized diameter of the center add optical zone in the hyperopic-correcting lenses 1102H, providing for an increased percentage of light to be received in the hyperope's pupil through its transitional optical zones when focused on far-distance objects. This is as compared to alternative hyperopic-correcting lenses, like the hyperopic-correcting lenses 402H in FIG. 4, having a center add optical zone diameter size optimized for myopes in the myopic-correcting lenses 402M in the multifocal contact lens system 400. In the multifocal contact lens system 400, a reduced percentage of light would be received in the hyperope's pupil through the transitional optical zones of the hyperopic-correcting lenses 402H where focused on longer-distance objects, as compared to myope's pupil through a worn myopic-correcting lens 402M, resulting in more compromised far-distance vision for hyperopes.

In this manner, one or more myopic-correcting lenses 1102M and/or one or more hyperopic-correcting lenses 1102H can be selected from the multifocal contact lens system 1100 for a patient's OD and OS based on their refractive error in their eyes to provide refractive error correction for corrected vision and improved longer-distance vision for hyperopes with multifocality and presbyopia correction.

With reference to FIG. 11, the myopic-correcting and hyperopic-correcting lenses 1102M, 1102H provide multifocality with corrected presbyopia for near-distances vision. In this regard, as shown in FIG. 11, the myopic-correcting lens 1102M has a myopic power profile that is provided by a first add optical zone 1104M and first transitional optical zones 1106M(1)-1106M(3) surrounding the first add optical zone 1104M. The myopic-correcting lens 1102M may also have a final distance optical zone 1106M(F) surrounding the first transitional optical zone 1106M(3), which has a refractive correction power for far-distance vision. The myopic-correcting lenses 1102M may have the same design as the myopic-correcting lenses 402M in FIG. 4 as a non-limiting example. The first add optical zone 1104M is disposed around the first optical axis A₁ and has a first add zone power profile as part of the myopic power profile of the myopic-correcting lens 1102M that has myopic paraxial power selected to substantially correct myopic refractive error for distance vision (e.g., at 0.25 D) for a wearer according to their refractive error correction prescription and a first add power to correct for presbyopia. The first add optical zone 1104M has the first add zone diameter D_{C1} that is sized based on the anticipated pupil constriction due to pupil miosis when a wearer is focused on a near-distance object (e.g., at 2.5 D) to enhance presbyopia correction. In this manner, more light passes into the wearer's pupil from the first add optical zone 1104M, having the first add power when the wearer is focused on a near-distance object. The first add optical zone 1104M may be spherical or have some target spherical aberration that is dependent on the myopic paraxial power in the first add optical zone 1104M. In this example, there are three (3) first transitional optical zones 1106M(1)-1106M(3). The first transitional optical zones 1106M(1)-1106M(3) surround the first add optical zone 1104M about the first optical axis A₁; each includes respective myopic progressive power profiles as part of the overall myopic power profile for the myopic-correcting lens 1102M. The myopic power profile is comprised of the first add zone power profile, and the myopic progressive power profile includes a first spherical aberration (SPHA) to provide correction of myopic refractive error correction.

The first transitional optical zones 1106M(1)-1106M(3) in the myopic-correcting lens 1102M provide refractive correction of light rays (“light”) passing through the myopic-correcting lens 1102M are different radiuses R_{M2} outside of the first add optical zone 1104M relative to the first optical axis A₁ of the myopic-correcting lens 1102M. For example, each first transitional optical zone 1106M(1)-1106M(3) may have a progressive power profile that provides an overall multifocality to the wearer as a function of the distance of a focused object. In this example, the power profiles of the first transitional optical zones 1106M(1), 1106M(2) provide a non-continuous or derivative non-continuous change in power at their respective transitions to the respective first transitional optical zones 1106M(2), 1106M(3). The transitions shown in FIG. 11 between adjacent first transitional optical zones 1106M(1)-1106M(3) are shown as distinct optical zones for illustrative purposes only, but in this example, the change in power at these respective transitions is continuous or substantially continuous. Thus, the myopic-correcting lens 1102M may have a single transitional optical zone that surrounds the first add optical zone 1104M and has a continuous aspheric power profile power. Note, however, that the transitions shown in FIG. 11 between any adjacent first transitional optical zones 1106M(1)-1106M(3) could also be non-continuous. Note, however, that the change in power at the transitions shown in FIG. 11 between any adjacent first transitional optical zones 1106M(1)-1106M(3) could also be non-continuous. The myopic-correcting lens 1102M has an overall optical zone diameter D_{M1}.

As also shown in FIG. 11, the hyperopic-correcting lens 1102H has a hyperopic power profile that is provided by a second add optical zone 1104H and second transitional optical zones 1106H(1)-1106H(3) surrounding the second add optical zone 1104H. The hyperopic-correcting lens 1102H may also have a final distance optical zone 1106H(F) surrounding the third, second transitional optical zone 1106H(3), which has a refractive correction power for far-distance vision. The second add optical zone 1104H is disposed around a second optical axis A₂ and has a second add zone power profile as part of the hyperopic power profile of the hyperopic-correcting lens 1102H that has hyperopic paraxial power selected to substantially correct hyperopic refractive error for distance vision (e.g., at 0.25 D) for a wearer according to their refractive error correction prescription and a second add power to correct for presbyopia. In this example, the second add optical zone 1104H has a second add zone diameter D_{C2} that is sized smaller than the first add zone diameter D_{C1} of the first add optical zone 1104M of the myopic-correcting lens 1102M. This is based on the anticipated reduced pupil size of a hyperope wearer when constricted to pupil miosis when a wearer is focused on a near-distance object (e.g., at 2.5 D) as opposed to a myope wearer of a myopic-correcting lens 1102M.

The second add optical zone 1104H may be spherical or have some target spherical aberration that is dependent on the hyperopic paraxial power in the second add optical zone 1104H. In this example, there are three (3) second transitional optical zones 1106H(1)-1106H(3). The second transitional optical zones 1106H(1)-1106H(3) surround the second add optical zone 1104H about the second optical axis A₂; each includes respective hyperopic progressive power profiles as part of the overall hyperopic power profile for the hyperopic-correcting lens 1102H. The hyperopic power profile is comprised of the second add zone power profile, and the hyperopic progressive power profile includes a second spherical aberration (SPHA) to provide correction of hyperopic refractive error correction.

With continuing reference to FIG. 11, the second transitional optical zones 1106H(1)-1106H(3) in the hyperopic-correcting lens 1102H provide refractive correction of light rays (“light”) passing through the hyperopic-correcting lens 1102H are different radiuses R_{H2} outside of the center second add optical zone 1104M relative to the second optical axis A₂ of the hyperopic-correcting lens 402H. For example, each second transitional optical zone 1106H(1)-1106H(3) may have a progressive power profile that provides an overall multifocality to the wearer as a function of the distance of a focused object. The transitions shown in FIG. 11 between adjacent second transitional optical zones 1106H(1)-1106H(3) are shown as distinct optical zones for illustrative purposes only, but in this example, the change in power at these respective transitions is continuous or substantially continuous. Thus, the hyperopic-correcting lens 1102H may have a single transitional optical zone that surrounds the second add optical zone 1104H and has a continuous aspheric power profile power. Note, however, that the transitions shown in FIG. 11 between any adjacent second transitional optical zones 1106H(1)-1106H(3) could also be non-continuous. Note, however, that the change in power at the transitions shown in FIG. 11 between any adjacent second transitional optical zones 1106H(1)-1106H(3) could also be non-continuous. The hyperopic-correcting lens 1102H has an overall optical zone diameter D_{H1}.

Also, as illustrated in FIG. 11 and discussed in more detail below, the myopic power profile in each of the myopic-correcting lenses 1102M in the multifocal contact lens system 1100 has a first SPHA 1112M that is larger than a second SPHA 1112H in each of the hyperopic power profile of the hyperopic-correcting lenses 1102H in the multifocal contact lens system 1100. In other words, the first SPHA 1112M is the same in each of the myopic-correcting lenses 1102M in the multifocal contact lens system 1100, but the second SPHA 1112H is the same, but smaller than the first SPHA 1112M, in each of the hyperopic-correcting lenses 1102H in the multifocal contact lens system 1100. The first SPHA 1112M in the myopic-correcting lenses 1102M is a spherical aberration in the myopic power profiles of the myopic-correcting lenses 1102M as a function of their radius R_{M2} relative to the first optical axis A₁. The second SPHA 1112H in the hyperopic-correcting lenses 1102H is a spherical aberration in the hyperopic power profiles of the hyperopic-correcting lenses 1102H as a function of their radius R_{H2} relative to the second optical axis A₂. Reducing the second SPHA 1112H in the hyperopic-correcting lenses 1102H in the multifocal contact lens system 1100 over the first SPHA 1112M in the myopic-correcting lenses 1102M in the multifocal contact lens system 1100 can further improve far-distance vision by hyperopes wearing hyperopic-correcting lenses 1102H in the multifocal contact lens system 1100. For example, the second SPHA 1112H may be at least ten percent (10%) less than the first SPHA 1112M due to the discovery that, on average, hyperopes have a smaller SPHA than myopes for a similar spherical refraction, age, vergence, and add power need. As another example, the second SPHA 1112H of the hyperopic-correcting lenses 1102H in the multifocal contact lens system 1100 may be between ten percent (10%) and twenty percent (20%) less than the first SPHA 1112M in the myopic-correcting lenses 1102M in the multifocal contact lens system 1100.

In another example, the first SPHA 1112M of each of the plurality of myopic-correcting lenses 1102M is targeted to an average first ocular SPHA of a population of myopes, such as shown in the graph 900A in FIG. 9A. The second SPHA 1112H of each of the plurality of hyperopic-correcting lenses 1102H can also be targeted to an average second ocular SPHA of a population of hyperopes, such as shown in the graph 900B in FIG. 9B.

In another example, the second SPHA 1112H in the plurality of hyperopic-correcting lenses 1102H in the multifocal contact lens system 1100 can be made to have the same target residual SPHA as provided by the first SPHA 1112M in the myopic-correcting lenses 1102M in the multifocal contact lens system 1100. For example, as discussed earlier with regard to FIG. 9A, for a mean myopic subject with a myopic refractive error correction prescription of −3.25 D and label add power need of +1.75 D, the expected value of distance SPHA may be 0.077 D/mm². The myopic-correcting lenses 1102M in the multifocal contact lens system 1100 may have a myopic power profile that provides a first SPHA 1112M of −0.080 D/mm², resulting in a residual ocular SPHA of =−0.003 D/mm² (i.e., 0.077 D/mm²−0.080 D/mm²). As shown in FIG. 9B, for a mean hyperopic subject with hyperopic refractive error correction prescription=+2.00 D and label add power need=+2.25 D, the expected value of distance SPHA is 0.089 D/mm². Thus, to match the target residual SPHA for a hyperopic group wearing the hyperopic-correcting lenses 1102H to that myope group wearing myopic-correcting lenses 1102M in the multifocal contact lens system 1100, the design of hyperopic-correcting lenses 1102H in this example is changed such that their second SPHA 1112H is −0.092 D/mm² (i.e., −0.089 D/mm²−0.003 D/mm²=−0.092 D/mm²) to provide the same target residual SPHA for a hyperopic group.

In another example, the first SPHA 1112M in each of the myopic-correcting lenses 1102M is the same in the multifocal contact lens system 1100, but the first SPHA 1112M is a function of the radius R_{M2} of the myopic-correcting lenses 1102M. For example, the first SPHA 1112M of each of the myopic-correcting lenses 1102M can be between −0.064 D/mm² and −0.096 D/mm². The second SPHA 1112H in each of the hyperopic-correcting lenses 1102H is the same in the multifocal contact lens system 1100, but the second SPHA 1112H is also a function of the radius R_{H2} of the hyperopic-correcting lenses 1102H. For example, the second SPHA 1112H of each of the hyperopic-correcting lenses 1102H can be between −0.073 D/mm² and −0.111 D/mm².

As discussed above, the second add optical zone 1104H of the hyperopic-correcting lens 1102H also has a second add zone diameter D_{C2} that is sized smaller than the first add zone diameter D_{C1} of the first add optical zone 1104M of the myopic-correcting lens 1102M. This is based on the anticipated reduced pupil size of a hyperope wearer when constricted to pupil miosis when a wearer is focused on a near-distance object (e.g., at 2.5 D). In this manner, more light passes into a hyperope wearer's pupil from the second transitional optical zones 1106H(1)-1106H(3) when the hyperope wearer is focused on a far-distance object to provide for improved longer-distance vision.

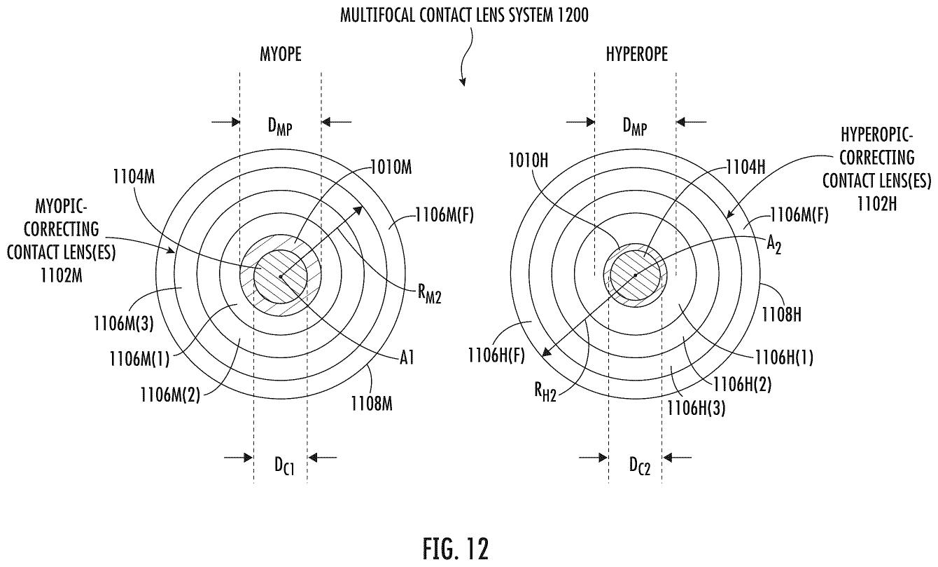

This is shown in FIG. 12, wherein a myopic-correcting lens 1102M and a hyperopic-correcting lens 1102H from the multifocal contact lens system 1100 in FIG. 11 are shown being worn on a respective myope and hyperope under the same luminance, spherical refraction, age, vergence, and add power need as an example when focused on a shorter-distance object for shorter-distance vision. As shown in FIG. 12, the diameter D_{MP} of the myope's pupil 1010M is larger than the diameter D_{HP} of the hyperope's pupil 1010H when wearing respective myopic-correcting and hyperopic-correcting lens 1102M, 1102H under the same or similar conditions luminance, spherical refraction, age, vergence, and add power. This is because, on average, a hyperope pupil will constrict more to a smaller diameter size than a myope pupil under similar conditions. Thus, as shown in FIGS. 11 and 12 and discussed in more detail below, the second add optical zone 1104H of the hyperopic-correcting lens 1102H has a second add zone diameter D_{C2} that is sized smaller than the first add zone diameter D_{C1} of the first add optical zone 1104M of the myopic-correcting lens 1102M based on the anticipated reduced pupil size of a hyperope wearer when constricted to pupil miosis when a wearer is focused on a near-distance object (e.g., at 2.5 D).

For example, as discussed above with regard to the graph 1000A in FIG. 10A, with a luminance of 120 cd/m² and a vergence of 2 D, for a mean myopic subject with a myopic refractive error correction prescription of −3.25 D and label add power need of +1.75 D, the expected value of the entrance pupil diameter may be 2.428 mm. The myopic-correcting lenses 1102M may have it's first add optical zones 1104M and it's first transitional optical zones 1106M(1)-1106M(3) defined by radial control positions of [0, 0.7831, 1.0569, 1.4895] for the mid-add label power myopic-correcting lenses 1102M and [0, 0.6389, 0.9426, 1.4337] for the high-add label power myopic-correcting lenses 1102M. As discussed above in the graph 1000B in FIG. 11, the mean hyperopic subject with a hyperopic refractive error correction prescription of +2.00 D and label add power need of +2.25 D, again with a luminance of 120 cd/m² and a vergence of 2 D, the expected value of entrance pupil diameter may be 2.251 mm. Thus, in an example, to match the target relative add zone size of the myope group, the design for hyperopic-correcting lenses 1102H in the multifocal contact lens system 1100 can be changed such that the radial control points are reduced by a factor of 2.251/2.428=0.927, making the second add zone diameter D_{C2} of the second add optical zone 1104H approximately 7% smaller than the second add zone diameter D_{C2} of the first add optical zone 1104M in the myopic-correcting lenses 1102M. As another example, the second add zone diameter D_{C2} of the second add optical zone 1104H of the hyperopic-correcting lenses 1102H can be at least five percent (5%) less (e.g., seven percent (7%) less) than the first add zone diameter D_{C1} of the myopic-correcting lenses 1102M.

Thus, in the example, the first add zone diameter D_{C1} of the myopic-correcting lenses 1102M and the second add zone diameter D_{C2} of the hyperopic-correcting lenses 1102H can be based on targeted average pupil diameter of a population of respective myopes and hyperopes. This can be determined, for example, from the graphs 1000A, 1000B in FIGS. 10A and 10B described above.

Furthermore, it has been discovered that, in general, myopes and hyperopes have differences in the distribution of add power need. A higher proportion of hyperopes are fitted with high-add power lenses as compared to myopes of the same or similar age. Thus, a hyperope with a higher add power may experience more compromised far-distance vision as compared to a myope. Also, as discussed above, a hyperope may already have a natural disposition of feeling that their far-distance vision has been compromised when fitted with presbyopia-correcting lenses due to a greater expectation of superior far-distance vision than myopes. Thus, in exemplary aspects, to improve the far-distance vision of the hyperope, the effective add power in the hyperopic-correcting lenses 1102H in the multifocal contact lens system 1100 can also be reduced as compared to the effective add power in the myopic-correcting lenses 1102M of the same multifocal contact lens system 1100 for a given label add power. Also, it may be desired to only reduce the effective add power in certain effective label add power ranges of the hyperopic-correcting multifocal lenses 1102H to improve far-distance vision, taking advantage of binocular disparity between a patient's dominant and non-dominant eye. For example, the effective add power may be reduced in some or all of the hyperopic-correcting lenses 1102H for a given label add power as compared to the label add power of the myopic-correcting lenses 1102M. The effective add power in the hyperopic-correcting lenses 1102H in the multifocal contact lens system 1100 can be provided by adjusting its paraxial power and aspheric constants in its respective hyperopic power profiles.

The DOF of one or more of the hyperopic-correcting lenses 1102H for a given label add power can be changed with respect to a DOF of one or more of myopic-correcting lenses 1102M for the same given label add power by between +0.05 D and −0.25 D.

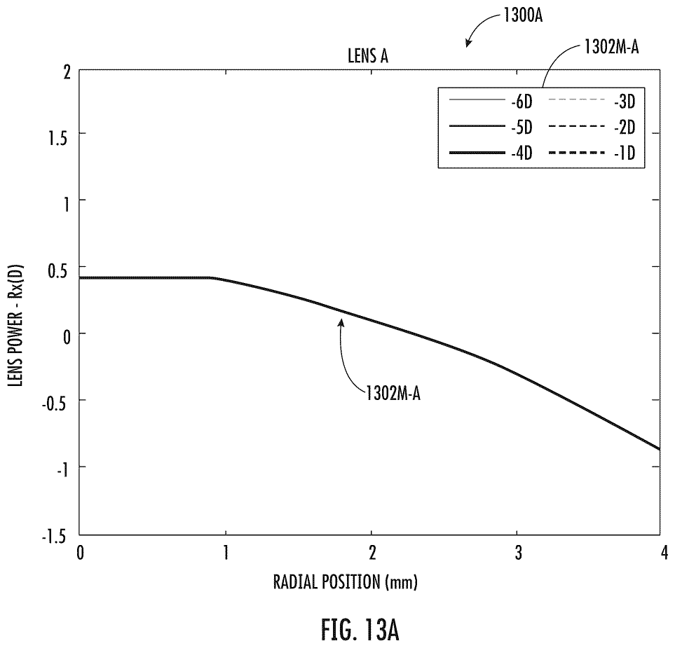

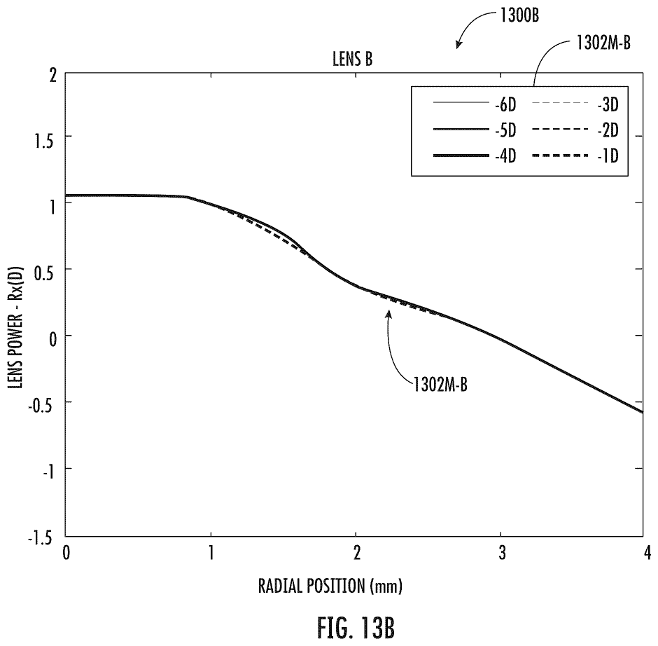

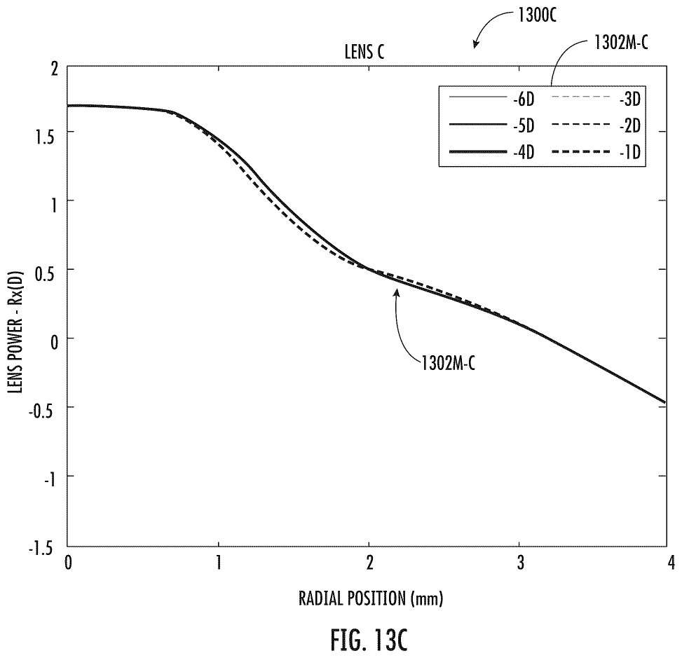

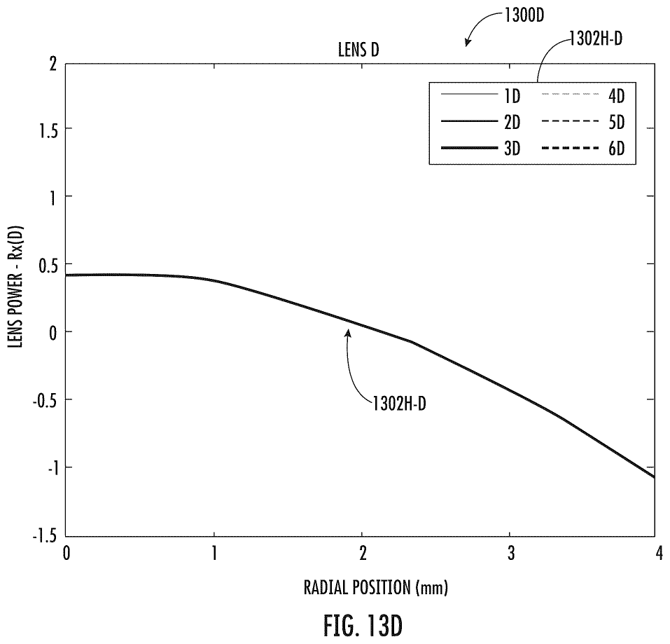

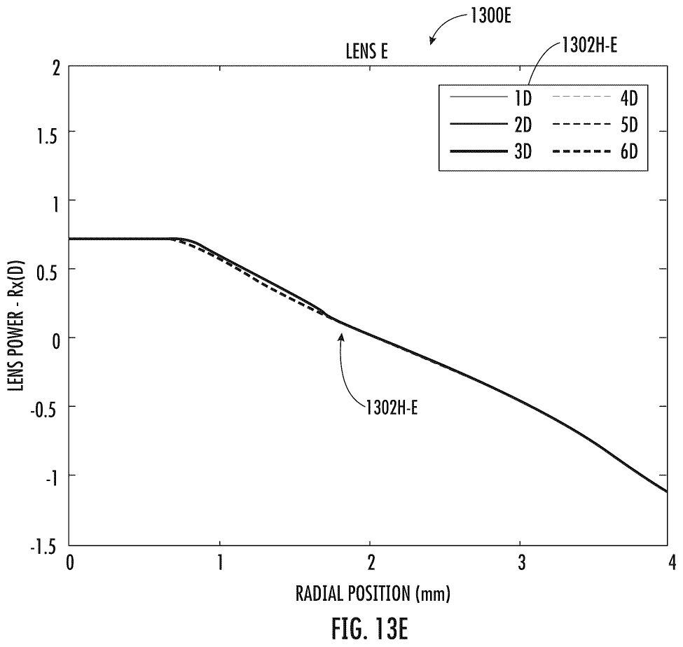

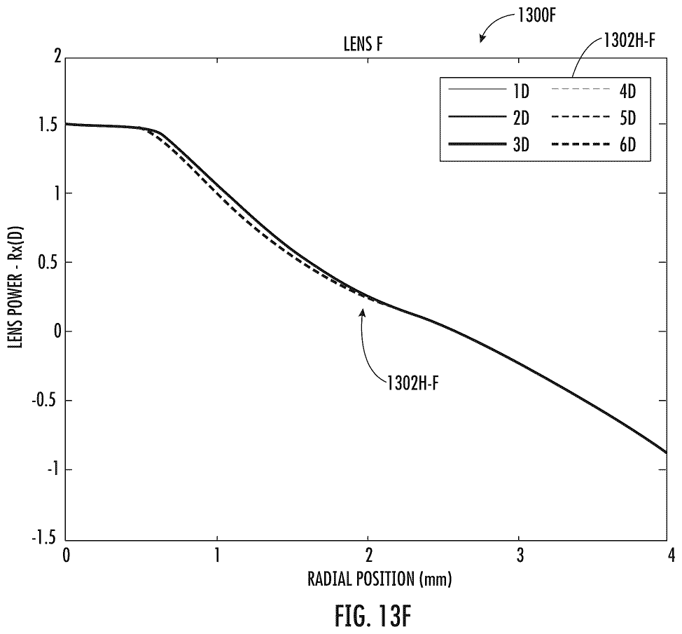

FIGS. 13A-13C are exemplary graphs 1300A, 1300B, 1300C that each include a respective low-add, mid-add, and high-add myopic power profiles 1302M-A, 1302M-B, 1302M-C for myopic-correcting lenses 1102M (for refractive error correction prescriptions −6 D, −5 D, −4 D, −3 D, −2 D, −1 D) in FIG. 11. The graphs 1300A, 1300B, 1300C plot lens power minus prescription Rx in diopters (D) as a function of radial position from the respective first optical axis A₁ of the myopic-correcting lenses 1102M in FIG. 11. The graph 1300A in FIG. 13A illustrates low-add myopic power profiles 1302M-A for the different refractive error correction prescriptions of low-add myopic-correcting lenses 1102M for a low-add label add power of 0.75 D, which can be thought of as a low-add power for patients having a lower or initial loss of accommodation. However, note that the low-add label add power could be between +0.5 D and +1.49 D. The graph 1300B in FIG. 13B illustrates mid-add myopic power profiles 1302M-B for the different refractive error correction prescriptions of mid-add myopic-correcting lenses 1102M for a mid-add label add power of +1.75 D, which can be thought of as a medium or mid-add power for patients having a higher loss of accommodation. However, note that the mid-add label add power could be between +1.5 D and +1.99 D. The graph 1300C in FIG. 13C illustrates high-add myopic power profiles 1302M-C for the different refractive error correction prescriptions of high-add myopic-correcting lenses 1102M for a high-add label add power of +2.5 D, which can be thought of as a high-add power for patients having the highest loss of accommodation. However, note that the high-add label add power could be between +2.0 D and +2.5 D.

The low-add, mid-add, and high-add myopic power profiles 1302M-A, 1302M-B, 1302M-C for the myopic-correcting lenses 1102M in FIGS. 13A-13C vary with respect to paraxial power, the radius R_{M1} of the first add optical zone 1104M, the effective add power (i.e., magnitude of the first add power) provided by the first add optical zone 1104M and the radius R_{M1} of the first add optical zone 1104M. However, with each low-add, mid-add, and high-add label add power group shown in the low-add, mid-add, and high-add myopic power profiles 1302M-A, 1302M-B, 1302M-C in FIGS. 13A-13C, the paraxial power, effective add power (i.e., magnitude of the first and second add powers) provided by the first add optical zone 1104M, and the radius R_{M1} of the first add optical zones 404M is relatively constant across the myopic refractive error correction prescriptions. In other words, for a given effective add power shown in the different label add power groups for the respective low-add, mid-add, and high-add myopic power profiles 1302M-A, 1302M-B, 1302M-C in FIGS. 13A-13C, the paraxial power, the effective add power and the radius R_{M1} of the first add optical zone 1104M are almost the same for each of the myopic refractive error correction prescriptions.

FIGS. 13D-13F are exemplary graphs 1300D, 1300E, 1300F that each include a respective low-add, mid-add, and high-add hyperopic power profiles 1302H-D, 1302H-E, 1302H-F for a plurality of the hyperopic-correcting lenses 1102H (for refractive error correction prescriptions +1 D, +2 D, +3 D, +4 D, +5 D, +6 D) in FIG. 11. The graphs 1300D, 1300E, 1300F plot lens power minus prescription Rx in diopters (D) as a function of radial position from the respective second optical axis A₂ of the hyperopic-correcting lens 1102H in FIG. 11. The graph 1300D in FIG. 13D illustrates low-add hyperopic power profiles 1302H-D for the different refractive error correction prescriptions of low-add hyperopic-correcting lenses 1102H for a low-add label add power of 0.75 D, which can be thought of as a low-add power for patients having a lower or initial loss of accommodation. However, note that the low-add label add power could be between +0.5 D and +1.49 D. The graph 1300E in FIG. 13E illustrates mid-add hyperopic power profiles 1302H-E for the different refractive error correction prescriptions of mid-add hyperopic-correcting lenses 1102H for a mid-add label add power of +1.75 D, which can be thought of as a medium or mid-add power for patients having a higher loss of accommodation. However, note that the mid-add label power could be between +1.5 D and +1.99 D. The graph 1300F in FIG. 13F illustrates high-add hyperopic power profiles 1302H-F for the different refractive error correction prescriptions of high-add hyperopic-correcting lenses 1102H for a high-add label add power of +2.5 D, which can be thought of as a high-add power for patients having the highest loss of accommodation. However, note that the high-add label add power could be between +2.0 D and +2.5 D.

The low-add, mid-add, and high-add hyperopic power profiles 1302H-D, 1302H-E, 1302H-F for the hyperopic-correcting lenses 1102H in FIGS. 13D-13F vary with respect to paraxial power, the radius R_{H2} of the second add optical zone 1104H, the effective add power (i.e., magnitude of the second add power) provided by the second add optical zone 1104H and the radius R_{H2} of the second add optical zone 1104H. However, with each low-add, mid-add, and high-add label add power group shown in the low-add, mid-add, and high-add hyperopic power profiles 1302H-D, 1302H-E, 1302H-F in FIGS. 13D-13F, the paraxial power, effective add power (i.e., magnitude of the second add power) provided by the second add optical zone 1104H, and the radius R_{H2} of the second add optical zone 1104H is relatively constant across the hyperopic refractive error correction prescriptions. In other words, for a given effective add power shown in the different label add power groups for the respective low-add, mid-add, and high-add hyperopic power profiles 1302H-D, 1302H-E, 1302H-F in FIGS. 13D-13F, the paraxial power, the effective add power and the radius R_{H2} of the second add optical zone 1104H are almost the same for each of the myopic refractive error correction prescriptions.

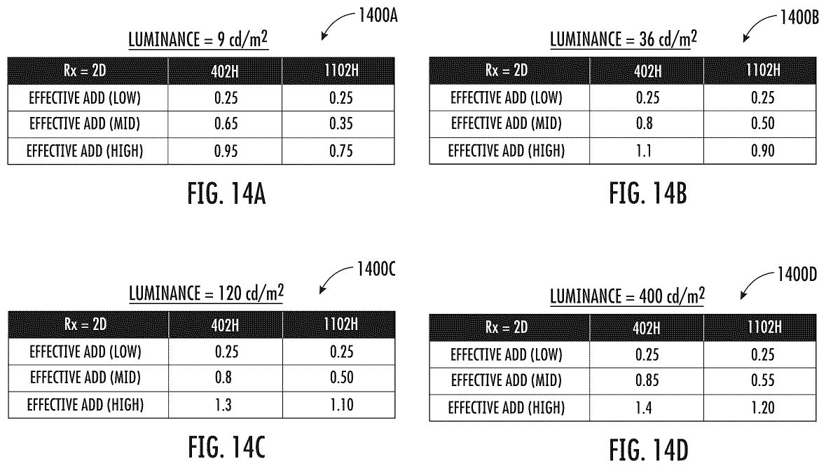

As discussed above, the effective add power (e.g., paraxial power) of the hyperopic-correcting lenses 1102H may be reduced over the effective label power (e.g., paraxial power) of the myopic-correcting lenses 1102M to further improve far-distance vision for hyperopes wearing the hyperopic-correcting lenses 1102H. This is shown, for example, by comparing the low-add myopic power profiles 1302M-A and the low-add hyperopic power profiles 1302H-D in FIGS. 13A and 13D for respective low-add label add power myopic-correcting and hyperopic-correcting lenses 1102M, 1102H. This is also shown in tables 1400A-1400D in FIGS. 14A-14D, described in more detail below, illustrating respective exemplary monocular effective add powers (in diopters) of the hyperopic-correcting lens 1102H in the multifocal contact lens system 1100 in FIG. 11 as compared to the hyperopic-correcting lens 402H in the multifocal contact lens system 400 in FIG. 4 for various respective luminances of 9 cd/mm², 36 cd/mm², 120 cd/mm², and 400 cd/mm², as shown.

For example, the low-add label add power of one or more low-add hyperopic-correcting lenses 1102H, shown by their low-add hyperopic power profiles 1302H-D in FIG. 13D, may be reduced between GD and +0.15 D with respect to the low-add label add power of one or more low-add myopic-correcting lenses 1102M shown by their low-add myopic power profiles 1302M-A in FIG. 13A. This is also shown, for example, by comparing the mid-add myopic power profiles 1302M-B and the mid-add hyperopic power profiles 1302H-E in FIGS. 13B and 13E for respective mid-add label add power myopic-correcting and hyperopic-correcting lenses 1102M, 1102H. For example, the mid-add label add power of one or more mid-add hyperopic-correcting lenses 1102H, shown by their mid-add hyperopic power profiles 1302H-E in FIG. 13E, may be reduced between +0.20 D and +0.50 D with respect to the mid-add label add power of one or more mid-add myopic-correcting lenses 1102M shown by their mid-add myopic power profiles 1302M-B in FIG. 13B. This is also shown, for example, by comparing the high-add myopic power profiles 1302M-C and the high-add hyperopic power profiles 1302H-F in FIGS. 13C and 13F for respective high-add label add power myopic-correcting and hyperopic-correcting lenses 1102M, 1102H. For example, the high-add label add power of one or more high-add hyperopic-correcting lenses 1102H, shown by their high-add hyperopic power profiles 1302H-F in FIG. 13F, may be reduced between +0.15 D and −0.15 D with respect to the high-add label add power of one or more high-add myopic-correcting lenses 1102M shown by their high-add myopic power profiles 1302M-C in FIG. 13C.

For example, in the multifocal contact lens system 1100 in FIG. 11, the effective mid-add power (e.g., at least +1.5 D (e.g., add need of +1.5 D to +1.75 D)) in the mid-add hyperopic power profiles 1302H-E of the mid-add hyperopic-correcting lenses 1102H shown in FIG. 13E may be reduced by at least +0.2 D as compared to their counterpart mid-add myopic-correcting lenses 1102M represented by the mid-add myopic power profiles 1302M-B in FIG. 13B. Also, the effective high-add power (e.g., add need of +2.0 D to +2.5 D) in the mid-add hyperopic power profiles 1302H-E in the hyperopic-correcting lenses 1102H shown in FIG. 13F may be reduced by at least +0.2 D (e.g., add need of +0.3 D) as compared to their counterpart high-add myopic-correcting lenses 1102M represented by the high-add myopic power profiles 1302M-C in FIG. 13C.

Further, in the multifocal contact lens system 1100 in FIG. 11, the low-add DOF of one or more low-add hyperopic-correcting lenses 1102H, shown by their low-add hyperopic power profiles 1302H-D in FIG. 13D, may be changed by between +0.10 D and −0.10 D with respect to one or more low-add myopic-correcting lenses 1102M shown by their low-add myopic power profiles 1302M-A in FIG. 13A. In another example, the mid-add DOF of one or more mid-add hyperopic-correcting lenses 1102H, shown by their mid-add hyperopic power profiles 1302H-E in FIG. 13E, may be changed by between +0.05 D and −0.25 D with respect to one or more mid-add myopic-correcting lenses 1102M shown by their mid-add myopic power profiles 1302M-B in FIG. 13B. In another example, the high-add DOF of one or more high-add hyperopic-correcting lenses 1102H, shown by their high-add hyperopic power profiles 1302H-F in FIG. 13F, may be changed by between +0.15 D and −0.15 D with respect to one or more high-add myopic-correcting lenses 1102M shown by their high-add myopic power profiles 1302M-C in FIG. 13C.

As another example, as shown in the low-add myopic power profiles 1302M-A in FIG. 13A, the first add optical zone 1104M of the low-add myopic-correcting lenses 1102M may have an add optical zone radius (one half of diameter D_{C1}) between 0 mm and 0.23 mm. The first transitional optical zone 1106M(1) of the low-add myopic-correcting lenses 1102M may have a radius relative to the first optical axis A₁ between 0.23 mm and 0.43 mm, with the first add power of the first add optical zone 1104M being between +0.002 D and +0.003 D. The first transitional optical zone 1106M(2) of the low-add myopic-correcting lenses 1102M may have a radius relative to the first optical axis A₁ between 0.44 mm and 0.67 mm, with the first add power of the first add optical zone 1104M being between +0.002 D and +0.003 D. The first transitional optical zone 1106M(2) of the low-add myopic-correcting lenses 1102M may have a radius relative to the first optical axis A₁ between 0.67 mm and 2.0 mm, with the first add power of the first add optical zone 1104M being between +0.0005 D and +0.001 D. The low-add myopic-correcting lenses 1102M may have a final distance optical zone extrapolated paraxial power of between +0.336 D and +0.537 D relative to the paraxial power of the refractive need.

As another example, as shown in the mid-add myopic power profiles 1302M-B in FIG. 13B, the first add optical zone 1104M of the mid-add myopic-correcting lenses 1102M may have an add optical zone add optical zone radius (one half of diameter D_{C1}) between 0 mm and 0.78 mm. The first transitional optical zone 1106M(1) of the mid-add myopic-correcting lenses 1102M may have a radius relative to the first optical axis A₁ between 0.78 mm and 1.06 mm, with the first add power of the first add optical zone 1104M being between +0.343 D and +0.425 D. The first transitional optical zone 1106M(2) of the mid-add myopic-correcting lenses 1102M may have a radius relative to the first optical axis A₁ between 1.06 mm and 1.49 mm, with the first add power of the first add optical zone 1104M being between +0.262 D and +0.344 D. The first transitional optical zone 1106M(3) of the mid-add myopic-correcting lenses 1102M may have a radius relative to the first optical axis A₁ between 1.49 mm and 2.0 mm, with the first add power of the first add optical zone 1104M being between +0.060 D and +0.142 D. The mid-add myopic-correcting lenses 1102M may have a final distance optical zone extrapolated paraxial power of between +0.559 D and +0.760 D relative to the paraxial power of the refractive need.

As another example, as shown in the high-add myopic power profiles 1302M-C in FIG. 13C, the first add optical zone 1104M of the high-add myopic-correcting lenses 1102M may have an add optical zone radius (one half of diameter D_{C1}) between 0 mm and 0.64 mm. The first transitional optical zone 1106M(1) of the high-add myopic-correcting lenses 1102M may have a radius relative to the first optical axis A₁ between 0.64 mm and 0.94 mm, with the first add power of the first add optical zone 1104M being between +0.845 D and +1.045 D. The first transitional optical zone 1106M(2) of the high-add myopic-correcting lenses 1102M may have a radius relative to the first optical axis A₁ between 0.94 mm and 1.43 mm, with the first add power of the first add optical zone 1104M being between +0.646 D and +0.846 D. The first transitional optical zone 1106M(2) of the high-add myopic-correcting lenses 1102M may have a radius relative to the first optical axis A₁ between 1.43 mm and 2.0 mm, with the first add power of the first add optical zone 1104M being between +0.149 D and +0.349 D. The high-add myopic-correcting lenses 1102M may have a final distance optical zone extrapolated paraxial power of between +0.628 D and +0.828 D relative to the paraxial power of the refractive need.

As another example, as shown in the low-add hyperopic power profiles 1302H-D in FIG. 13D, the second add optical zone 1104H of the low-add hyperopic-correcting lenses 1102H may have an add optical zone radius (one half of diameter D_{C2}) between 0 mm and 0.23 mm. The first transitional optical zone 1106M(1) of the low-add hyperopic-correcting lenses 1102H may have a radius relative to the second optical axis A₂ between 0.23 mm and 0.43 mm, with the second add power of the second add optical zone 1104H being between +0.002 D and +0.003 D. The second transitional optical zone 1106H(2) of the low-add hyperopic-correcting lenses 1102H may have a radius relative to the second optical axis A₂ between 0.44 mm and 0.67 mm, with the first add power of the first add optical zone 1104M being between +0.0005 D and +0.001 D. The second transitional optical zone 1106H(2) of the low-add hyperopic-correcting lenses 1102H may have a radius relative to the second optical axis A₂ between 0.67 mm and 2.0 mm, with the second add power of the second add optical zone 1104H being between +0.0005 D and +0.001 D. The low-add hyperopic-correcting lenses 1102H may have a final distance optical zone extrapolated paraxial power of between +0.336 D and +0.537 D relative to the paraxial power of the refractive need.

As another example, as shown in the mid-add hyperopic power profiles 1302H-E in FIG. 13E, the second add optical zone 1104H of the mid-add hyperopic-correcting lenses 1102H may have an add optical zone radius (one half of diameter D_{C2}) between 0 mm and 0.73 mm. The first transitional optical zone 1106M(1) of the mid-add hyperopic-correcting lenses 1102H may have a radius relative to the second optical axis A₂ between 0.73 mm and 0.98 mm, with the second add power of the second add optical zone 1104H being between +0.343 D and +0.425 D. The second transitional optical zone 1106H(2) of the mid-add hyperopic-correcting lenses 1102H may have a radius relative to the second optical axis A₂ between 0.98 mm and 1.38 mm, with the first add power of the first add optical zone 1104M being between +0.262 D and +0.344 D. The second transitional optical zone 1106H(2) of the mid-add hyperopic-correcting lenses 1102H may have a radius relative to the second optical axis A₂ between 1.38 mm and 2.0 mm, with the second add power of the second add optical zone 1104H being between +0.060 D and +0.142 D. The mid-add hyperopic-correcting lenses 1102H may have a final distance optical zone extrapolated paraxial power of between +0.259 D and +0142 D relative to the paraxial power of the refractive need.

As another example, as shown in the high-add hyperopic power profiles 1302H-F in FIG. 13F, the second add optical zone 1104H of the high-add hyperopic-correcting lenses 1102H may have an add optical zone radius (one half of diameter D_{C2}) between 0 mm and 0.59 mm. The second transitional optical zone 1106H(1) of the high-add hyperopic-correcting lenses 1102H may have a radius relative to the second optical axis A₂ between 0.59 mm and 0.87 mm, with the second add power of the second add optical zone 1104H being between +0.845 D and 1.045 D. The second transitional optical zone 1106H(2) of the high-add hyperopic-correcting lenses 1102H may have a radius relative to the second optical axis A₂ between 0.87 mm and 1.33 mm, with the first add power of the first add optical zone 1104M being between +0.646 D and +0.846 D. The second transitional optical zone 1106H(2) of the high-add hyperopic-correcting lenses 1102H may have a radius relative to the second optical axis A₂ between 1.33 mm and 2.0 mm, with the second add power of the second add optical zone 1104H being between +0.149 D and +0.349 D. The high-add hyperopic-correcting lenses 1102H may have a final distance optical zone extrapolated paraxial power of between +0.428 D and +0.629 D relative to the paraxial power of the refractive need.

FIGS. 14A-14D are tables 1400A-1400D illustrating respective exemplary monocular effective add powers (in diopters) of the hyperopic-correcting lens 1102H in the multifocal contact lens system 1100 in FIG. 11 as compared to the hyperopic-correcting lens 402H in the multifocal contact lens system 400 in FIG. 4 for various respective luminances of 9 cd/mm², 36 cd/mm², 120 cd/mm², and 400 cd/mm², as shown. The monocular effective add powers for the hyperopic-correcting lens 1102H and the hyperopic-correcting lens 402H are for a label add power of +2.0 D. Each table 1400A-1440D shows monocular effective add powers for the low-add, mid-add, and high-add hyperopic-correcting lens 1102H represented by the respective hyperopic power profiles 1302H-D, 1302H-E, 1302H-F in FIGS. 13D-13 as compared to the monocular effective add powers for the hyperopic-correcting lens 402H is represented by the respective hyperopic power profiles 502H-A, 502H-B, 502H-C in FIGS. 13D-13F, for respective luminances.

As shown in tables 1400A-1400 D FIGS. 14A-14D, given the advantage of binocular disparity afforded by the myopic-correcting and hyperopic-correcting lens 1102M, 1102H in the multifocal contact lens system 1100 in FIG. 11, it is desired to improve the distance vision. As discussed above, in an effort to improve distance vision for the mid-add and high-add hyperopic-correcting lens 1102H, the effective add power in the mid-add hyperopic-correcting lenses 1102H is reduced more than reduced in the high-add hyperopic-correcting lenses 1102H. Thus, in multifocal contact lens system 1100 in FIG. 11, the effective add power of the mid-add ADD hyperopic-correcting lenses 1102H is reduced (by adjusting the lens design paraxial power) by 0.3 D. The effective add power of the high-add hyperopic-correcting lenses 1102H lens is reduced by 0.2 D. With the multifocal contact lens system 1100 in FIG. 11, the mid-add hyperopic-correcting lenses 1102H would generally provide better near in dim light and better distance in bright conditions. In the high-add patients, fitting the patient with a mid-add hyperopic-correcting lens 1102H in the dominant eye and a high-add hyperopic-correcting lens 1102H in the non-dominant eye would generally provide better distance (at dim) and better near performance. Note that in this example, the intraocular disparity between the mid-add hyperopic-correcting lenses 1102H and high-add hyperopic-correcting lenses 1102H remains within the 0.4 D to 0.6 D range, an amount thought to be acceptable without causing a substantiative compromise in binocular summation.

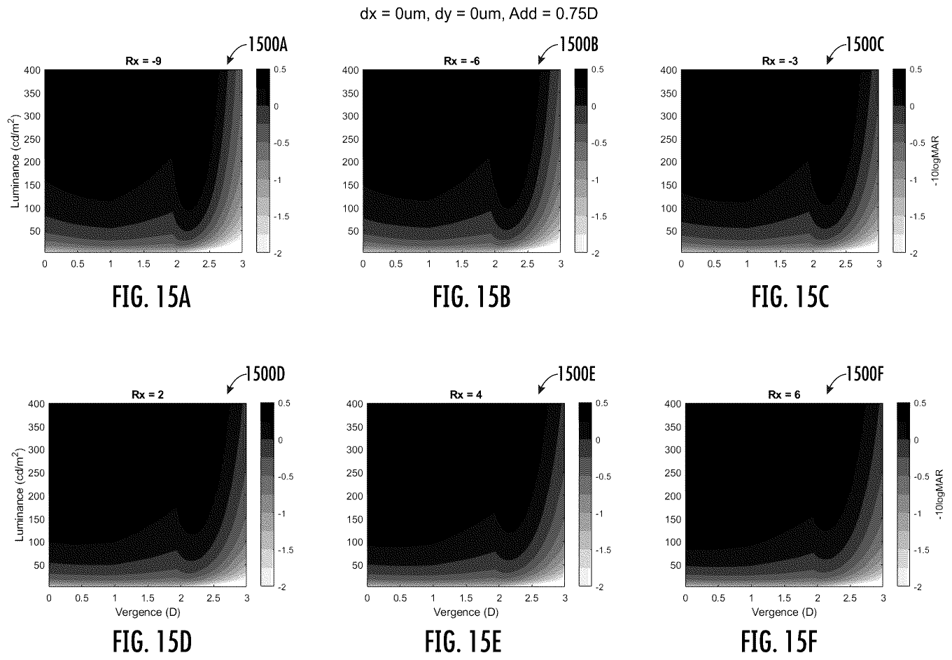

FIGS. 15A-22F illustrate exemplary cyclopean visual performance shown as luminance (in cd/m²) and MAR (as −10 log MAR) plotted as a function of vergence (in diopters) of different myopic and hyperopic refractive error correction prescriptions (Rx) of the myopic-correcting and hyperopic-correcting lenses 1102M, 1102H in FIG. 11. In this example, these myopic-correcting and hyperopic-correcting lenses 1102M, 1102H are represented by the respective myopic power profiles 1302M-A, 1302M-B, 1302M-C and hyperopic power profiles 1302H-D, 1302H-E, 1302H-F in respective FIGS. 13A-13F previously discussed. Plotting the cyclopean visual performance of the myopic-correcting and hyperopic-correcting lenses 1102M, 1102H in FIGS. 15A-22F enables the ability to study the total multifocal contact lens system 400. As shown in FIGS. 15A-22F, the cyclopean visual performance of the hyperopic-correcting lenses 1102H in the multifocal contact lens system 1100 exhibits a significant improvement in distance vision when comparing cyclopean visual performance shown in FIGS. 15D-15F, 16D-16F, 17D-17F, 18D-18F, 19D-19F, 20D-20F, 21D-21F, 22D-22F for various label add powers for hyperopes wearing the hyperopic-correcting lenses 1102H, as compared to cyclopean visual performance shown in FIGS. 15A-15C, 16A-16C, 17A-17C, 18A-18C, 19A-19C, 20A-20C, 21A-21C, 22A-22C for myopes wearing the myopic-correcting lenses 1102M.

In this regard, FIGS. 15A-15C are exemplary plots 1500A, 1500B, 1500C of cyclopean visual performance shown as luminance (in cd/m²) and MAR (as −10 log MAR) plotted as a function of vergence (in diopters) of different myopic refractive error correction prescriptions (Rx) of the low-add myopic-correcting lenses 1102M in FIG. 11 represented by the respective low-add myopic power profiles 1302M-A in FIG. 13A for a low-add label add power of +0.75 D. FIGS. 15D-15F are exemplary plots 1500D, 1500E, 1500F of cyclopean visual performance shown as MAR (as −10 log MAR) as a function of luminance (in candela (cd) per meter squared (m2) cd/m2), and vergence (in diopters) of hyperopic refractive error correction prescriptions (Rx) of the low-add hyperopic-correcting lenses 1102H in FIG. 11 represented by the respective low-add hyperopic power profiles 1302H-D in FIG. 13D for a low-add label add power of +0.75 D.

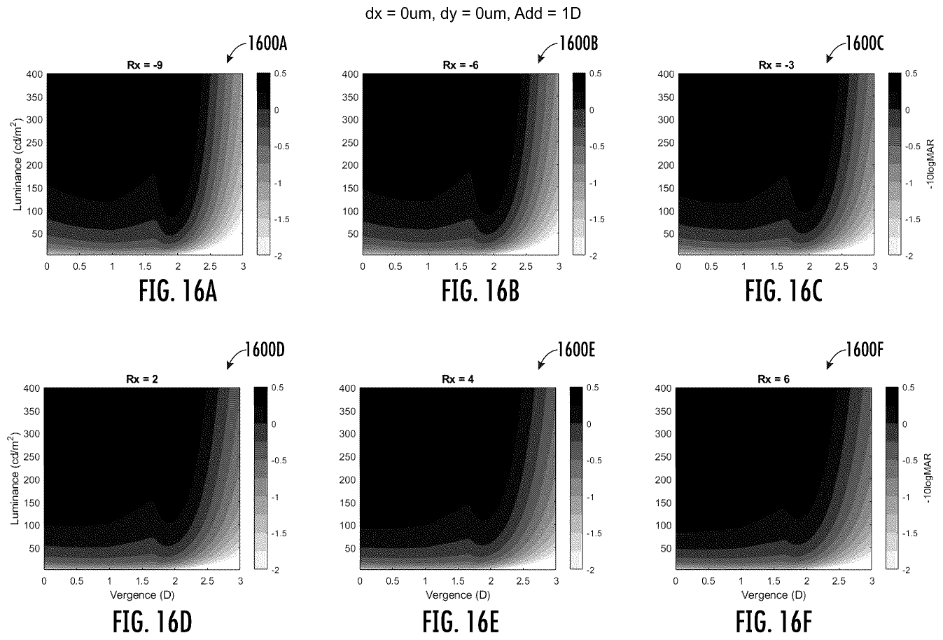

FIGS. 16A-16C are exemplary plots 1600A, 1600B, 1600C of cyclopean visual performance shown as luminance (in cd/m²) and MAR (as −10 log MAR) plotted as a function of vergence (in diopters) of different myopic refractive error correction prescriptions (Rx) of the low-add myopic-correcting lenses 1102M in FIG. 11 represented by the respective low-add myopic power profiles 1302M-A in FIG. 13A for a low-add label add power of +1.0 D. FIGS. 16D-16F are exemplary plots 1600D, 1600E, 1600F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the low-add hyperopic-correcting lenses 1102H in FIG. 11 represented by the respective low-add hyperopic power profiles 1302H-D in FIG. 13D for a low-add label add power of +1.0 D.

FIGS. 17A-17C are exemplary plots 1700A, 1700B, 1700C of cyclopean visual performance shown as luminance (in cd/m²) and MAR (as −10 log MAR) plotted as a function of vergence (in diopters) of different myopic refractive error correction prescriptions (Rx) of the low-add myopic-correcting lenses 1102M in FIG. 11 represented by the respective low-add myopic power profiles 1302M-A in FIG. 13A for a low-add label add power of +1.25 D. FIGS. 17D-17F are exemplary plots 1700D, 1700E, 1700F of cyclopean visual performance shown as MAR (as −10 log MAR) as a function of luminance (in candela (cd) per meter squared (m2) cd/m2), and vergence (in diopters) of hyperopic refractive error correction prescriptions (Rx) of the low-add hyperopic-correcting lenses 1102H in FIG. 11 represented by the respective low-add hyperopic power profiles 1302H-D in FIG. 13D for a low-add label add power of +1.25 D.

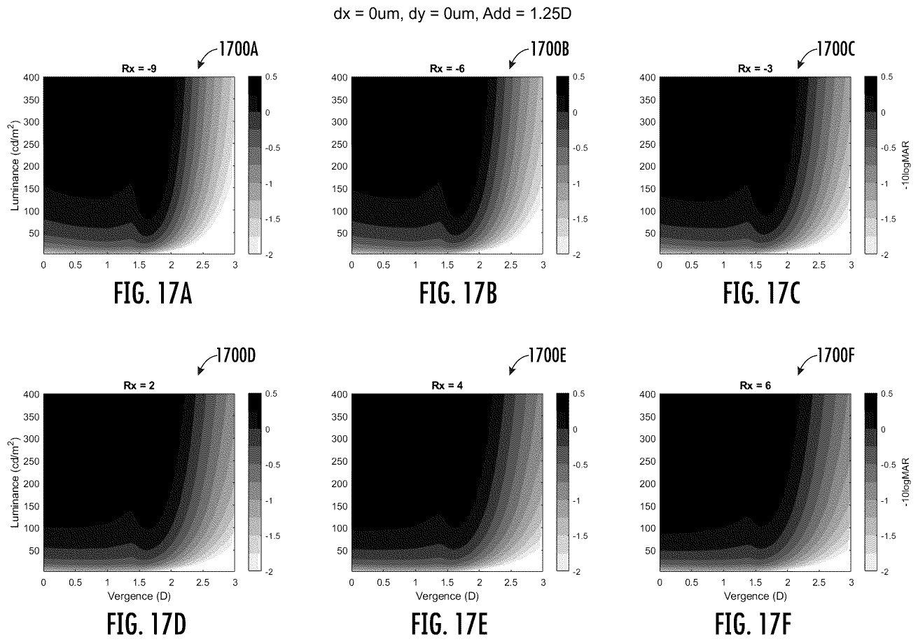

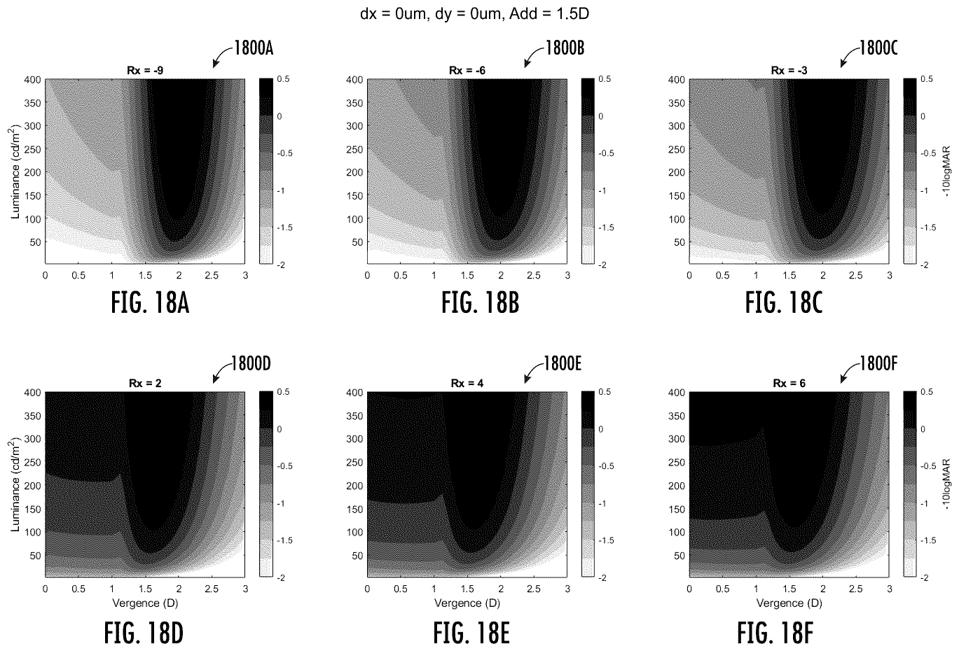

FIGS. 18A-18C are exemplary plots 1800A, 1800B, 1800C of cyclopean visual performance shown as luminance (in cd/m²) and MAR (as −10 log MAR) plotted as a function of vergence (in diopters) of different myopic refractive error correction prescriptions (Rx) of the mid-add myopic-correcting lenses 1102M in FIG. 11 represented by the respective mid-add myopic power profiles 1302M-B in FIG. 13B for a mid-add label add power of +1.5 D. FIGS. 18D-18F are exemplary plots 1800D, 1800E, 1800F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the mid-add hyperopic-correcting lenses 1102H in FIG. 11 represented by the respective mid-add hyperopic power profiles 1302H-E in FIG. 13E for a mid-add label add power of +1.5 D.

FIGS. 19A-19C are exemplary plots 1900A, 1900B, 1900C of cyclopean visual performance shown as luminance (in cd/m²) and MAR (as −10 log MAR) plotted as a function of vergence (in diopters) of different myopic refractive error correction prescriptions (Rx) of the mid-add myopic-correcting lenses 1102M in FIG. 11 represented by the respective mid-add myopic power profiles 1302M-B in FIG. 13B for a mid-add label add power of +1.75 D. FIGS. 19D-19F are exemplary plots 1900D, 1900E, 1900F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the mid-add hyperopic-correcting lenses 1102H in FIG. 11 represented by the respective mid-add hyperopic power profiles 1302H-E in FIG. 13E for a mid-add label add power of +1.75 D.

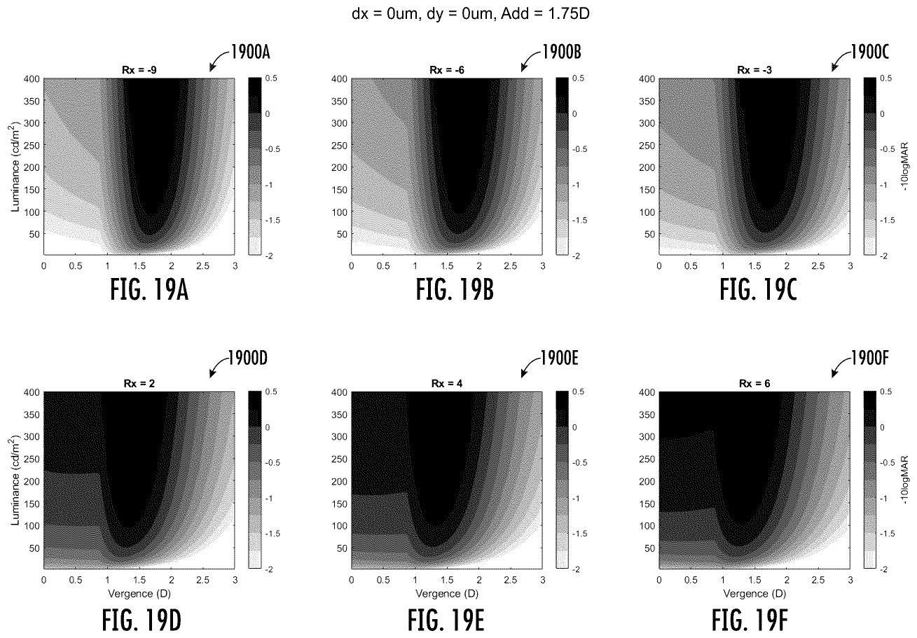

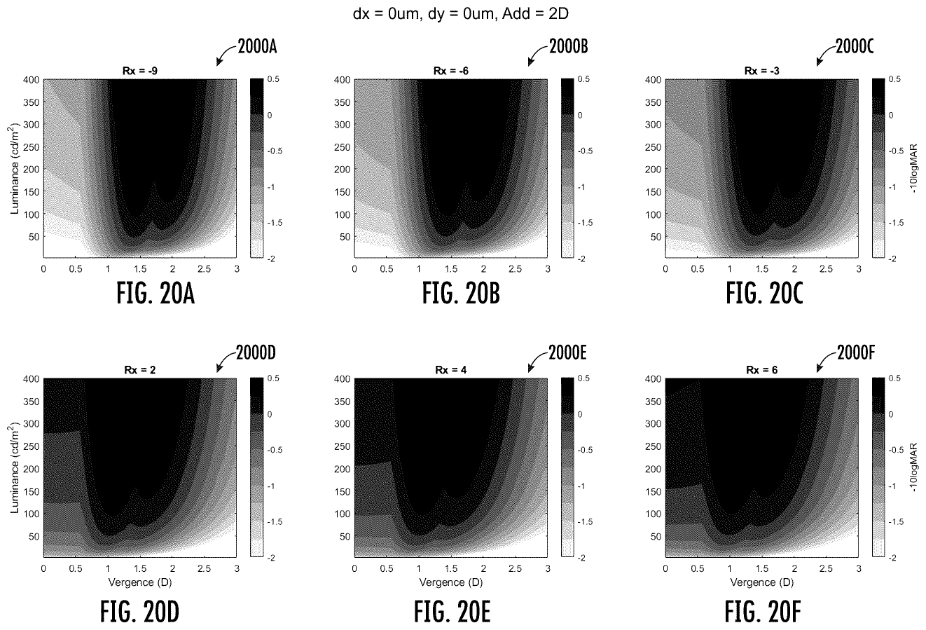

FIGS. 20A-20C are exemplary plots 2000A, 2000B, 2000C of cyclopean visual performance shown as luminance (in cd/m²) and MAR (as −10 log MAR) plotted as a function of vergence (in diopters) of different myopic refractive error correction prescriptions (Rx) of the mid-add myopic-correcting lenses 1102M in FIG. 11 represented by the respective mid-add myopic power profiles 1302M-B in FIG. 13B for a mid-add label add power of +2.0 D. FIGS. 20D-20F are exemplary plots 2000D, 2000E, 2000F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the mid-add hyperopic-correcting lenses 1102H in FIG. 11 represented by the respective mid-add hyperopic power profiles 1302H-E in FIG. 13E for a mid-add label add power of +2.0 D.

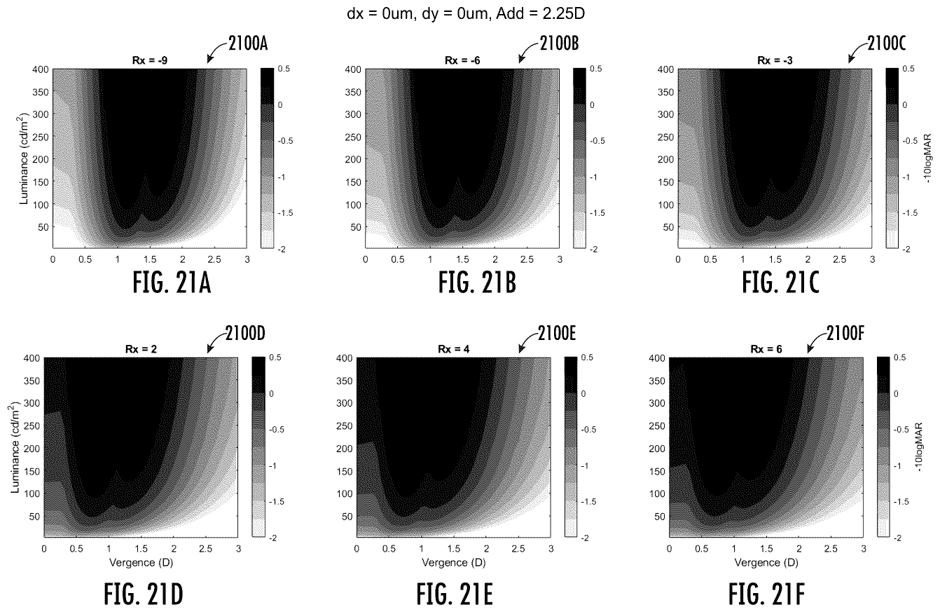

FIGS. 21A-21C are exemplary plots 2100A, 2100B, 2100C of cyclopean visual performance shown as luminance (in cd/m²) and MAR (as −10 log MAR) plotted as a function of vergence (in diopters) of different myopic refractive error correction prescriptions (Rx) of the high-add myopic-correcting lenses 1102M in FIG. 11 represented by the respective high-add myopic power profiles 1302M-C in FIG. 13C for a high-add label add power of +2.25 D. FIGS. 21D-21F are exemplary plots 2100D, 2100E, 2100F of cyclopean visual performance shown as MAR (as −10 log MAR) as a function of luminance (in candela (cd) per meter squared (m2) cd/m2), and vergence (in diopters) of hyperopic refractive error correction prescriptions (Rx) of the high-add hyperopic-correcting lenses 1102H in FIG. 11 represented by the respective high-add hyperopic power profiles 1302H-F in FIG. 13F for a mid-add label add power of +2.25 D.

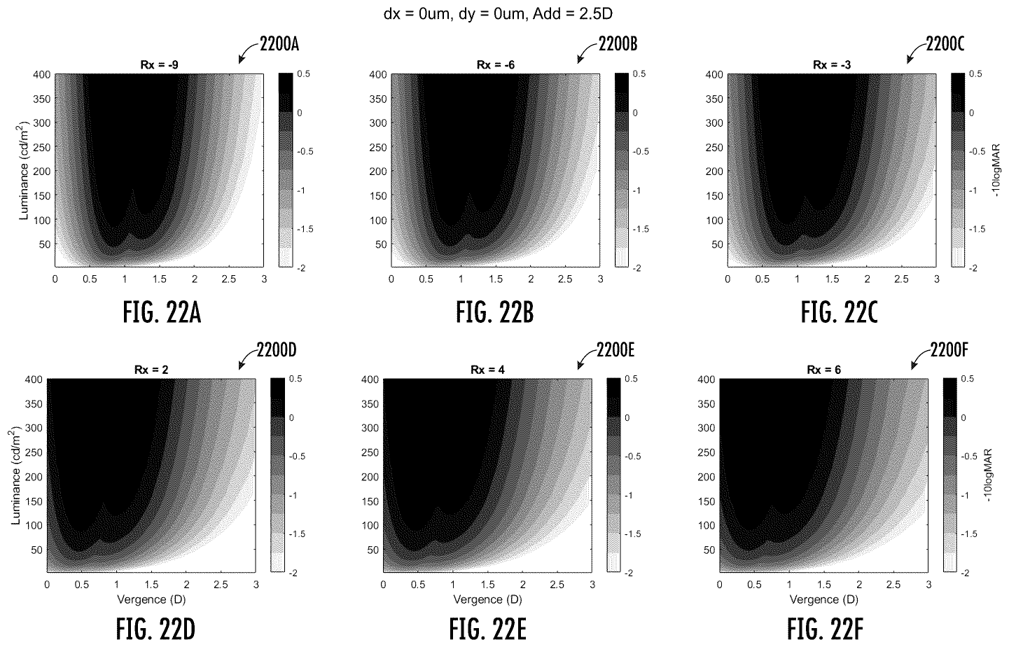

FIGS. 22A-22C are exemplary plots 2200A, 2200B, 2200C of cyclopean visual performance shown as luminance (in cd/m²) and MAR (as −10 log MAR) plotted as a function of vergence (in diopters) of different myopic refractive error correction prescriptions (Rx) of the high-add myopic-correcting lenses 1102M in FIG. 11 represented by the respective high-add myopic power profiles 1302M-C in FIG. 13C for a high-add label add power of +2.5 D. FIGS. 22D-22F are exemplary plots 2200D, 2200E, 2200F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the high-add hyperopic-correcting lenses 1102H in FIG. 11 represented by the respective high-add hyperopic power profiles 1302H-F in FIG. 13F for a mid-add label add power of +2.5 D.

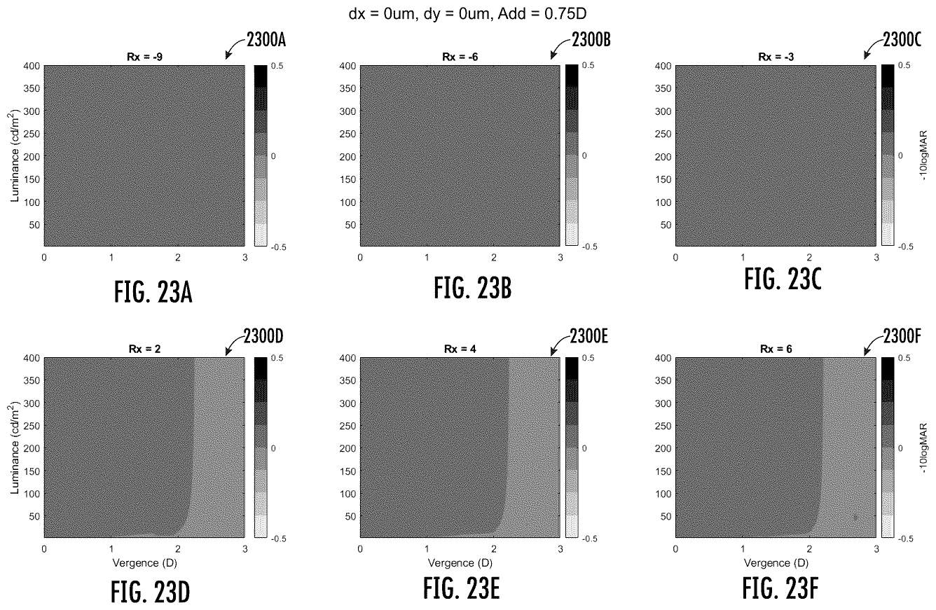

FIGS. 23A-25F are exemplary plots of the difference in cyclopean visual performance as luminance difference plotted as a function of vergence (in diopters) between different refractive error correction prescriptions (Rx) myopic-correcting and hyperopic-correcting lenses 1102M, 1102H in the multifocal contact lens system 1100 in FIG. 11, as compared to the myopic-correcting and hyperopic-correcting lenses 402M, 402H in the multifocal contact lens system 400 in FIG. 4.

In this regard, FIGS. 23A-23C are exemplary plots 2300A, 2300B, 2300B of the difference in cyclopean visual performance as luminance difference plotted as a function of vergence (in diopters) between different refractive error correction prescriptions (Rx) of low-add myopic-correcting lenses 1102M represented by the respective low-add myopic power profiles 1302M-A in FIG. 13A for a low-add label add power of +0.75 D, and compared to the plots 600A-600C of cyclopean visual performance in FIGS. 6A-6C for the corresponding different refractive error correction prescriptions (Rx) of low-add myopic-correcting lenses 402M for a corresponding low-add label add power of +0.75 D. FIGS. 23D-23F are exemplary plots 2300D, 2300E, 2300F of the difference in cyclopean visual performance as luminance difference plotted as a function of vergence (in diopters) between different refractive error correction prescriptions (Rx) of low-add hyperopic-correcting lenses 1102H represented by the respective low-add hyperopic power profiles 1302H-F in FIG. 13D for a low-add label add power of +0.75 D, as compared to the plots 600D-600F of cyclopean visual performance in FIGS. 6D-6F for the corresponding different refractive error correction prescriptions (Rx) of low-add hyperopic-correcting lenses 402H for a corresponding low-add label add power of +0.75 D.

As shown in the cyclopean visual performance plots 2300D-2300F in FIGS. 23D-23F, the low-add hyperopic-correcting lenses 1102H in the multifocal contact lens system 1100 in FIG. 11 exhibit better far-distance vision performance as compared to the low-add hyperopic-correcting lenses 402H in the multifocal contact lens system 400 in FIG. 4 for low-add label add powers. However, the low-add hyperopic-correcting lenses 402H in the multifocal contact lens system 400 in FIG. 4 exhibit slightly better near-distance vision than the low-add hyperopic-correcting lenses 1102H in the multifocal contact lens system 1100 in FIG. 11 for low-add label add powers. This is due in part to the reduced add optical zone radius (one-half of diameter D_{C2}) of the hyperopic-correcting lenses 1102H in the multifocal contact lens system 1100 in FIG. 11 as compared to the add optical zone radius (one-half of diameter D_{C1}) of the myopic-correcting lenses 1102M in the multifocal contact lens system 1100 in FIG. 11. A reduced add optical zone radius (one-half of diameter D_{C2}) of the hyperopic-correcting lenses 1102H will provide for less light to be received in the hyperope pupil through the second add optical zone 1104H when focused at near distances.

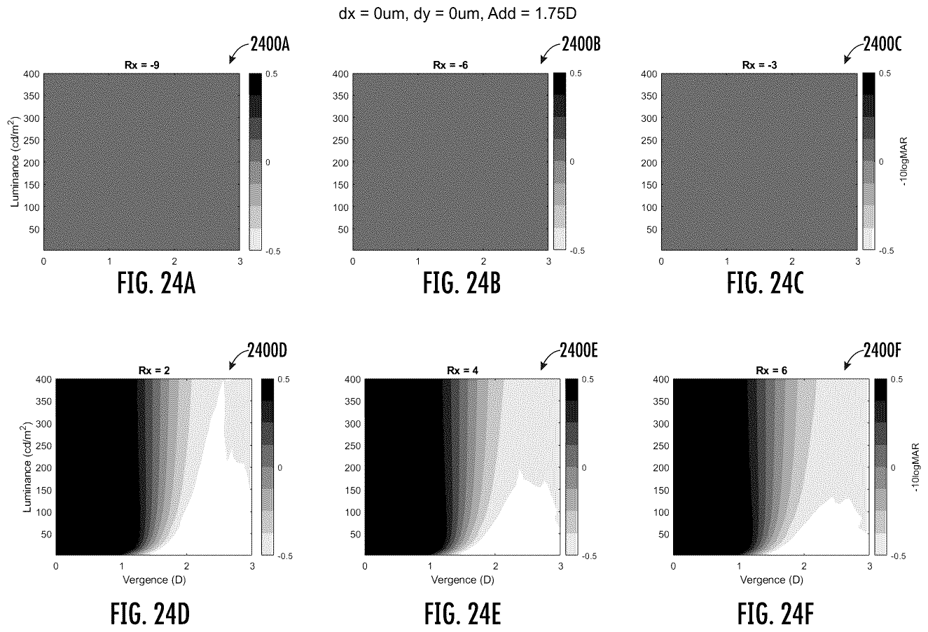

FIGS. 24A-24C are exemplary plots 2400A, 2400B, 2400C of the difference in v cyclopean visual performance as luminance difference plotted as a function of vergence (in diopters) between different refractive error correction prescriptions (Rx) of mid-add myopic-correcting lenses 1102M represented by the respective mid-add myopic power profiles 1302M-B in FIG. 13B for a mid-add label add power of +1.75 D, and compared to the plots 700A-700C of cyclopean visual performance in FIGS. 7A-7C for the corresponding different refractive error correction prescriptions (Rx) of mid-add myopic-correcting lenses 402M for a corresponding mid-add label add power of +1.75 D. FIGS. 24D-24F are exemplary plots 2400D, 2400E, 2400F of the difference in cyclopean visual performance as luminance difference plotted as a function of vergence (in diopters) between different refractive error correction prescriptions (Rx) of mid-add hyperopic-correcting lenses 1102H represented by the respective mid-add hyperopic power profiles 1302H-E in FIG. 13E for a mid-add label add power of +1.75 D, as compared to the plots 700D-700F of cyclopean visual performance in FIGS. 7D-7F for the corresponding different refractive error correction prescriptions (Rx) of mid-add hyperopic-correcting lenses 402H for a corresponding mid-add label add power of +1.75 D.

As shown in the cyclopean visual performance plots 2400D-2400F in FIGS. 24D-24F, the mid-add hyperopic-correcting lenses 1102H in the multifocal contact lens system 1100 in FIG. 11 exhibit better far-distance vision performance as compared to the mid-add hyperopic-correcting lenses 402H in the multifocal contact lens system 400 in FIG. 4 for mid-add label add powers. However, the mid-add hyperopic-correcting lenses 402H in the multifocal contact lens system 400 in FIG. 4 exhibit slightly better near-distance vision than the mid-add hyperopic-correcting lenses 1102H in the multifocal contact lens system 1100 in FIG. 11 for mid-add label add powers. This is due in part to the reduced add optical zone radius (one-half of diameter D_{C2}) of the hyperopic-correcting lenses 1102H in the multifocal contact lens system 1100 in FIG. 11 as compared to the add optical zone radius (one-half of diameter D_{C1}) of the myopic-correcting lenses 1102M in the multifocal contact lens system 1100 in FIG. 11. A reduced add optical zone radius (one-half of diameter D_{C2}) of the hyperopic-correcting lenses 1102H will provide for less light to be received in the hyperope pupil through the second add optical zone 1104H when focused at near distances.

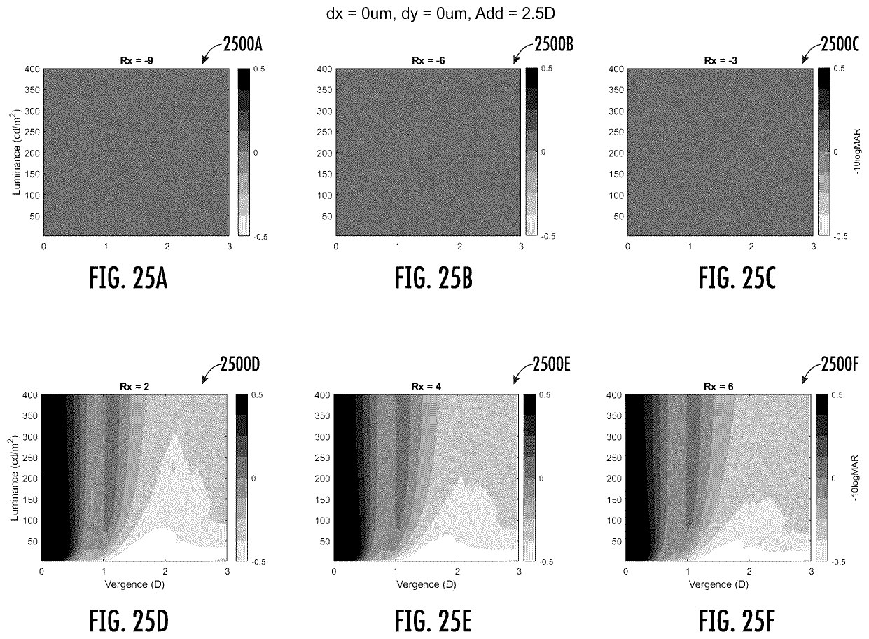

FIGS. 25A-25C are exemplary plots 2500A, 2500B, 2500B of the difference in cyclopean visual performance as luminance difference plotted as a function of vergence (in diopters) between different refractive error correction prescriptions (Rx) of high-add myopic-correcting lenses 1102M represented by the respective high-add myopic power profiles 1302M-C in FIG. 13C for a high-add label add power of +2.5 D, and compared to the plots 800A-800C of cyclopean visual performance in FIGS. 8A-8C for the corresponding different refractive error correction prescriptions (Rx) of high-add myopic-correcting lenses 402M for a corresponding high-add label add power of +2.5 D. FIGS. 25D-25F are exemplary plots 2500D, 2500E, 2500F of the difference in cyclopean visual performance as luminance difference plotted as a function of vergence (in diopters) between different refractive error correction prescriptions (Rx) of high-add hyperopic-correcting lenses 1102H represented by the respective high-add hyperopic power profiles 1302H-F in FIG. 13F for a high-add label add power of +2.5 D, as compared to the plots 800D-800F of cyclopean visual performance in FIGS. 8D-8F for the corresponding different refractive error correction prescriptions (Rx) of high-add hyperopic-correcting lenses 402H for a corresponding high-add label add power of +2.5 D.

As shown in the cyclopean visual performance plots 2500D-2500F in FIGS. 25D-25F, the high-add hyperopic-correcting lenses 1102H in the multifocal contact lens system 1100 in FIG. 11 exhibit better far-distance vision performance as compared to the high-add hyperopic-correcting lenses 402H in the multifocal contact lens system 400 in FIG. 4 for high-add label add powers. However, the high-add hyperopic-correcting lenses 402H in the multifocal contact lens system 400 in FIG. 4 exhibit better near-distance vision in low luminance levels than the high-add hyperopic-correcting lenses 1102H in the multifocal contact lens system 1100 in FIG. 11 for high-add label add powers. This is due in part to the reduced add optical zone radius (one-half of diameter D_{C2}) of the hyperopic-correcting lenses 1102H in the multifocal contact lens system 1100 in FIG. 11 as compared to the add optical zone radius (one-half of diameter D_{C1}) of the myopic-correcting lenses 1102M in the multifocal contact lens system 1100 in FIG. 11. A reduced add optical zone radius (one-half of diameter D_{C2}) of the hyperopic-correcting lenses 1102H will provide for less light to be received in the hyperope pupil through the second add optical zone 1104H when focused at near distances.

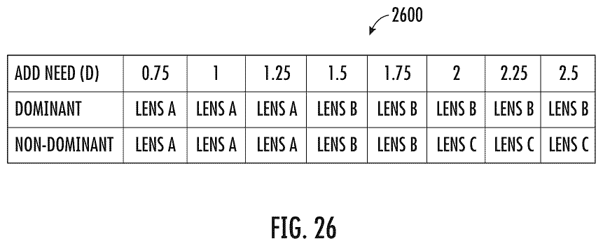

FIG. 26 is an exemplary lens fitting guide 2600 that can be used to fit a patient with myopic-correcting and/or hyperopic-correcting lenses 1102M, 1102H from the multifocal contact lenses system 1100 in FIG. 11, represented by the myopic and hyperopic power profiles 1302M-A, 1302M-B, 1302M-C, 1302H-D, 1302H-E, 1302H-F in FIGS. 13A-13F, based on the patient's refractive error correction prescription and add power need. “Lens A,” shown in the lens fitting guide 2600, designates a low-add contact lens, which are the low-add myopic-correcting and hyperopic-correcting lenses 1102M, 1102H represented by the respective low-add myopic and hyperopic power profiles 1302M-A, 1302H-D in FIGS. 13A and 13D. “Lens B,” shown in the lens fitting guide 2600, designates a mid-add contact lens, which are the mid-add myopic-correcting and hyperopic-correcting lenses 1102M, 1102H represented by the respective mid-add myopic and hyperopic power profiles 1302M-B, 1302H-E in FIGS. 13B and 13E. “Lens C,” shown in the lens fitting guide 2600, designates a high-add contact lens, which are the high-add myopic-correcting and hyperopic-correcting lenses 1102M, 1102H represented by the respective mid-add myopic and hyperopic power profiles 1302M-C, 1302H-F in FIGS. 13C and 13F.

It has been further discovered that not only do hyperopes generally have more positive ocular SPHA than myopes, as discussed previously above, but that ocular SPHA may further increase in hyperopes as a function of the increase in refractive error. Thus, in other exemplary aspects discussed below, the myopic and/or hyperopic power profiles of myopic-correcting and/or the hyperopic-correcting lenses 1102M, 1102H in the multifocal contact lens system 1100 in FIG. 11 can be further refined to be refractive error correction dependent (i.e., refractive error correction prescription or refractive error correction label power dependent) for even further optimization for enhanced far-distance vision. The SPHA of the myopic-correcting and/or the hyperopic-correcting lenses 1102M, 1102H being refractive error correction dependent means that the SPHA further varies between different respective myopic and/or hyperopic error corrections within the different respective myopic-correcting and/or the hyperopic-correcting lenses in a multifocal contact lens system. For example, the SPHA of a hyperopic-correcting lens in a multifocal contact lens system can be designed to add more negative SPHA to the hyperopic-correcting lenses as the hyperopic refractive error correction prescription of the hyperopic-correcting lenses increases in diopter. As another example, the SPHA of the myopic-correcting lenses in a multifocal contact lens system can also be made to be refractive error correction dependent to enhance far-distance vision. For example, the SPHA in the myopic-correcting lenses can be designed to add more negative SPHA to the myopic-correcting lenses as the myopic refractive error correction prescription of the myopia-correcting lenses increases in diopter (that is, as the refractive error correction prescription becomes increasingly negative).

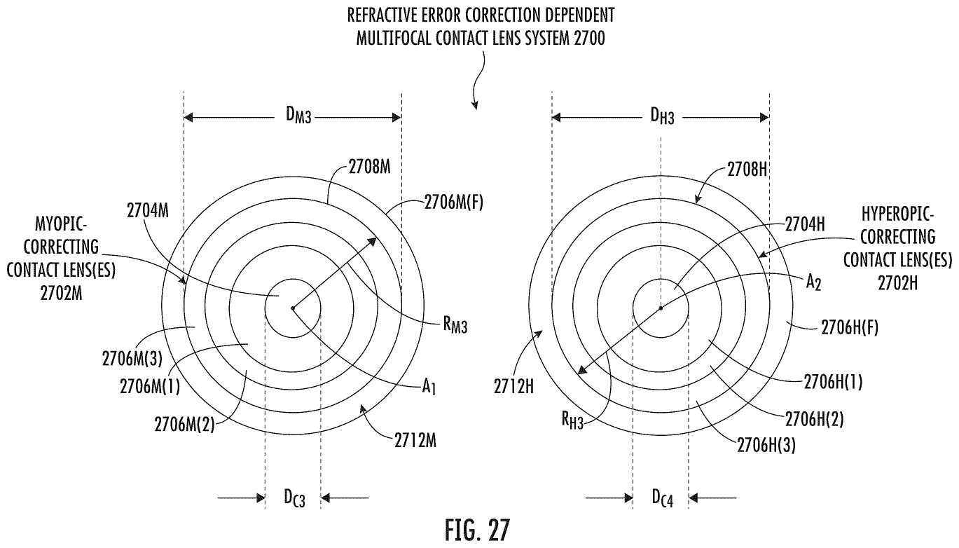

In this regard, FIG. 27 illustrates a multifocal contact lens system 2700 that includes myopic-correcting multifocal lenses 2702M (also referred to as “myopic-correcting lenses 2702M”) and hyperopic-correcting multifocal lenses 2702H (also referred to as “hyperopic-correcting lenses 2702H”). In this example, the myopic-correcting lenses 2702M and hyperopic-correcting lenses 2702H are multifocal contact lenses. Each of the myopic-correcting lenses 2702M and the hyperopic-correcting lenses 2702H have an effective add power designated with a given label add power for correction of presbyopia. Note that although only one (1) myopic-correcting lens 2702M and one (1) hyperopic-correcting lens 2702H are shown in FIG. 27, the multifocal contact lens system 2700 includes a plurality of the myopic-correcting lenses 2702M, each with a different myopic refractive error correction indicated by a different myopic refractive error correction prescription (e.g., −1 D, −2 D, −3 D . . . , −9 D) and for different label add powers, and a plurality of the hyperopic-correcting lenses 402H each with a different hyperopic refractive error correction prescription (e.g., +1 D, +2 D, +3 D . . . , +9 D) and for different label add powers. In this manner, one or more myopic-correcting lenses 2702M and/or one or more hyperopic-correcting lenses 2702H can be selected for a patient's OD and OS based on their refractive error in their eyes to provide refractive error correction for corrected vision with multifocality and presbyopia correction.

As discussed in more detail below, the myopic-correcting and/or hyperopic-correcting lenses 2702M, 2702H may further have an SPHA that is dependent on their specific refractive error correction prescription. The myopic-correcting and/or hyperopic-correcting lenses 2702M, 2702H can be designed similarly to the myopic-correcting and hyperopic-correcting lenses 1102M, 1102H in the multifocal contact lens system 1100 in FIG. 11. However, if the myopic-correcting lenses 2702M in the multifocal contact lens system 2700 have SPHAs that are further dependent on their specific myopic refractive error correction prescription, their myopic power profiles will differ from the myopic power profiles 1302M-A, 1302M-B, 1302M-C in FIGS. 13A-13C in this example. Likewise, if the hyperopic-correcting lenses 2702H in the multifocal contact lens system 2700 have an SPHA that is further dependent on their specific hyperopic refractive error correction prescription, their hyperopic power profiles will differ from the hyperopic power profiles 1302H-D, 1302H-E, 1302H-F in FIGS. 13D-13F in this example.

Also, it has been discovered that the pupil size in hyperopes gets smaller as hyperopic refractive error increases. Thus, as discussed in more detail below, as an example, a second add zone diameter D_{C4} of a second add optical zone 2704H of the hyperopic-correcting lenses 2702H can be designed such that the second add optical zone 2704H decreases in diameter D_{C4} as the hyperopic refractive error correction prescription of the hyperopic-correcting lenses 2702H increases in diopter. The first add zone diameter D_{C3} of a first add optical zone 2704M of the myopic-correcting lenses 2702M in the multifocal contact lens system 2700 can also be made to be refractive error correction dependent. For example, it has been discovered that the pupil size in myopes gets larger as myopic refractive error increases (that is, as refractive error correction becomes increasingly negative). Thus, as an example, the first add zone diameter D_{C3} of the first add optical zone 2704M of the myopic-correcting lenses 2702M can be designed such that the first add optical zone 2704M increases in diameter D_{C3} as the myopic refractive error correction prescription of the myopic-correcting lenses 2740M decreases in diopter.

In this manner, one or more myopic-correcting lenses 2702M and/or one or more hyperopic-correcting lenses 2702H can be selected from the multifocal contact lens system 2700 for a patient's OD and OS based on their refractive error in their eyes to provide further improved refractive error correction for corrected vision and improved longer-distance vision for hyperopes with multifocality and presbyopia correction.

With reference to FIG. 27, the myopic-correcting and hyperopic-correcting lenses 2702M, 2702H provide multifocality with corrected presbyopia for near-distances vision. The myopic-correcting lens 2702M has a myopic power profile that is provided by a first add optical zone 2704M and first transitional optical zones 2706M(1)-2706M(3) surrounding the first add optical zone 2704M. The myopic-correcting lens 2702M may also have a final distance optical zone 2706M(F) surrounding the first transitional optical zone 2706M(3), which has a refractive correction power for far-distance vision. The myopic-correcting lenses 2702M may have the same design as myopic-correcting lenses 1102M in FIG. 11 as a non-limiting example. The first add optical zone 2704M is disposed around the first optical axis A₁ and has a first add zone power profile as part of the myopic power profile of the myopic-correcting lens 2702M that has myopic paraxial power selected to substantially correct myopic refractive error for distance vision (e.g., at 0.25 D) for a wearer according to their refractive error correction prescription and a first add power to correct for presbyopia. The first add optical zone 2704M has the first add zone diameter D_{C3} that is sized based on the anticipated pupil constriction due to pupil miosis when a wearer is focused on a near-distance object (e.g., at 2.5 D) to enhance presbyopia correction. In this manner, more light passes into the wearer's pupil from the first add optical zone 2704M having the first add power when the wearer is focused on a near-distance object. The first add optical zone 2704M may be spherical or have some target spherical aberration that is dependent on the myopic paraxial power in the first add optical zone 2704M. In this example, there are three (3) first transitional optical zones 2706M(1)-2706M(3). The first transitional optical zones 2706M(1)-2706M(3) surround the first add optical zone 2704M about the first optical axis A₁, and each includes respective myopic progressive power profiles as part of the overall myopic power profile for the myopic-correcting lens 2702M. The myopic power profile is comprised of the first add zone power profile, and the myopic progressive power profile includes a first spherical aberration (SPHA) to provide correction of myopic refractive error correction.

The first transitional optical zones 2706M(1)-2706M(3) in the myopic-correcting lens 2702M provide refractive correction of light rays (“light”) passing through the myopic-correcting lens 2702M are different radiuses R_{M3} outside of the center-first add optical zone 2704M relative to the first optical axis A₁ of the myopic-correcting lens 2702M. For example, each first transitional optical zone 2706M(1)-2706M(3) may have a progressive power profile that provides an overall multifocality to the wearer as a function of the distance of a focused object. The transitions shown in FIG. 27 between adjacent first transitional optical zones 2706M(1)-2706M(3) are shown as distinct optical zones for illustrative purposes only, but in this example, the change in power at these respective transitions is continuous or substantially continuous. Thus, the myopic-correcting lens 2702M may have a single transitional optical zone that surrounds the first add optical zone 2704M and has a continuous aspheric power profile power. Note, however, that the transitions shown in FIG. 27 between any adjacent first transitional optical zones 2706M(1)-2706M(3) could also be non-continuous. Note, however, that the change in power at the transitions shown in FIG. 27 between any adjacent first transitional optical zones 2706M(1)-2706M(3) could also be non-continuous. The myopic-correcting lens 2702M has an overall diameter D_{M3}.

As also shown in FIG. 27, the hyperopic-correcting lens 2702H has a hyperopic power profile that is provided by a second add optical zone 2704H and second transitional optical zones 2706H(1)-2706H(3) surrounding the second add optical zone 2704H. The hyperopic-correcting lens 2702H may also have a final distance optical zone 2706H(F) surrounding the second transitional optical zone 2706H(3), which has a refractive correction power for far-distance vision. The second add optical zone 2704H is disposed around a second optical axis A₂ and has a second add zone power profile as part of the hyperopic power profile of the hyperopic-correcting lens 2702H that has hyperopic paraxial power selected to substantially correct hyperopic refractive error for distance vision (e.g., at 0.25 D) for a wearer according to their refractive error correction prescription and a second add power to correct for presbyopia. In this example, the second add optical zone 2704H has a second add zone diameter D_{C4} that is sized smaller than the first add zone diameter D_{C3} of the first add optical zone 2704M of the myopic-correcting lens 2702M. This is based on the anticipated reduced pupil size of a hyperope wearer when constricted to pupil miosis when a wearer is focused on a near-distance object (e.g., at 2.5 D) as opposed to a myope wearer of a myopic-correcting lens 2702M.

The second add optical zone 2704H may be spherical or have some target spherical aberration that is dependent on the hyperopic paraxial power in the second add optical zone 2704H. In this example, there are three (3) second transitional optical zones 2706H(1)-2706H(3). The second transitional optical zones 2706H(1)-2706H(3) surround the second add optical zone 2704H about the second optical axis A₂, and each includes a respective hyperopic progressive power profile as part of the overall hyperopic power profile for the hyperopic-correcting lens 2702H. The hyperopic power profile is comprised of the second add zone power profile, and the hyperopic progressive power profile includes a second SPHA to provide correction of hyperopic refractive error correction.

With continuing reference to FIG. 27, the second transitional optical zones 2706H(1)-2706H(3) in the hyperopic-correcting lens 2702H provide refractive correction of light rays (“light”) passing through the hyperopic-correcting lens 2702H are different radiuses R_{H3} outside of the second add optical zone 2704H relative to the second optical axis A₂ of the hyperopic-correcting lens 2702H. For example, each second transitional optical zone 2706H(1)-2706H(3) may have a progressive power profile that provides an overall multifocality to the wearer as a function of the distance of a focused object. The transitions shown in FIG. 27 between adjacent second transitional optical zones 2706H(1)-2706H(3) are shown as distinct optical zones for illustrative purposes only, but in this example, the change in power at these respective transitions is continuous or substantially continuous. Thus, the hyperopic-correcting lens 2702H may have a single transitional optical zone that surrounds the second add optical zone 2704M and has a continuous aspheric power profile power. Note, however, that the transitions shown in FIG. 27 between any adjacent second transitional optical zones 2706H(1)-2706H(3) could also be non-continuous. Note, however, that the change in power at the transitions shown in FIG. 27 between any adjacent second transitional optical zones 2706H(1)-2706H(3) could also be non-continuous. The hyperopic-correcting lens 2702H has an overall optical zone diameter D_{H3}.

Also, as illustrated in FIG. 27, as provided in the multifocal contact lens system 1100 in FIG. 11, the myopic power profile in each of the myopic-correcting lenses 2702M in the multifocal contact lens system 2700 each a first SPHA 2712M that is larger than a second SPHA 2712H in each of the hyperopic power profile of the hyperopic-correcting lenses 2702H in the multifocal contact lens system 2700. In other words, the second SPHAs 2712H in the hyperopic power profiles of the hyperopic-correcting lenses 2702H is smaller than the first SPHAs 2712M in the myopic power profiles of the myopic-correcting lenses 2702M. The first SPHAs 2712M in the myopic-correcting lenses 2702M is a spherical aberration in the myopic power profiles of the myopic-correcting lenses 2702M as a function of their radius R_{M3} relative to the first optical axis A₁. The second SPHAs 2712H in the hyperopic-correcting lenses 2702H is a spherical aberration in the hyperopic power profiles of the hyperopic-correcting lenses 2702H as a function of their radius R_{H3} relative to the second optical axis A₂. As discussed earlier, reducing the second SPHA 2712H in the hyperopic-correcting lenses 2702H in the multifocal contact lens system 2700 over the first SPHA 2712M in the myopic-correcting lenses 2702M in the multifocal contact lens system 2700 can further improve far-distance vision by hyperopes wearing hyperopic-correcting lenses 2702H in the multifocal contact lens system 2700.

Also, in the multifocal contact lens system 2700 in FIG. 27, the second SPHA 2712H for each of the plurality hyperopic-correcting lenses 2702H is dependent on its hyperopic refractive error correction label power. In other words, in addition to the second SPHAs 2712H in the hyperopic power profiles of the hyperopic-correcting lenses 2702H being less than the first SPHAs 2712M in the myopic power profiles of the myopic-correcting lenses 2702M, the second SPHAs 2712H in the hyperopic power profiles of the hyperopic-correcting lenses 2702H become more negative as the hyperopic refractive error correction prescription increases in diopter. For example, in this example, a hyperopic-correcting lens 2702H with a hyperopic refractive error correction prescription of +4 D will have a more negative second SPHA 2712H than the second SPHA 2712H of a hyperopic-correcting lens 2702H with a hyperopic refractive error correction prescription of +2 D. In this manner, the hyperopic power profiles of the hyperopic-correcting lenses 2702H in the multifocal contact lens system 2700 in FIG. 27 can be further optimized to be hyperopic refractive error correction dependent for even further optimization for more enhanced far-distance vision.

In an example, the second SPHAs 2712H of each of the plurality of hyperopic-correcting lenses 2702H can be targeted to an average second ocular SPHA of a population of hyperopes for their given hyperopic refractive error, such as shown in the graph 900B in FIG. 9B. As a further example, the second SPHAs 2712H of the hyperopic-correcting lenses 2702H may be at least ten percent (10%) smaller than the first SPHAs 2712M of the myopic-correcting lens 2702M. As a further example, the second SPHAs 2712H of the hyperopic-correcting lenses 2702H may be at least ten percent (10%) smaller than the first SPHAs 2712M of the myopic-correcting lens 2702M for a given corresponding refractive error correction prescription (e.g., +2 D hyperopic refractive error correction prescription vs. −2 D myopic refractive error correction prescription). As another example, the second SPHAs 2712H of the hyperopic-correcting lenses 2702H in the multifocal contact lens system 2700 may be between ten percent (10%) and twenty percent (20%) smaller than the first SPHAs 2712M in the myopic-correcting lenses 2702M in the multifocal contact lens system 2700. As another example, the second SPHAs 2712H of each of the plurality of hyperopic-correcting lenses 2702H can be between −0.053 D/mm² and −0.146 D/mm², and the first SPHAs 2712M of each of the plurality of myopic-correcting lenses 2702M can be between 0.053 D/mm² and −0.146 D/mm².

In another example, the second SPHAs 2712H for the plurality of hyperopic-correcting lenses 2702H becomes more negative monotonically (i.e., in the same increments between adjacent hyperopic refractive error correction prescriptions) as the hyperopic refractive error correction prescription of the plurality of hyperopic-correcting lenses 2702H increases in diopter. The second SPHAs 2712H for the plurality of hyperopic-correcting lenses 2702H may become more negative linearly as the hyperopic refractive error correction prescription of the plurality of hyperopic-correcting lenses 2702H increases in diopter.

Also, in the multifocal contact lens system 2700 in FIG. 27, the first SPHA 2712M for each of the plurality myopic-correcting lenses 2702M can also be dependent on its myopic refractive error correction label power. In other words, in addition to the first SPHAs 2712M in the myopic power profiles of the myopic-correcting lenses 2702M being greater than the second SPHAs 2712H in the hyperopic power profiles of the hyperopic-correcting lenses 2702H, the first SPHAs 2712HM in the myopic power profiles of the myopic-correcting lenses 2702M become more negative as the myopic refractive error correction prescription increases in diopter. For example, in this example, a myopic-correcting lens 2702M with a myopic refractive error correction prescription of −4 D will have a more negative first SPHA 2712M than the first SPHA 2712M of a myopic-correcting lens 2702M with a myopic refractive error correction prescription of −2 D. In this manner, the myopic power profiles of the myopic-correcting lenses 2702M in the multifocal contact lens system 2700 in FIG. 27 can be further optimized to be myopic refractive error correction dependent for even further optimization for more enhanced far-distance vision.

In another example, the first SPHAs 2712M of each of the plurality of myopic-correcting lenses 2702M can be targeted to an average first ocular SPHA of a population of myopes for their given myopic refractive error, such as shown in the graph 900A in FIG. 9A. As a further example, the second SPHAs 2712H of the hyperopic-correcting lenses 2702H may be at least five percent (5%) less than the first SPHAs 2712M of the myopic-correcting lens 2702M. As a further example, the second SPHAs 2712H of the hyperopic-correcting lenses 2702H may be at least five percent (5%) less than the first SPHAs 2712M of the myopic-correcting lens 2702M for a given corresponding refractive error correction prescription (e.g., −2 D myopic refractive error correction prescription vs. +2 D hyperopic refractive error correction prescription). As another example, the second SPHAs 2712H of the hyperopic-correcting lenses 2702H may be between three percent (3%) and fifty percent (50%) less than the first SPHAs 2712M of the myopic-correcting lens 2702M. In another example, only the first SPHAs 2712M for the plurality of myopic-correcting lenses 2702M that have a myopic refractive error correction prescription of −2.5 D or greater becomes more negative as the myopic refractive error correction prescription of such myopic-correcting lenses 2702M increases in diopter tp mitigate or offset ocular SPHA to further improve longer-distance vision. As an example, the first SPHAs 2712M of each of the plurality of myopic-correcting lenses 2702M can be between −0.053 D/mm² and −0.146 D/mm², and the first SPHAs 2712M of each of the plurality of myopic-correcting lenses 2702M can be between −0.064 D/mm² and −0.096 D/mm².

In another example, the first SPHAs 2712M for the plurality of myopic-correcting lenses 2702M becomes more negative monotonically (i.e., in the same increments between adjacent myopic refractive error correction prescriptions) as the myopic refractive error correction prescription of the plurality of myopic-correcting lenses 2702M increases in diopter. The first SPHAs 2712M for the plurality of myopic-correcting lenses 2702M may become more negative linearly as the hyperopic refractive error correction prescription of the plurality of hyperopic-correcting lenses 2702H increases in diopter.

As discussed above, the second add optical zone 2704H of the hyperopic-correcting lens 2702H also has a second add zone diameter D_{C4} that is sized smaller than the first add zone diameter D_{C3} of the first add optical zone 2704M of the myopic-correcting lens 2702M. This is based on the anticipated reduced pupil size of a hyperope wearer when constricted to pupil miosis when a wearer is focused on a near-distance object (e.g., at 2.5 D). In this manner, a greater percentage of light passes into a hyperope wearer's pupil from the second transitional optical zones 2706H(1)-2706H(3) of the hyperopic-correcting lenses 2702H when the hyperope wearer is focused on a far-distance object to provide for improved longer-distance vision. As an example, the second add zone diameter D_{C4} of the second add optical zone 2704H of the hyperopic-correcting lenses 2702H can be at least two percent (2%) less than the first add zone diameter D_{C3} of the myopic-correcting lenses 2702M.

Also, as discussed above, it has been discovered that the pupil size in hyperopes gets smaller as hyperopic refractive error increases. This is shown in the plot 1000B in FIG. 10B previously described above for the example of a mean hyperopic subject with a refractive error correction prescription (Rx) of +2.0 D and add power need of +2.25 D with a luminance of 120 cd/m² and vergence of 2 D. For example, the second add zone diameter D_{C4} of a second add optical zone 2704H of a hyperopic-correcting lens 2702H may be between 0 mm and 0.73 mm based on the average pupil diameters observed in hyperopes. Thus, in this example of the multifocal contact lens system 2700 in FIG. 27, the second add zone diameter D_{C4} of the second add optical zone 2704H of the hyperopic-correcting lenses 2702H in the multifocal contact lens system 2700 can also be made to be hyperopic refractive error correction dependent to further increased performance of far-distance vision. For example, the second add zone diameter D_{C4} of the second add optical zone 2704H of the hyperopic-correcting lenses 2702H can be designed such that the second add optical zone 2704H decreases in diameter D_{C4} as the hyperopic refractive error correction prescription of the hyperopic-correcting lenses 2702H increase in diopter. For example, the second add zone diameter D_{C4} of the second add optical zones 2704H of the plurality of hyperopic-correcting lenses 2702H can be designed to continue to decrease in size as the hyperopic refractive error correction prescription of the plurality of hyperopic-correcting lenses 2702H increases in diopter. For example, the second add zone diameter D_{C4} of a second add optical zone 2704H of a hyperopic-correcting lens 2702H with a +2 D hyperopic refractive error correction prescription will have a larger diameter than the second add zone diameter D_{C4} of a second add optical zone 2704H of a hyperopic-correcting lens 2702H with a +4 D hyperopic refractive error correction prescription.

As another example, the second add zone diameter D_{C4} for the plurality of hyperopic-correcting lenses 2702H can continue to decrease monotonically (i.e., in the same distance decrease increments between adjacent hyperopic refractive error correction prescriptions) as the hyperopic refractive error correction prescription of the plurality of hyperopic-correcting lenses 2702H increases in diopter. For example, in another example, second add zone diameter D_{C4} for the plurality of hyperopic-correcting lenses 2702H can continue to decrease linearly as the hyperopic refractive error correction prescription of the plurality of hyperopic-correcting lenses 2702H increases in diopter.

In another example, the first add optical zone 2704M of the myopic-correcting lens 2702M also has the first add zone diameter D_{C3} that is sized larger than the second add zone diameter D_{C4} of the second add optical zone 2704H of the hyperopic-correcting lens 2702H. Thus, in this example of the multifocal contact lens system 2700 in FIG. 27, the first add zone diameter D_{C3} of the first add optical zone 2704M of the myopic-correcting lenses 2702M in the multifocal contact lens system 2700 can also be made to be myopic refractive error correction dependent to further increased performance of far-distance vision. For example, the first add zone diameter D_{C3} of the first add optical zone 2704M of the myopic-correcting lenses 2702M can be designed such that the first add optical zone 2704M increases in diameter D_{C3} as the myopic refractive error correction prescription of the myopic-correcting lenses 2702M increases in diopter. For example, the first add zone diameter D_{C3} of the first add optical zones 2704M of the plurality of myopic-correcting lenses 2702M can be designed to continue to increase in size as the myopic refractive error correction prescription of the plurality of myopic-correcting lenses 2702M increases in diopter. For example, the first add zone diameter D_{C3} of the first add optical zone 2704M of a myopic-correcting lens 2702M with a −4 D hyperopic refractive error correction prescription will have a larger diameter than the first add zone diameter D_{C3} of a first add optical zone 2704M of a myopic-correcting lens 2702M with a −2 D myopic refractive error correction prescription.

As another example, the second add zone diameter D_{C4} for the plurality of hyperopic-correcting lenses 2702H can continue to decrease monotonically (i.e., in the same distance decrease increments between adjacent hyperopic refractive error correction prescriptions) as the hyperopic refractive error correction prescription of the plurality of hyperopic-correcting lenses 2702H increases in diopter. For example, In another example, second add zone diameter D_{C4} for the plurality of hyperopic-correcting lenses 2702H can continue to decrease linearly as the hyperopic refractive error correction prescription of the plurality of hyperopic-correcting lenses 2702H increases in diopter.

Furthermore, as discussed above, it has been discovered that, in general, myopes and hyperopes have differences in the distribution of add power needs. A higher proportion of hyperopes are fitted with high-add power lenses as compared to myopes of the same or similar age. Thus, a hyperope with a higher add power may experience more compromised far-distance vision as compared to a myope. Also, as discussed above, a hyperope may already have a natural disposition of feeling that their far-distance vision has been compromised when fitted with presbyopia-correcting lenses due to a greater expectation of superior far-distance vision than myopes. Thus, in another example, to improve the far-distance vision of the hyperope, the effective add power in the hyperopic-correcting lenses 2702H in the multifocal contact lens system 2700 can also be reduced as compared to the effective add power in the myopic-correcting lenses 2702M in the same in the multifocal contact lens system 2700 for a given label add power. Also, it may be desired to only reduce the effective add power in certain effective label add power ranges of the hyperopic-correcting multifocal lenses 2702H to improve far-distance vision, taking advantage of binocular disparity between a patient's dominant and non-dominant eye. For example, the effective add power may be reduced in some or all of the hyperopic-correcting lenses 2702H for a given label add power by +0.0 D to +0.65 D as compared to the label add power of the myopic-correcting lenses 2702M. The effective add power in the hyperopic-correcting lenses 2702H in the multifocal contact lens system 2700 can be provided by adjusting its paraxial power and aspheric constants in its respective hyperopic power profiles.

Also, the DOF of one or more of the hyperopic-correcting lenses 2702H for a given label add power can be changed with respect to a DOF of one or more of myopic-correcting lenses 2702M for the same given label add power.

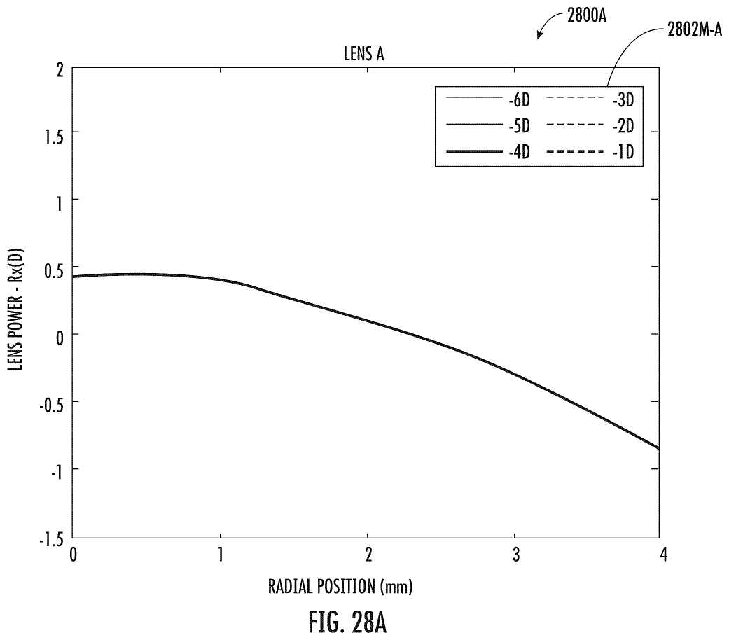

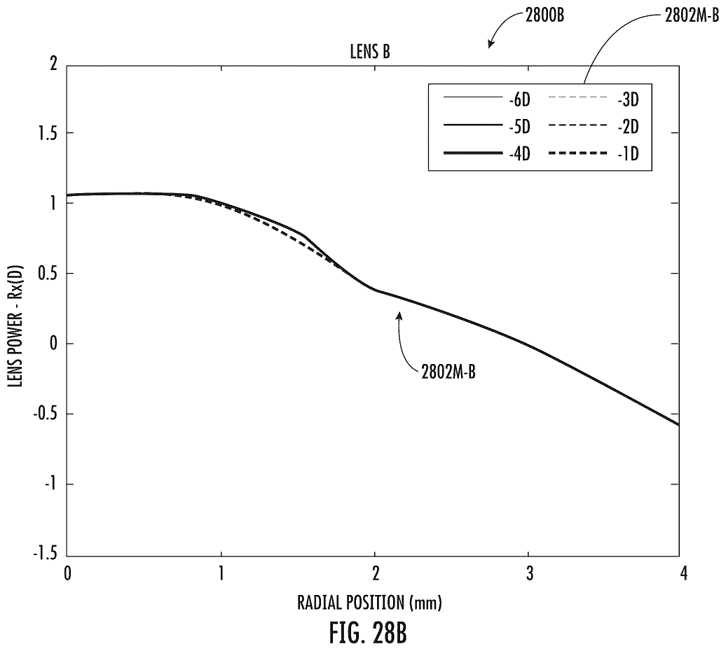

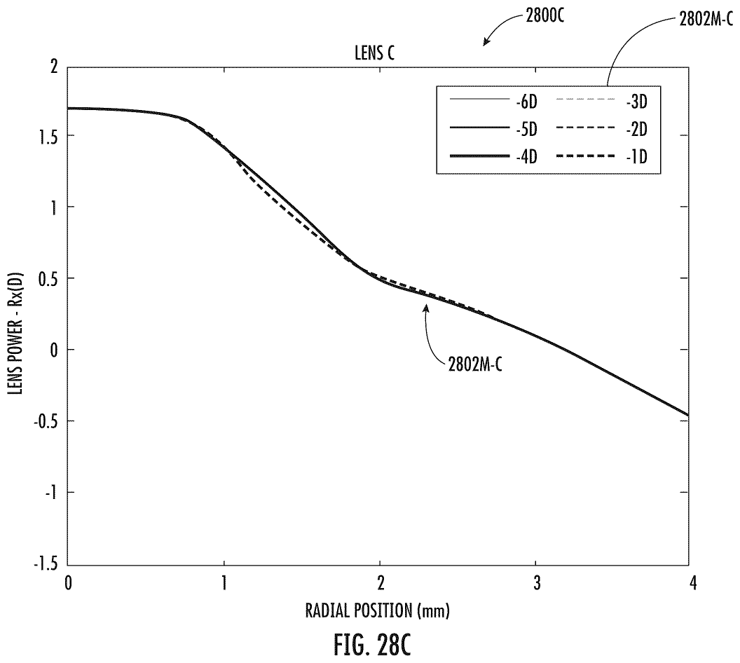

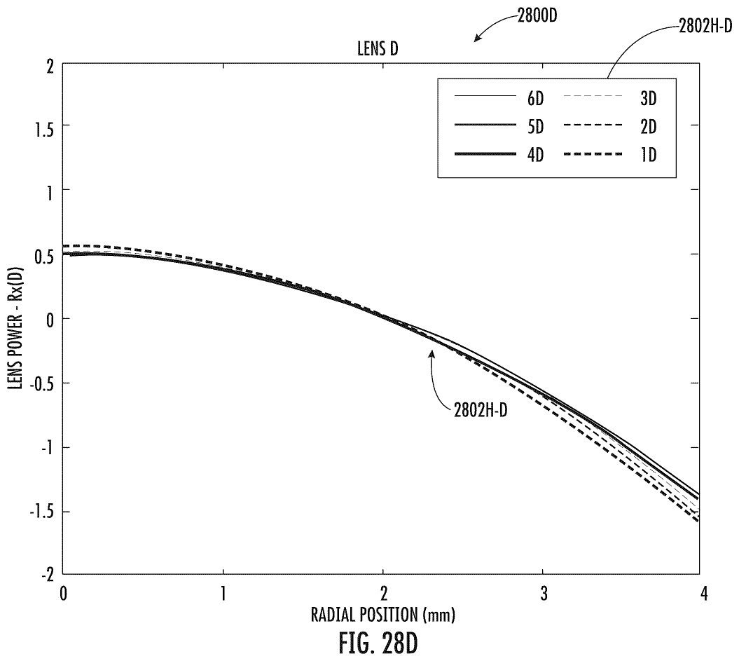

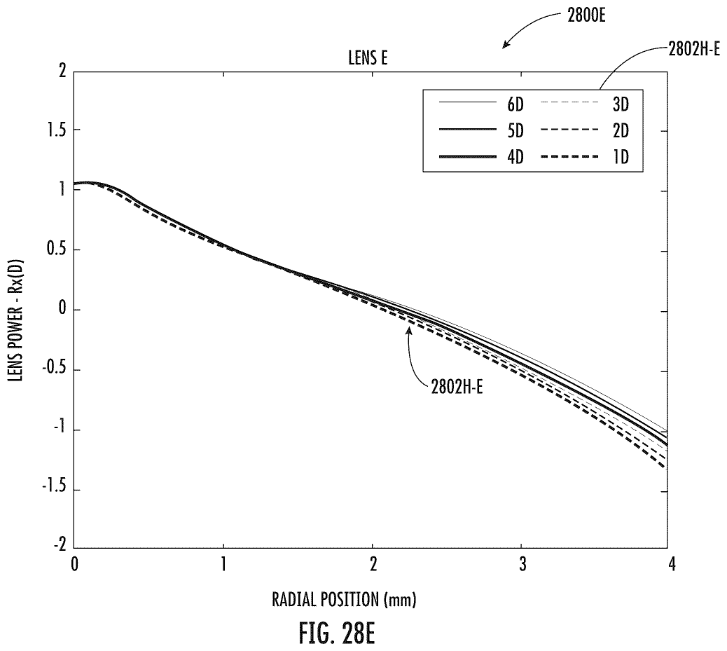

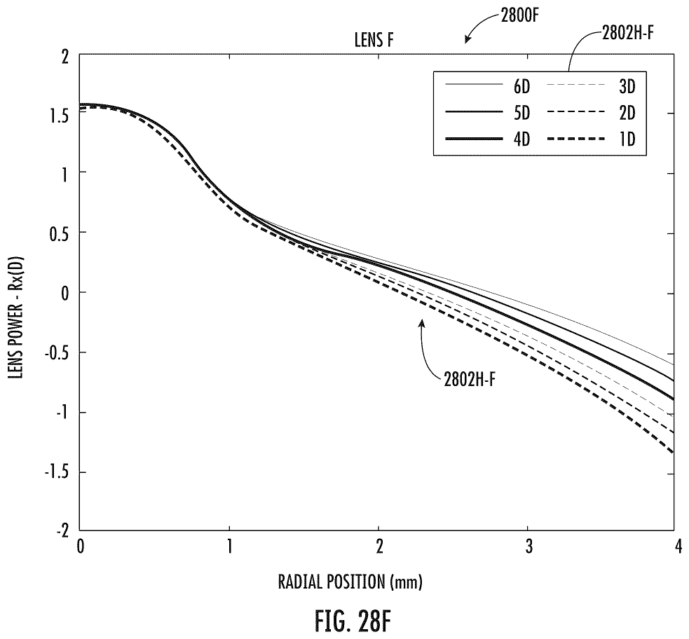

FIGS. 28A-28C are exemplary graphs 2800A, 2800B, 2800C that each include a respective low-add, mid-add, and high-add myopic power profiles 2802M-A, 2802M-B, 2802M-C for myopic-correcting lenses 2702M (for refractive error correction prescriptions −6 D, −5 D, −4 D, −3 D, −2 D, −1 D) in FIG. 27. The graphs 2800A, 2800B, 2800C plot lens power minus prescription Rx in diopers (D) as a function of radial position from the respective first optical axis A₁ of the myopic-correcting lenses 2702M in FIG. 27. The graph 2800A in FIG. 28A illustrates low-add myopic power profiles 2802M-A for the different refractive error correction prescriptions of low-add myopic-correcting lenses 2702M for a low-add label add power of +0.75 D, which can be thought of as a low-add power for patients having a lower or initial loss of accommodation. However, note that the low-add label add power could be between +0.5 D and +1.49 D. The graph 2800B in FIG. 28B illustrates mid-add myopic power profiles 2802M-B for the different refractive error correction prescriptions of mid-add myopic-correcting lenses 2702M for a mid-add label add power of +1.75 D, which can be thought of as a medium or mid-add power for patients having a higher loss of accommodation. However, note that the mid-add label power could be between +1.5 D and +1.99 D. The graph 2800C in FIG. 28C illustrates high-add myopic power profiles 2802M-C for the different refractive error correction prescriptions of high-add myopic-correcting lenses 2702M for a high-add label add power of +2.5 D, which can be thought of as a high-add power for patients having the highest loss of accommodation. However, note that the high-add label add power could be between +2.0 D and +2.5 D.

The low-add, mid-add, and high-add myopic power profiles 2802M-A, 2802M-B, 2802M-C for the myopic-correcting lenses 2702M in FIGS. 28A-28C vary with respect to paraxial power, the radius R_{M3} of the first add optical zone 2704M, the effective add power (i.e., magnitude of the first add power) provided by the first add optical zone 2704M and the radius R_{M3} of the first add optical zone 2704M. However, with each low-add, mid-add, and high-add label add power group shown in the low-add, mid-add, and high-add myopic power profiles 2802M-A, 2802M-B, 2802M-C in FIGS. 28A-28C, the paraxial power, effective add power (i.e., magnitude of the first and second add powers) provided by the first add optical zone 2704M, and the radius R_{M3} of the first add optical zones 2704M is relatively constant across the myopic refractive error correction prescriptions. In other words, for a given effective add power shown in the different label add power groups for the respective low-add, mid-add, and high-add myopic power profiles 2802M-A, 2802M-B, 2802M-C in FIGS. 28A-28C, the paraxial power, the effective add power and the radius R_{M3} of the first add optical zone 2704M are almost the same for each of the myopic refractive error correction prescriptions. This is because in this example, the low-add, mid-add, and high-add myopic power profiles 2802M-A, 2802M-B, 2802M-C of the respective low-add, mid-add, and high-add myopic-correcting lenses 2702M do not have a first SPHA 2712M or first add zone diameter R_{C3} depending on their myopic refractive error correction prescription, but such is not limiting.

FIGS. 28D-28F are exemplary graphs 2800D, 2800E, 2800F that each includes a respective low-add, mid-add, and high-add hyperopic power profiles 2802H-D, 2802H-E, 2802H-F for a plurality of the hyperopic-correcting lenses 2702H (for refractive error correction prescriptions +1 D, +2 D, +3 D, +4 D, +5 D, +6 D) in FIG. 27. The graphs 2800D, 2800E, 2800F plot lens power minus prescription Rx in diopers (D) as a function of radial position from the respective second optical axis A₂ of the hyperopic-correcting lenses 2702H in FIG. 27. The graph 2800D in FIG. 28D illustrates low-add hyperopic power profiles 2802H-D for the different refractive error correction prescriptions of low-add hyperopic-correcting lenses 2702H for a low-add label add power of +0.75 D, which can be thought of as a low-add power for patients having a lower or initial loss of accommodation. However, note that the low-add label add power could be between +0.5 D and +1.49 D. The graph 2800E in FIG. 28E illustrates mid-add hyperopic power profiles 2802H-E for the different refractive error correction prescriptions of mid-add hyperopic-correcting lenses 2702H for a mid-add label add power of +1.75 D, which can be thought of as a medium or mid-add power for patients having a higher loss of accommodation. However, note that the mid-add label power could be between +1.5 D and +1.99 D. The graph 2800F in FIG. 28F illustrates high-add hyperopic power profiles 2802H-F for the different refractive error correction prescriptions of high-add hyperopic-correcting lenses 2702H for a high-add label add power of +2.5 D, which can be thought of as a high-add power for patients having the highest loss of accommodation. However, note that the high-add label add power could be between +2.0 D and +2.5 D.

In this example, the second SPHAs 2712H of the hyperopic power profiles 2802H-D, 2802H-E, 2802H-F in FIGS. 28D-28F for the hyperopic-correcting lenses 2702H is dependent on its refractive error correction prescription. For example, as shown in the low-add hyperopic power profile 2802H-D in FIG. 28D, the low-add hyperopic-correcting lenses 2702H represented therein may have a second SPHA 2712H that varies as a function of radius R_{H3} in D/mm² as equal to −0.003972*Rx−0.1118, where Rx is in diopters. As another example, as shown in the mid-add hyperopic power profile 2802H-E in FIG. 28E, the mid-add hyperopic-correcting lenses 2702H represented therein may have a second SPHA 2712H that varies as a function of radius R_{H3} in D/mm² as equal to −0.003884*Rx−0.0902, where Rx is in diopters. As another example, as shown in the high-add hyperopic power profile 2802H-F in FIG. 28F, the mid-add hyperopic-correcting lenses 2702H represented therein may have a second SPHA 2712H that varies as a function of radius R_{H3} in D/mm² as equal to −0.009384*Rx−0.0638, where Rx is in diopters.

The low-add, mid-add, and high-add hyperopic power profiles 2802H-D, 2802H-E, 2802H-F for the hyperopic-correcting lenses 2702H in FIGS. 28D-28F vary with respect to paraxial power, the radius R_{H3} of the second add optical zone 2704H, the effective add power (i.e., magnitude of the second add power) provided by the second add optical zone 2704H and the radius R_{H3} of the second add optical zone 2704H. With each low-add, mid-add, and high-add label add power group shown in the low-add, mid-add, and high-add hyperopic power profiles 2802H-D, 2802H-E, 2802H-F in FIGS. 28D-28F, the paraxial power, the effective add power (i.e., magnitude of the second add power) provided by the second add optical zone 2704H, and the radius R_{H3} of the second add optical zone 2704H varies as a function of the hyperopic refractive error correction prescription to further improve far-distance vision for hyperopes wearing the hyperopic-correcting lenses 2702H.

As discussed above, the effective add power (e.g., paraxial power) of the hyperopic-correcting lenses 2702H may be reduced over the effective add power (e.g., paraxial power) of the myopic-correcting lenses 2702M to further improve far-distance vision for hyperopes wearing the hyperopic-correcting lenses 2702H. This is shown, for example, by comparing the low-add myopic power profiles 2802M-A and the low-add hyperopic power profiles 2802H-D in FIGS. 28A and 28D for respective low-add label add power myopic-correcting and hyperopic-correcting lenses 2702M, 2702H. For example, the low-add label add power of one or more low-add hyperopic-correcting lenses 2702H, shown by their low-add hyperopic power profiles 2802H-D in FIG. 28D, may be reduced between +0.0 D and +0.15 D with respect to the low-add label add power of one or more low-add myopic-correcting lenses 2702M, shown by their low-add myopic power profiles 2802M-A in FIG. 28A. This is also shown, for example, by comparing the mid-add myopic power profiles 2802M-B and the mid-add hyperopic power profiles 2802H-E in FIGS. 28B and 28E for respective mid-add label add power myopic-correcting and hyperopic-correcting lenses 2702M, 2702H. For example, the mid-add label add power of one or more mid-add hyperopic-correcting lenses 2702H, shown by their mid-add hyperopic power profiles 2802H-E in FIG. 28E, may be reduced between +0.20 D and +0.50 D with respect to the mid-add label add power of one or more mid-add myopic-correcting lenses 2702M shown by their mid-add myopic power profiles 2802M-B in FIG. 28B. This is also shown, for example, by comparing the high-add myopic power profiles 2802M-C and the high-add hyperopic power profiles 2802H-F in FIGS. 28C and 28F for respective high-add label add power myopic-correcting and hyperopic-correcting lenses 2702M, 2702H. For example, the high-add label add power of one or more high-add hyperopic-correcting lenses 2702H, shown by their high-add hyperopic power profiles 2802H-F in FIG. 28F, may be reduced between +0.40 D and −0.65 D with respect to the high-add label add power of one or more high-add myopic-correcting lenses 2702M shown by their high-add myopic power profiles 2802M-C in FIG. 28C.

For example, the effective low-add power (e.g., below +1.5 D) in the low-add hyperopic power profiles 2802H-D of the low-add hyperopic-correcting lenses 2702H shown in FIG. 28D may be reduced by between +0.0 D and +0.15 D as compared to their counterpart low-add myopic-correcting lenses 2702M represented by the low-add myopic power profiles 2802M-A in FIG. 28A. Also, in the multifocal contact lens system 2700 in FIG. 27, the effective mid-add power (e.g., at least +1.5 D (e.g., add need of +1.5 D to +1.75 D)) in the mid-add hyperopic power profiles 2802H-E of the mid-add hyperopic-correcting lenses 2702H shown in FIG. 28E may be reduced by between +0.20 D and +0.50 D as compared to their counterpart mid-add myopic-correcting lenses 2702M represented by the mid-add myopic power profiles 2802M-B in FIG. 28B. Also, in the multifocal contact lens system 2700 in FIG. 27, the effective high-add power (e.g., add need of +2.0 D to +2.5 D) in the mid-add hyperopic power profiles 2802H-E in the hyperopic-correcting lenses 2702H shown in FIG. 27F may be reduced by between +0.40 D and +0.65 D as compared to their counterpart high-add myopic-correcting lenses 2702M represented by the high-add myopic power profiles 2802M-C in FIG. 28C.

Further, in the multifocal contact lens system 2700 in FIG. 27, the low-add DOF of one or more low-add hyperopic-correcting lenses 2702H, shown by their low-add hyperopic power profiles 2802H-D in FIG. 28D, may be changed by between +0.15 D and −0.10 D with respect to one or more low-add myopic-correcting lenses 2702M shown by their low-add myopic power profiles 2802M-A in FIG. 28A. In another example, the mid-add DOF of one or more mid-add hyperopic-correcting lenses 2702H, shown by their mid-add hyperopic power profiles 2802H-E in FIG. 28E, may be changed by between +0.05 D and −0.20 D with respect to one or more mid-add myopic-correcting lenses 2702M shown by their mid-add myopic power profiles 2802M-B in FIG. 28B. In another example, the high-add DOF of one or more high-add hyperopic-correcting lenses 2702H, shown by their high-add hyperopic power profiles 2802H-F in FIG. 28F, may be changed by between +0.30 D and −0.20 D with respect to one or more high-add myopic-correcting lenses 2702M shown by their high-add myopic power profiles 2802M-C in FIG. 28C.

As another example, as shown in the low-add myopic power profiles 2802M-A in FIG. 28A, the first add optical zone 2704M of the low-add myopic-correcting lenses 2702M may have an add optical zone radius (one half of diameter D_{C3}) between 0 mm and 0.23 mm. The first transitional optical zone 2706M(1) of the low-add myopic-correcting lenses 2702M may have a radius relative to the first optical axis A₁ between 0.23 mm and 0.43 mm, with the first add power of the first add optical zone 2704M being between +0.002 D and +0.003 D. The first transitional optical zone 2706M(2) of the low-add myopic-correcting lenses 2702M may have a radius relative to the first optical axis A₁ between 0.44 mm and 0.67 mm, with the first add power of the first add optical zone 2704M being between +0.002 D and +0.003 D. The first transitional optical zone 2706M(2) of the low-add myopic-correcting lenses 2702M may have a radius relative to the first optical axis A₁ between 0.67 mm and 2.0 mm, with the first add power of the first add optical zone 2704M being between +0.0005 D and +0.001 D. The low-add myopic-correcting lenses 2702M may have a final distance optical zone extrapolated paraxial power of between +0.336 D and +0.537 D relative to the paraxial power of the refractive need.

As another example, as shown in the mid-add myopic power profiles 2802M-B in FIG. 28B, the first add optical zone 2704M of the mid-add myopic-correcting lenses 2702M may have an add optical zone radius (one half of diameter D_{C3}) between 0 mm and 0.78 mm. The first transitional optical zone 2706M(1) of the mid-add myopic-correcting lenses 2702M may have a radius relative to the first optical axis A₁ between 0.78 mm and 1.06 mm, with the first add power of the first add optical zone 2704M being between +0.343 D and +0.425 D. The first transitional optical zone 2706M(2) of the mid-add myopic-correcting lenses 2702M may have a radius relative to the first optical axis A₁ between 1.06 mm and 1.49 mm, with the first add power of the first add optical zone 2704M being between +0.262 D and +0.344 D. The first transitional optical zone 2706M(2) of the mid-add myopic-correcting lenses 2702M may have a radius relative to the first optical axis A₁ between 1.49 mm and 2.0 mm, with the first add power of the first add optical zone 2704M being between +0.060 D and +0.142 D. The mid-add myopic-correcting lenses 2702M may have a final distance optical zone extrapolated paraxial power of between +0.559 D and +0.760 D relative to the paraxial power of the refractive need.

As another example, as shown in the high-add myopic power profiles 2802M-C in FIG. 28C, the first add optical zone 2704M of the high-add myopic-correcting lenses 2702M may have an add optical zone radius (one half of diameter D_{C3}) between 0 mm and 0.64 mm. The first transitional optical zone 2706M(1) of the high-add myopic-correcting lenses 2702M may have a radius relative to the first optical axis A₁ between 0.64 mm and 0.94 mm, with the first add power of the first add optical zone 2704M being between +0.845 D and +1.045 D. The first transitional optical zone 2706M(2) of the high-add myopic-correcting lenses 2702M may have a radius relative to the first optical axis A₁ between 0.94 mm and 1.43 mm, with the first add power of the first add optical zone 2704M being between +0.646 D and +0.846 D. The first transitional optical zone 2706M(2) of the high-add myopic-correcting lenses 2702M may have a radius relative to the first optical axis A₁ between 1.43 mm and 2.0 mm, with the first add power of the first add optical zone 2704M being between +0.149 D and +0.349 D. The high-add myopic-correcting lenses 2702M may have a final distance optical zone extrapolated paraxial power of between +0.628 D and +0.828 D relative to the paraxial power of the refractive need.

As another example, as shown in the low-add hyperopic power profiles 2802H-D in FIG. 28D, the second add optical zone 2704H of the low-add hyperopic-correcting lenses 2702H may have an add optical zone radius (one half of diameter D_{C4}) between 0 mm and 0.23 mm. The second transitional optical zone 2706H(1) of the low-add hyperopic-correcting lenses 2702H may have a radius relative to the second optical axis A₂ between 0.23 mm and 0.43 mm, with the second add power of the second add optical zone 2704H being between +0.002 D and +0.003 D. The second transitional optical zone 2706H(2) of the low-add hyperopic-correcting lenses 2702H may have a radius relative to the second optical axis A₂ between 0.44 mm and 0.67 mm, with the first add power of the first add optical zone 2704M being between +0.0005 D and +0.001 D. The second transitional optical zone 2706H(2) of the low-add hyperopic-correcting lenses 2702H may have a radius relative to the second optical axis A₂ between 0.67 mm and 2.0 mm, with the second add power of the second add optical zone 2704H being between +0.0005 D and +0.001 D. The low-add hyperopic-correcting lenses 2702H may have a final distance optical zone extrapolated paraxial power of between +0.336 D and +0.537 D relative to the paraxial power of the refractive need.

As another example, as shown in the mid-add hyperopic power profiles 2802H-E in FIG. 28E, the second add optical zone 2704H of the mid-add hyperopic-correcting lenses 2702H may have an add optical zone radius (one half of diameter D_{C4}) between 0 mm and 0.73 mm. The second transitional optical zone 2706H(1) of the mid-add hyperopic-correcting lenses 2702H may have a radius relative to the second optical axis A₂ between 0.73 mm and 0.98 mm, with the second add power of the second add optical zone 2704H being between +0.343 D and +0.425 D. The second transitional optical zone 2706H(2) of the mid-add hyperopic-correcting lenses 2702H may have a radius relative to the second optical axis A₂ between 0.98 mm and 1.38 mm, with the first add power of the first add optical zone 2704M being between +0.262 D and +0.344 D. The second transitional optical zone 2706H(2) of the mid-add hyperopic-correcting lenses 2702H may have a radius relative to the second optical axis A₂ between 1.38 mm and 2.0 mm, with the second add power of the second add optical zone 2704H being between +0.060 D and +0.142 D. The mid-add hyperopic-correcting lenses 2702H may have a final distance optical zone extrapolated paraxial power of between +0.259 D and +0142 D relative to the paraxial power of the refractive need.

As another example, as shown in the high-add hyperopic power profiles 2802H-F in FIG. 28F, the second add optical zone 2704H of the high-add hyperopic-correcting lenses 2702H may have an add optical zone radius (one half of diameter D_{C4}) between 0 mm and 0.59 mm. The first transitional optical zone 2706M(1) of the high-add hyperopic-correcting lenses 2702H may have a radius relative to the second optical axis A₂ between 0.59 mm and 0.87 mm, with the second add power of the second add optical zone 2704H being between +0.845 D and 1.045 D. The second transitional optical zone 2706H(2) of the high-add hyperopic-correcting lenses 2702H may have a radius relative to the second optical axis A₂ between 0.87 mm and 1.33 mm, with the first add power of the first add optical zone 2704M being between +0.646 D and +0.846 D. The second transitional optical zone 2706H(2) of the high-add hyperopic-correcting lenses 2702H may have a radius relative to the second optical axis A₂ between 1.33 mm and 2.0 mm, with the second add power of the second add optical zone 2704H being between+0.149 D and +0.349 D. The high-add hyperopic-correcting lenses 2702H may have a final distance optical zone extrapolated paraxial power of between +0.428 D and +0.629 D relative to the paraxial power of the refractive need.

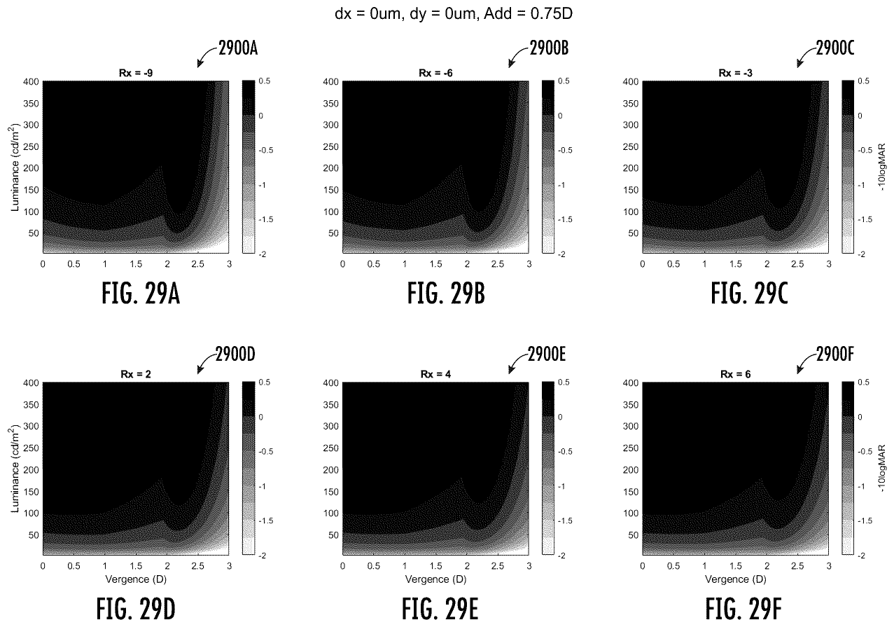

FIGS. 29A-36F illustrate exemplary cyclopean visual performance shown as luminance (in cd/m²) and MAR (as −10 log MAR) plotted as a function of vergence (in diopters) of different myopic and hyperopic refractive error correction prescriptions (Rx) of the myopic-correcting and hyperopic-correcting lenses 2702M, 2702H in FIG. 27. In this example, these myopic-correcting and hyperopic-correcting lenses 2702M, 2702H are represented by the respective myopic power profiles 2802M-A, 2802M-B, 2802M-C and hyperopic power profiles 2802H-D, 2802H-E, 2802H-F in respective FIGS. 28A-28F previously discussed. Plotting the cyclopean visual performance of the myopic-correcting and hyperopic-correcting lenses 2702M, 2702H in FIGS. 29A-36F enables the ability to study the total multifocal contact lens system 2700. As shown in FIGS. 29A-36F, the cyclopean visual performance of the hyperopic-correcting lenses 2702H in the multifocal contact lens system 2700, having their second SPHAs 2712H become more negative and/or the second add zone diameter D_{C4} of their second add optical zones 2704H decrease, as their hyperopic refractive error correction prescription increases in diopter, exhibits a further significant improvement in distance vision when comparing cyclopean visual performance shown in FIGS. 29D-29F, 30D-30F, 31D-31F, 32D-32F, 33D-33F, 34D-34F, 35D-35F, 36D-36F for various label add powers for hyperopes wearing the hyperopic-correcting lenses 2702H, as compared to cyclopean visual performance shown in FIGS. 29A-29C, 30A-30C, 31A-31C, 32A-32C, 33A-33C, 34A-34C, 35A-35C, 36A-36C for myopes wearing the myopic-correcting lenses 2702M.

In this regard, FIGS. 29A-29C are exemplary plots 2900A, 2900B, 2900C of cyclopean visual performance shown as luminance (in cd/m²) and MAR (as −10 log MAR) plotted as a function of vergence (in diopters) of different myopic refractive error correction prescriptions (Rx) of the low-add myopic-correcting lenses 2702M in FIG. 27 represented by the respective low-add myopic power profiles 2802M-A in FIG. 28A for a low-add label add power of +0.75 D. FIGS. 29D-29F are exemplary plots 2900D, 2900E, 2900F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the low-add hyperopic-correcting lenses 2702H in FIG. 27 represented by the respective low-add hyperopic power profiles 2802H-D in FIG. 28D for a low-add label add power of +0.75 D.

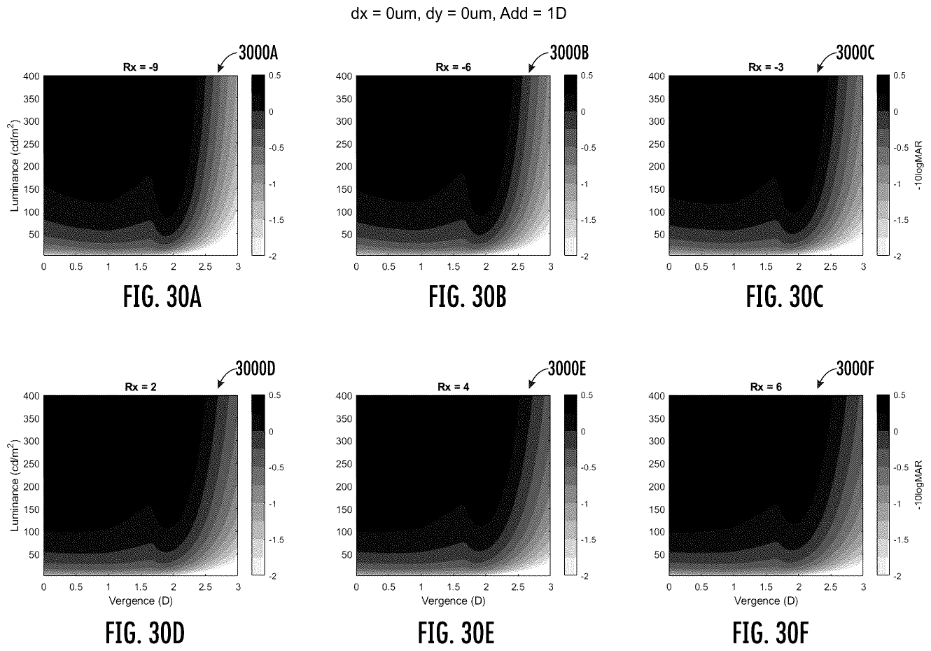

FIGS. 30A-30C are exemplary plots 3000A, 3000B, 3000C of cyclopean visual performance shown as luminance (in cd/m²) and MAR (as −10 log MAR) plotted as a function of vergence (in diopters) of different myopic refractive error correction prescriptions (Rx) of the low-add myopic-correcting lenses 2702M in FIG. 27 represented by the respective low-add myopic power profiles 2802M-A in FIG. 28A for a low-add label add power of +1.0 D. FIGS. 30D-30F are exemplary plots 3000D, 3000E, 3000F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the low-add hyperopic-correcting lenses 2702H in FIG. 27 represented by the respective low-add hyperopic power profiles 2802H-D in FIG. 28D for a low-add label add power of +1.0 D.

FIGS. 31A-31C are exemplary plots 3100A, 3100B, 3100C of cyclopean visual performance shown as luminance (in cd/m²) and MAR (as −10 log MAR) plotted as a function of vergence (in diopters) of different myopic refractive error correction prescriptions (Rx) of the low-add myopic-correcting lenses 2702M in FIG. 27 represented by the respective low-add myopic power profiles 2802M-A in FIG. 28A for a low-add label add power of +1.25 D. FIGS. 31D-31F are exemplary plots 3100D, 3100E, 3100F of cyclopean visual performance shown as MAR (as −10 log MAR) as a function of luminance (in candela (cd) per meter squared (m2) cd/m2), and vergence (in diopters) of hyperopic refractive error correction prescriptions (Rx) of the low-add hyperopic-correcting lenses 2702H in FIG. 27 represented by the respective low-add hyperopic power profiles 2802H-D in FIG. 28D for a low-add label add power of +1.25 D.

FIGS. 32A-32C are exemplary plots 3200A, 3200B, 3200C of cyclopean visual performance shown as luminance (in cd/m²) and MAR (as −10 log MAR) plotted as a function of vergence (in diopters) of different myopic refractive error correction prescriptions (Rx) of the mid-add myopic-correcting lenses 2702M in FIG. 27 represented by the respective mid-add myopic power profiles 2802M-B in FIG. 28B for a mid-add label add power of +1.5 D. FIGS. 32D-32F are exemplary plots 3200D, 3200E, 3200F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the mid-add hyperopic-correcting lenses 2702H in FIG. 27 represented by the respective mid-add hyperopic power profiles 2802H-E in FIG. 28E for a mid-add label add power of +1.5 D.

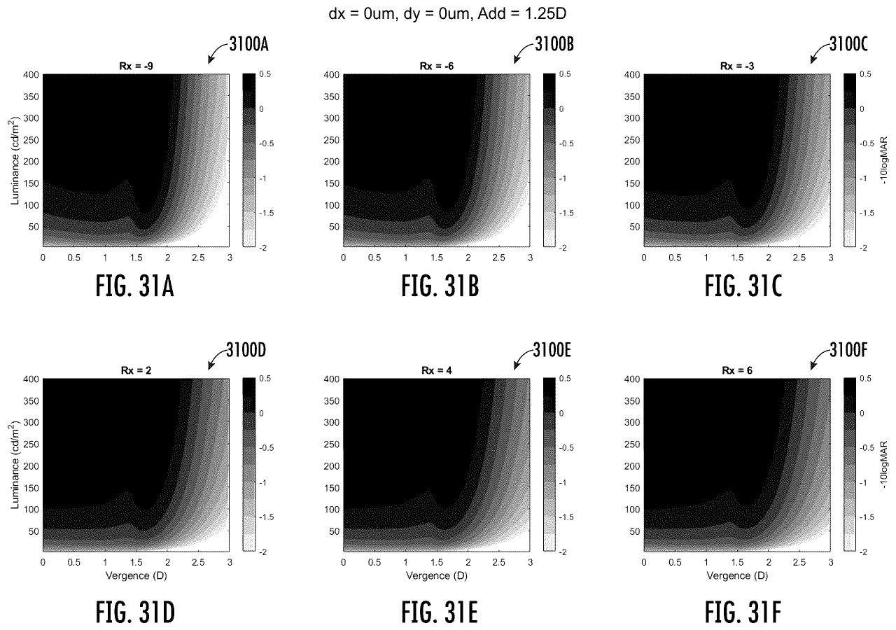

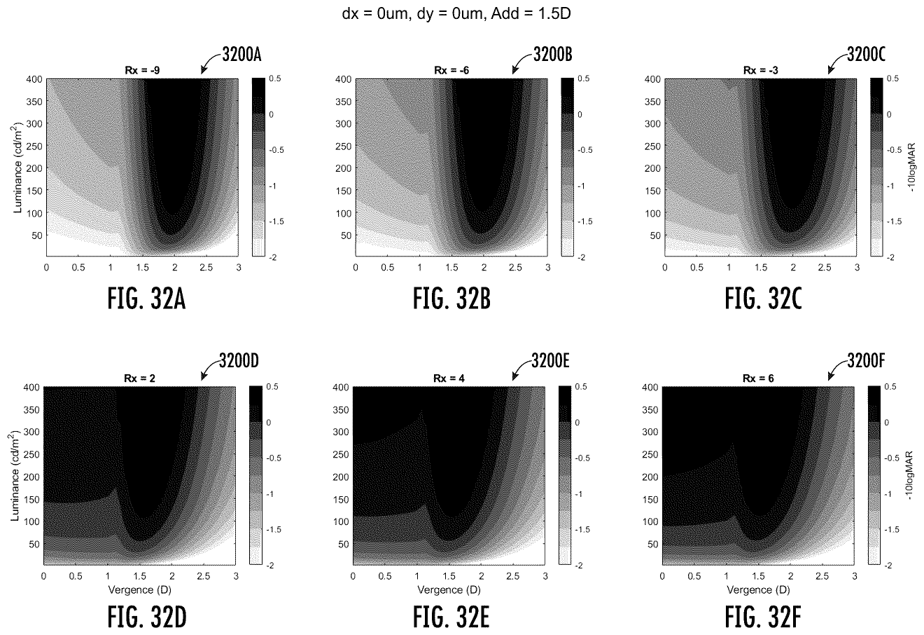

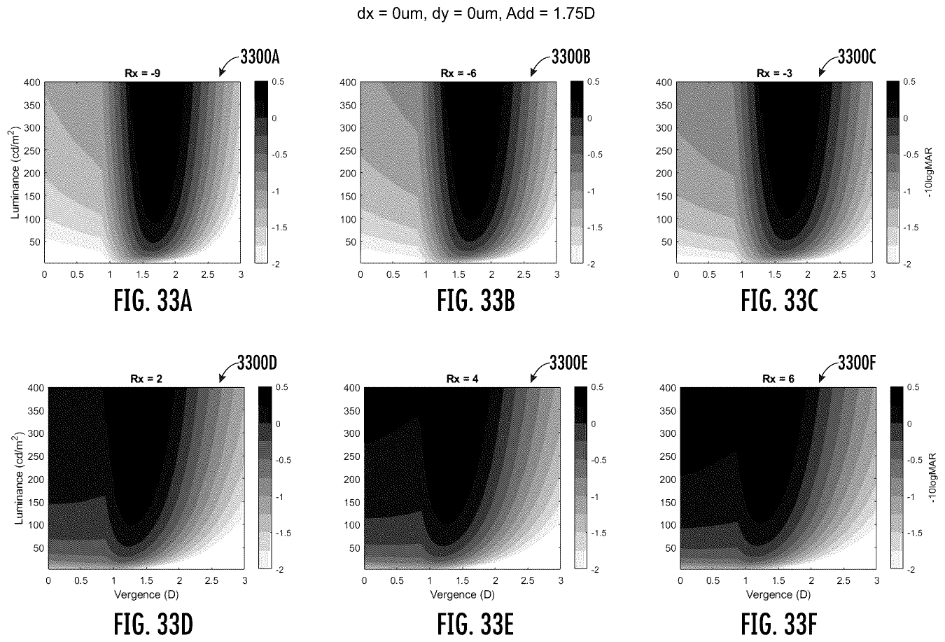

FIGS. 33A-33C are exemplary plots 3300A, 3300B, 3300C of cyclopean visual performance shown as luminance (in cd/m²) and MAR (as −10 log MAR) plotted as a function of vergence (in diopters) of different myopic refractive error correction prescriptions (Rx) of the mid-add myopic-correcting lenses 2702M in FIG. 27 represented by the respective mid-add myopic power profiles 2802M-B in FIG. 28B for a mid-add label add power of +1.75 D. FIGS. 33D-33F are exemplary plots 3300D, 3300E, 3300F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the mid-add hyperopic-correcting lenses 2702H in FIG. 27 represented by the respective mid-add hyperopic power profiles 2802H-E in FIG. 28E for a mid-add label add power of +1.75 D.

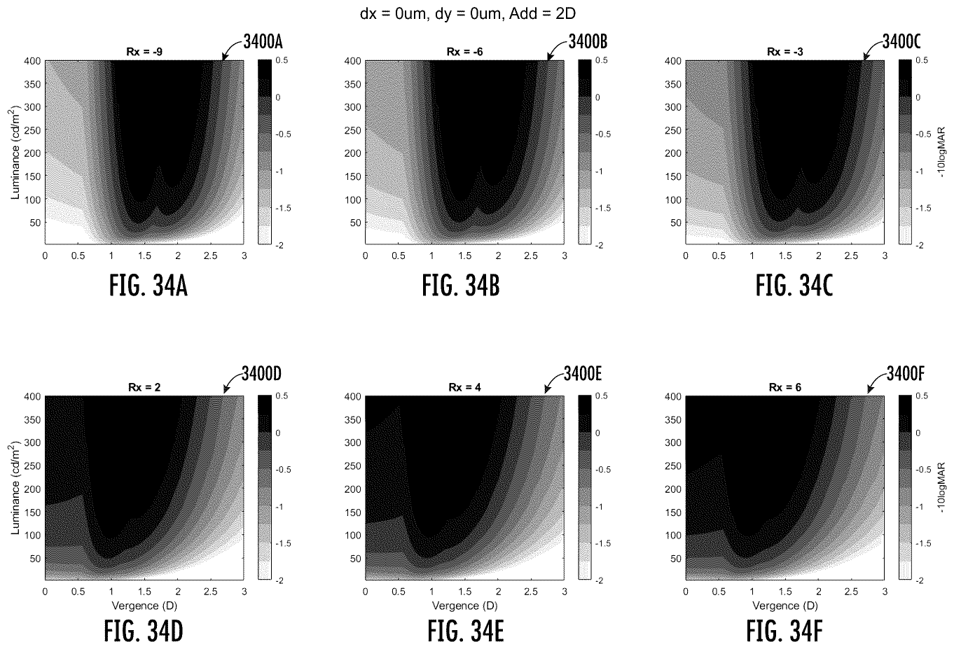

FIGS. 34A-34C are exemplary plots 3400A, 3400B, 3400C of cyclopean visual performance shown as luminance (in cd/m²) and MAR (as −10 log MAR) plotted as a function of vergence (in diopters) of different myopic refractive error correction prescriptions (Rx) of the mid-add myopic-correcting lenses 2702M in FIG. 27 represented by the respective mid-add myopic power profiles 2802M-B in FIG. 28B for a mid-add label add power of +2.0 D. FIGS. 34D-34F are exemplary plots 3400D, 3400E, 3400F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the mid-add hyperopic-correcting lenses 2702H in FIG. 27 represented by the respective mid-add hyperopic power profiles 2802H-E in FIG. 28E for a mid-add label add power of +2.0 D.

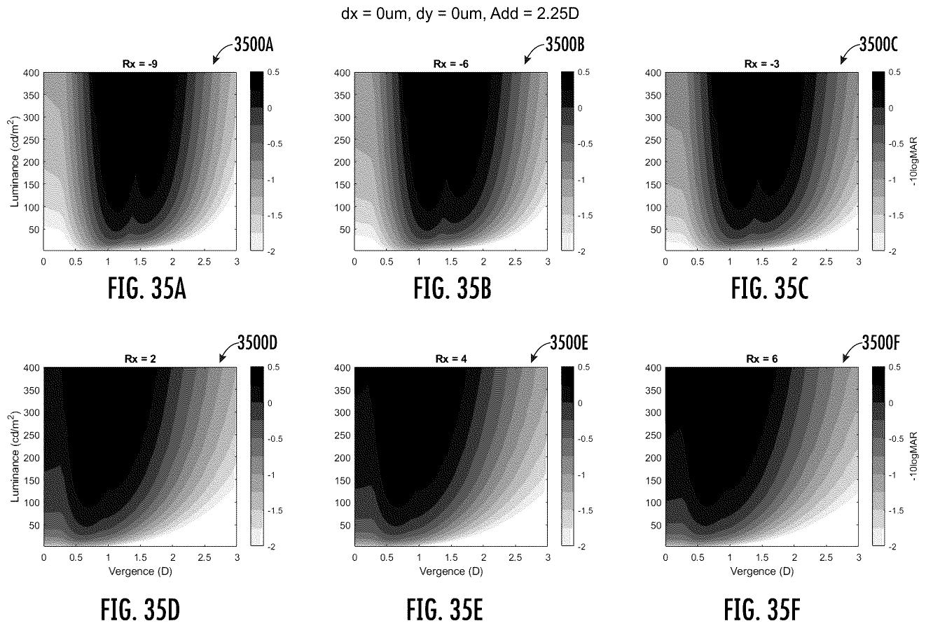

FIGS. 35A-35C are exemplary plots 3500A, 3500B, 3500C of cyclopean visual performance shown as luminance (in cd/m²) and MAR (as −10 log MAR) plotted as a function of vergence (in diopters) of different myopic refractive error correction prescriptions (Rx) of the high-add myopic-correcting lenses 2702M in FIG. 27 represented by the respective high-add myopic power profiles 2802M-C in FIG. 28C for a high-add label add power of +2.25 D. FIGS. 35D-35F are exemplary plots 3500D, 3500E, 3500F of cyclopean visual performance shown as MAR (as −10 log MAR) as a function of luminance (in candela (cd) per meter squared (m2) cd/m2), and vergence (in diopters) of hyperopic refractive error correction prescriptions (Rx) of the high-add hyperopic-correcting lenses 2702H in FIG. 27 represented by the respective high-add hyperopic power profiles 2802H-F in FIG. 28F for a mid-add label add power of +2.25 D.

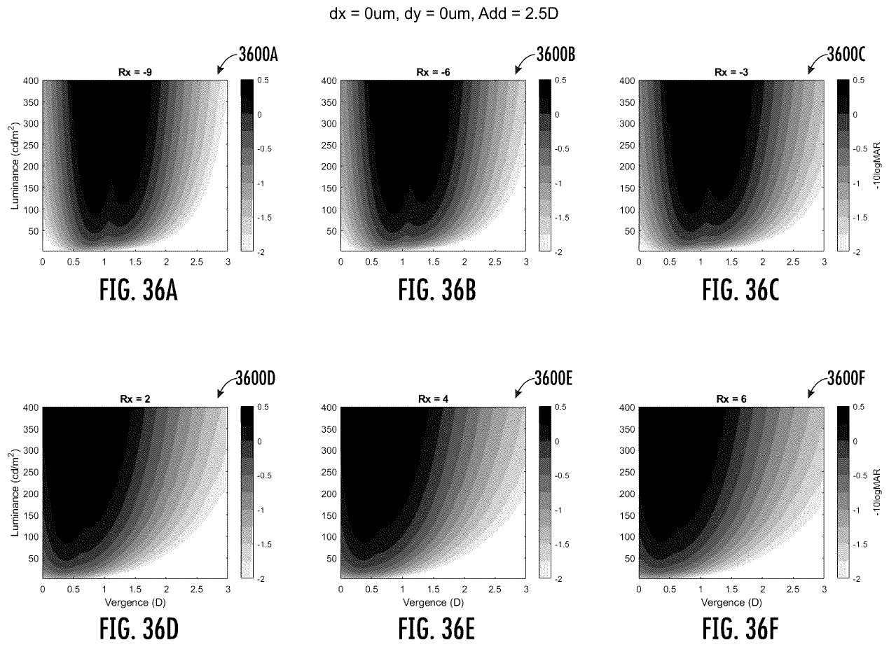

FIGS. 36A-36C are exemplary plots 3600A, 3600B, 3600C of cyclopean visual performance shown as luminance (in cd/m²) and MAR (as −10 log MAR) plotted as a function of vergence (in diopters) of different myopic refractive error correction prescriptions (Rx) of the high-add myopic-correcting lenses 2702M in FIG. 27 represented by the respective high-add myopic power profiles 2802M-C in FIG. 28C for a high-add label add power of +2.5 D. FIGS. 36D-36F are exemplary plots 3600D, 3600E, 3600F of cyclopean visual performance shown as MAR (as −10 log MAR) as a function of luminance (in candela (cd) per meter squared (m2) cd/m2) and vergence (in diopters) of hyperopic refractive error correction prescriptions (Rx) of the high-add hyperopic-correcting lenses 2702H in FIG. 27 represented by the respective high-add hyperopic power profiles 2802H-F in FIG. 28F for a mid-add label add power of +2.5 D.

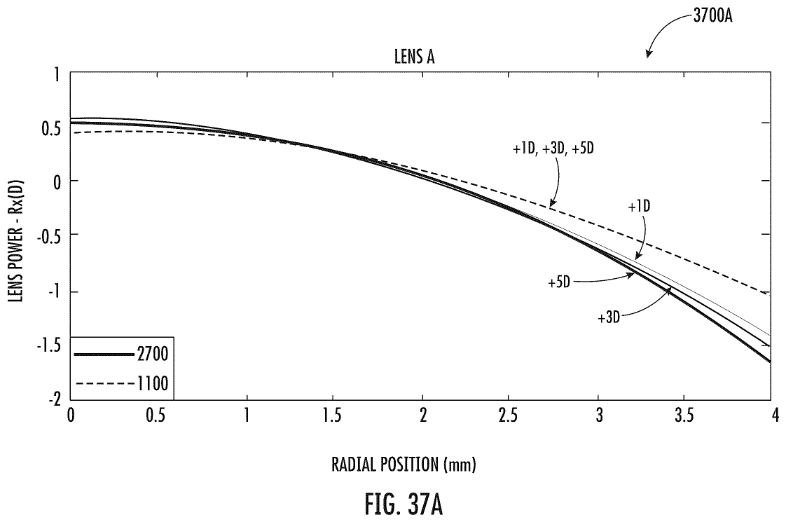

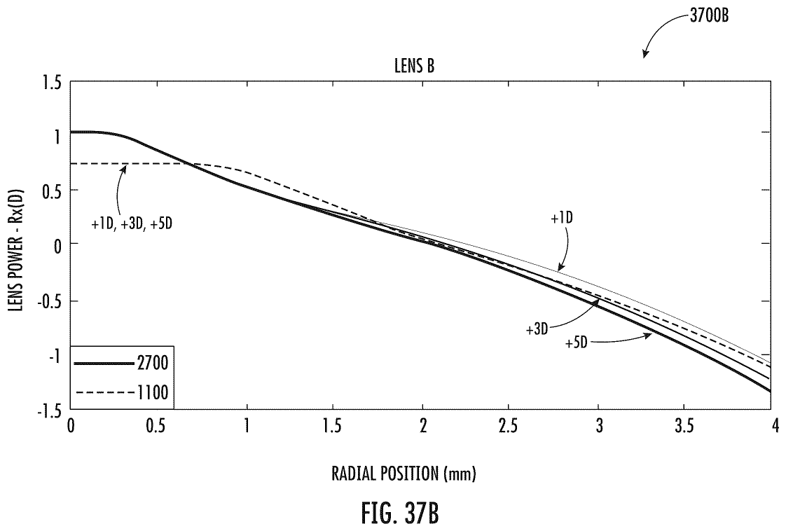

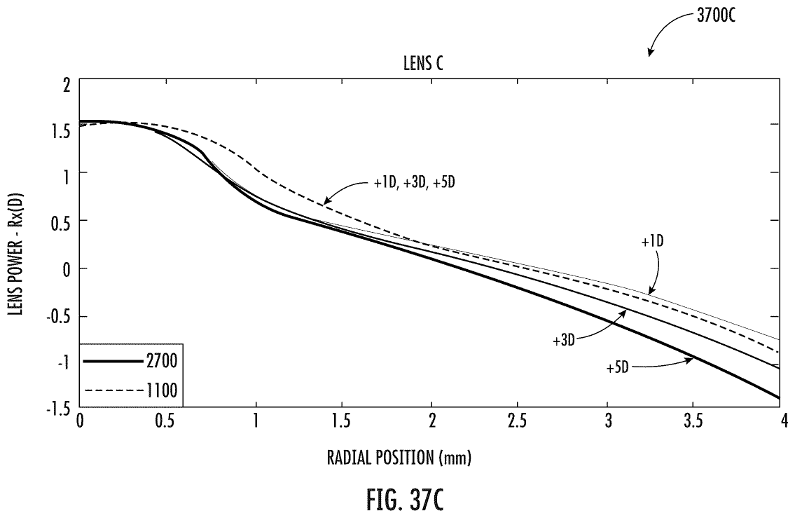

FIGS. 37A-37C are exemplary graphs 3700A, 3700B, 3700C that each include the respective low-add, mid-add, and high-add hyperopic power profiles 1302H-D, 1302H-E, 1302H-F for the multifocal contact lens system 1100 in FIG. 11 of +1 D, +3 D, and +5 D hyperopic refractive error correction prescription, respectively, and that have second SPHAs 1112H and/or the second add optical zones 1104H that are constant across hyperopia refractive error corrections and thus not dependent on hyperopia refractive error correction, plotted with the respective low-add, mid-add, and high-add hyperopic power profiles 2802H-D, 2802H-E, 2802H-F for the multifocal contact lens system 2700 in FIG. 27 that has second SPHAs 2712H and/or the second add optical zones 2704H that are refractive error correction dependent. As shown in the graphs 3700B, 3700C the mid-add and high-add hyperopic power profiles 2802H-E, 2802H-F for the hyperopic-correcting lenses 2702H provide better far-distance performance of approximately 1 MAR letter as compared to the mid-add and high-add hyperopic power profiles 1302H-E, 1302H-F for the hyperopic-correcting lenses 1102H.

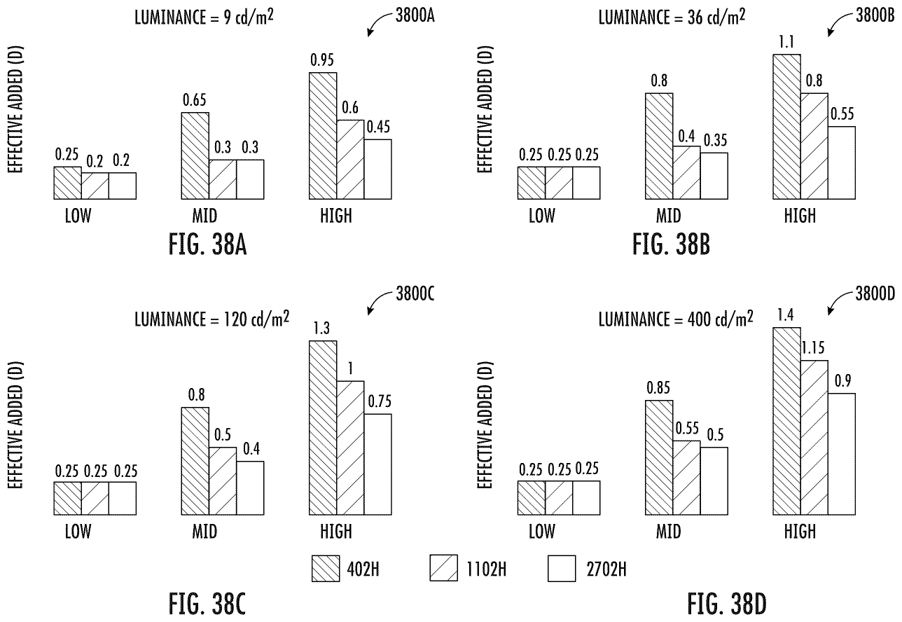

FIGS. 38A-38D are bar graphs 3800A-3800D that each include monocular effective add power for a different effective add powers at different respective luminance levels of 9 cd/mm², 36 cd/mm², 120 cd/mm², and 140 cd/mm² for the low-add, mid-add, and high-add hyperopic-correcting lenses 402H, 1102H, 2702H for different respective multifocal contact lens systems 400, 1100, 2700 in FIGS. 4, 11, and 27 represented by the respective power profiles in FIGS. 5A-5C, 13A-13F, and 28A-28F. The effective add power and monocular DOF of the low-add, mid-add, and high-add hyperopic-correcting lenses 402H, 1102H, 2702H were compared at the luminance levels of 9 cd/mm², 36 cd/mm², 120 cd/mm², and 140 cd/mm². As shown in FIGS. 38A-38D, the mid-add and high-add hyperopic-correcting lenses 2702H that have second SPHAs 2712H and/or the second add optical zones 2704H that are refractive error correction dependent, have less effective add power for all luminance levels except in for the mid-add hyperopic-correcting lenses 2702H at low luminance (e.g., 9 cd/mm²). Further, the high-add hyperopic-correcting lenses 2702H have less interocular disparity. Lower intraocular disparity of the hyperopic-correcting lenses 2702H in comparison to the hyperopic-correcting lenses 1102H is illustrated in FIGS. 38A-38D by comparing (or subtracting) the high-add effective add power and the mid-add effective add power for the hyperopic-correcting lenses 2702H with the high-add effective add power and the mid-add effective add power for the hyperopic-correcting lenses 1102H.

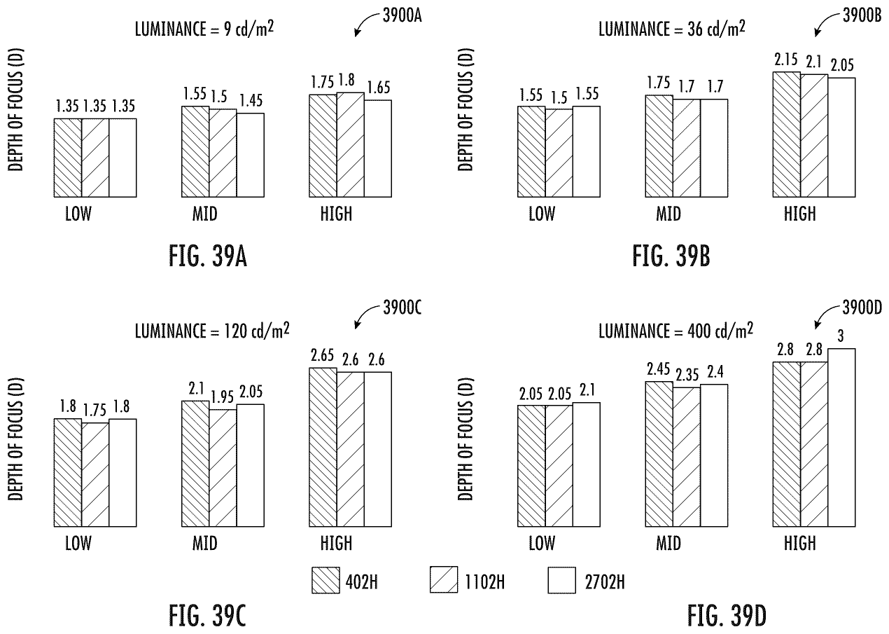

FIGS. 39A-39D are bar graphs 3900A-3900D that each include monocular DOFs for different effective add powers at different respective luminance levels of 9 cd/mm², 36 cd/mm², 120 cd/mm², and 140 cd/mm² for the low-add, mid-add, and high-add hyperopic-correcting lenses 402H, 1102H, 2702H for different respective multifocal contact lens systems 400, 1100, 2700 in FIGS. 4, 11, and 27 represented by the respective power profiles in FIGS. 5A-5C, 13A-13F, and 28A-28F. No substantial differences in DOF were identified.

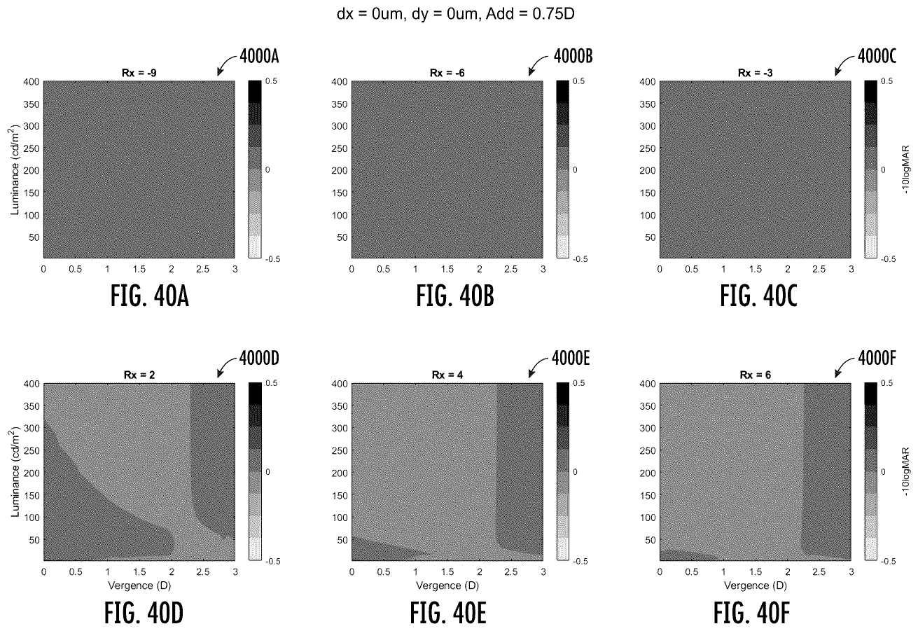

FIGS. 40A-40F are exemplary plots of the difference in cyclopean visual performance as luminance difference plotted as a function of vergence (in diopters) between different refractive error correction prescriptions (Rx) myopic-correcting and hyperopic-correcting lenses 2702M, 2702H in the multifocal contact lens system 2700 in FIG. 27, as compared to the myopic-correcting and hyperopic-correcting lenses 402M, 402H in the multifocal contact lens system 400 in FIG. 4.

In this regard, FIGS. 40A-40C are exemplary plots 4000A, 4000B, 4000B of the difference in cyclopean visual performance as luminance difference plotted as a function of vergence (in diopters) between different refractive error correction prescriptions (Rx) of low-add myopic-correcting lenses 2702M represented by the respective low-add myopic power profiles 2802M-A in FIG. 28A for a low-add label add power of +0.75 D, and compared to the plots 600A-600C of cyclopean visual performance in FIGS. 6A-6C for the corresponding different refractive error correction prescriptions (Rx) of low-add myopic-correcting lenses 402M for a corresponding low-add label add power of +0.75 D. FIGS. 40D-40F are exemplary plots 4000D, 4000E, 4000F of the difference in cyclopean visual performance as luminance difference plotted as a function of vergence (in diopters) between different refractive error correction prescriptions (Rx) of low-add hyperopic-correcting lenses 2702H represented by the respective low-add hyperopic power profiles 2802H-F in FIG. 28D for a low-add label add power of +0.75 D, as compared to the plots 600D-600F of cyclopean visual performance in FIGS. 6D-6F for the corresponding different refractive error correction prescriptions (Rx) of low-add hyperopic-correcting lenses 402H for a corresponding low-add label add power of +0.75 D.

As shown in the cyclopean visual performance plots 4000D-4000F in FIGS. 40D-40F, the low-add hyperopic-correcting lenses 2702H in the multifocal contact lens system 2700 in FIG. 27 exhibit even better far-distance vision performance as compared to the low-add hyperopic-correcting lenses 402H in the multifocal contact lens system 400 in FIG. 4 for low-add label add powers. However, the low-add hyperopic-correcting lenses 402H in the multifocal contact lens system 400 in FIG. 4 exhibit slightly better near-distance vision than the low-add hyperopic-correcting lenses 2702H in the multifocal contact lens system 2700 in FIG. 27 for low-add label add powers. This is due in part to the reduced add optical zone radius (one-half of diameter D_{C4}) of the hyperopic-correcting lenses 2702H in the multifocal contact lens system 2700 in FIG. 27 as compared to the add optical zone radius (one-half of diameter D_{C3}) of the myopic-correcting lenses 2702M in the multifocal contact lens system 2700 in FIG. 27. A reduced add optical zone radius (one-half of diameter D_{C4}) of the hyperopic-correcting lenses 2702H will provide for less light to be received in the hyperope pupil through the second add optical zone 2704H when focused at near distances.

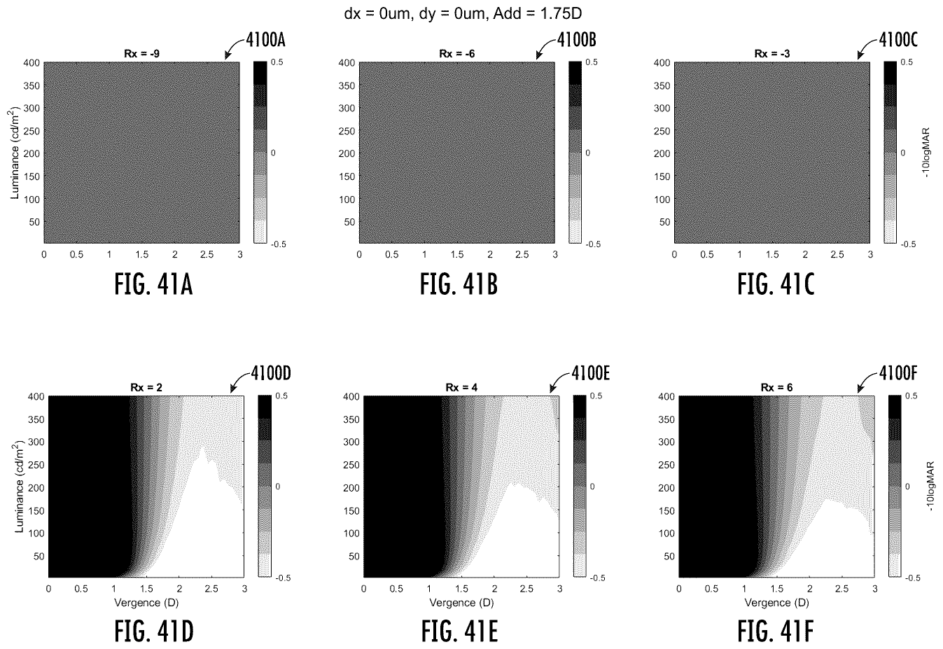

FIGS. 41A-41C are exemplary plots 4100A, 4100B, 4100C of the difference in cyclopean visual performance as luminance difference plotted as a function of vergence (in diopters) between different refractive error correction prescriptions (Rx) of mid-add myopic-correcting lenses 2702M represented by the respective mid-add myopic power profiles 2802M-B in FIG. 28B for a mid-add label add power of +1.75 D, and compared to the plots 700A-700C of cyclopean visual performance in FIGS. 7A-7C for the corresponding different refractive error correction prescriptions (Rx) of mid-add myopic-correcting lenses 402M for a corresponding mid-add label add power of +1.75 D. FIGS. 41D-41F are exemplary plots 4100D, 4100E, 4100F of the difference in cyclopean visual performance as luminance difference plotted as a function of vergence (in diopters) between different refractive error correction prescriptions (Rx) of mid-add hyperopic-correcting lenses 2702H represented by 10%—the respective mid-add hyperopic power profiles 2802H-E in FIG. 28E for a mid-add label add power of +1.75 D, as compared to the plots 700D-700F of cyclopean visual performance in FIGS. 7D-7F for the corresponding different refractive error correction prescriptions (Rx) of mid-add hyperopic-correcting lenses 402H for a corresponding mid-add label add power of +1.75 D.

As shown in the cyclopean visual performance plots 4100D-4100F in FIGS. 41D-242F, the mid-add hyperopic-correcting lenses 2702H in the multifocal contact lens system 2700 in FIG. 27 exhibit far better far-distance vision performance as compared to the mid-add hyperopic-correcting lenses 402H in the multifocal contact lens system 400 in FIG. 4 for mid-add label add powers. However, the mid-add hyperopic-correcting lenses 402H in the multifocal contact lens system 400 in FIG. 4 exhibit slightly better near-distance vision than the mid-add hyperopic-correcting lenses 2702H in the multifocal contact lens system 2700 in FIG. 27 for mid-add label add powers. This is due in part to the reduced add optical zone radius (one-half of diameter D_{C4}) of the hyperopic-correcting lenses 2702H in the multifocal contact lens system 2700 in FIG. 27 as compared to the add optical zone radius (one-half of diameter D_{C3}) of the myopic-correcting lenses 2702M in the multifocal contact lens system 2700 in FIG. 27. A reduced add optical zone radius (one-half of diameter D_{C4}) of the hyperopic-correcting lenses 2702H will provide for less light to be received in the hyperope pupil through the second add optical zone 2704H when focused at near distances.

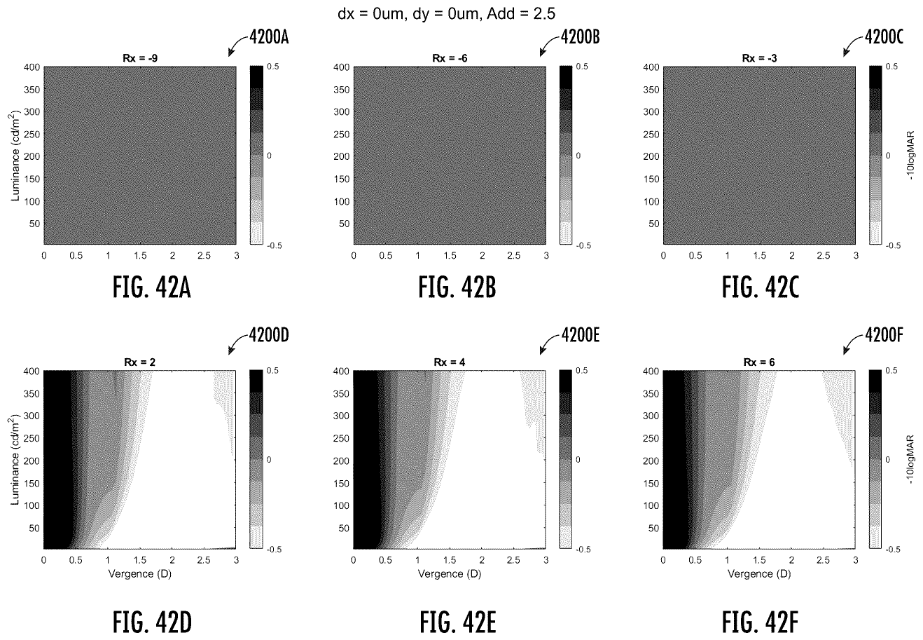

FIGS. 42A-42C are exemplary plots 4200A, 4200B, 4200B of the difference in cyclopean visual performance as luminance difference plotted as a function of vergence (in diopters) between different refractive error correction prescriptions (Rx) of high-add myopic-correcting lenses 2702M represented by the respective high-add myopic power profiles 2802M-C in FIG. 28C for a high-add label add power of +2.5 D, and compared to the plots 800A-800C of cyclopean visual performance in FIGS. 8A-8C for the corresponding different refractive error correction prescriptions (Rx) of high-add myopic-correcting lenses 402M for a corresponding high-add label add power of +2.5 D. FIGS. 42D-42F are exemplary plots 4200D, 4200E, 4200F of the difference in cyclopean visual performance as luminance difference plotted as a function of vergence (in diopters) between different refractive error correction prescriptions (Rx) of high-add hyperopic-correcting lenses 2702H represented by the respective high-add hyperopic power profiles 2802H-F in FIG. 28F for a high-add label add power of +2.5 D, as compared to the plots 800D-800F of cyclopean visual performance in FIGS. 8D-8F for the corresponding different refractive error correction prescriptions (Rx) of high-add hyperopic-correcting lenses 402H for a corresponding high-add label add power of +2.5 D.

As shown in the cyclopean visual performance plots 4200D-4200F in FIGS. 42D-42F, the high-add hyperopic-correcting lenses 2702H in the multifocal contact lens system 2700 in FIG. 27 exhibit better far-distance vision performance as compared to the high-add hyperopic-correcting lenses 402H in the multifocal contact lens system 400 in FIG. 4 for high-add label add powers. Also, the high-add hyperopic-correcting lenses 2702H in the multifocal contact lens system 2700 in FIG. 27 exhibit slightly better near-distance vision than the high-add hyperopic-correcting lenses 402H in the multifocal contact lens system 400 in FIG. 4 for high-add label add powers. This is due in part to the reduced add optical zone radius (one-half of diameter D_{C4}) of the hyperopic-correcting lenses 2702H in the multifocal contact lens system 2700 in FIG. 27 as compared to the add optical zone radius (one-half of diameter D_{C3}) of the myopic-correcting lenses 2702M in the multifocal contact lens system 2700 in FIG. 27. A reduced add optical zone radius (one-half of diameter D_{C4}) of the hyperopic-correcting lenses 2702H will provide for less light to be received in the hyperope pupil through the second add optical zone 2704H when focused at near distances.

Note that the aspects described above are in regard to exemplary contact lens systems, contact lens pairs, and individual contact lenses, but not that such examples are not limited to contact lenses but could be applied to any type of lenses and related lens systems and pairs.

It is important to note that the lens designs of the present disclosure may be incorporated into any number of different contact lenses formed from any number of materials, Specifically, the lens design of the present disclosure may be utilized in any of the contact lenses described herein, including, but not limited to, daily wear soft contact lenses, rigid gas permeable contact lenses, bifocal contact lenses, toric contact lenses, and hybrid contact lenses. In addition, although the disclosure is described with respect to contact lenses, it is important to note that the concept of the present disclosure may be utilized in spectacle lenses, intraocular lenses, corneal inlays, and onlays.

It is to be understood that the disclosure is not to be limited to the specific aspects disclosed and that modifications and other aspects are intended to be included within the scope of the appended claims and their equivalents. Although specific terms are employed herein, they are used in a generic and descriptive sense only and not for purposes of limitation. Upon reading the following description in light of the accompanying drawing figures, those skilled in the art will understand the concepts of the disclosure and will recognize applications of these concepts not particularly addressed herein. The aspects set forth below represent the necessary information to enable those skilled in the art to practice the disclosure and illustrate the best mode of practicing the disclosure. It should be understood that these concepts and applications fall within the scope of the disclosure and the accompanying claims. Many modifications and other embodiments of the disclosure set forth herein will come to mind to one skilled in the art to which the disclosure pertains, having the benefit of the teachings presented in the foregoing descriptions and the associated drawings. Although shown and described in what is believed to be the most practical and specific aspects disclosed, modifications and other aspects are intended to be included within the scope of the appended claims. It is apparent that departures from specific designs and methods described and shown will suggest themselves to those skilled in the art and may be used without departing from the spirit and scope of the disclosure.

Implementation examples are described in the following numbered clauses:
1. A contact lens system, comprising:
   a plurality of myopic-correcting lenses, each having a myopic power profile and each comprising:
      a first add optical zone having a first add zone power profile comprising a myopic paraxial power selected to substantially correct myopic refractive error and a first add power; and
      a first transitional optical zone surrounding the first add optical zone, the first transitional optical zone having a myopic progressive power profile; and
      the myopic power profile comprising the first add zone power profile and the myopic progressive power profile, the myopic power profile includes a first spherical aberration (SPHA); and
   a plurality of hyperopic-correcting lenses, each having a hyperopic power profile and each comprising:
      a second add optical zone having a second add zone power profile comprising a hyperopic paraxial power selected to substantially correct hyperopic refractive error and a second add power; and
      a second transitional optical zone surrounding the second add optical zone, the second transitional optical zone having a hyperopic progressive power profile;
      the hyperopic power profile comprising the second add zone power profile and the hyperopic progressive power profile, the hyperopic power profile having a second SPHA;
   wherein the second SPHA of each of the plurality of hyperopic-correcting lenses is at least ten percent (10%) less than the first SPHA of each of the plurality of myopic-correcting lenses.
2. The contact lens system of clause 1, wherein:
   the second SPHA of each of the plurality of hyperopic-correcting lenses is between ten percent (10%) and twenty percent (20%) less than the first SPHA of each of the plurality of myopic-correcting lenses.
3. The contact lens system of clause 1, wherein:
   the first SPHA of each of the plurality of myopic-correcting lenses is targeted to an average first ocular SPHA of a population of myopes; and the second SPHA of each of the plurality of hyperopic-correcting lenses is targeted to an average second ocular SPHA of a population of hyperopes.
4. The contact lens system of clause 3, wherein:
   the first SPHA of each of the plurality of myopic-correcting lenses is a first residual SPHA from the first ocular SPHA for the targeted average SPHA of the population of myopes;
   the second SPHA of each of the plurality of hyperopic-correcting lenses is a second residual SPHA from the second ocular SPHA for the targeted average SPHA of the population of hyperopes; and
   the first residual SPHA is the second residual SPHA.
5. The contact lens system of clause 1, wherein:
   at least one of the plurality of myopic-correcting lenses has the respective myopic power profile providing a first label add power of at least +1.5 diopter (D);
   at least one of the plurality of hyperopic-correcting lenses has the respective hyperopic power profile providing the first label add power; and
   the second add power of the at least one of the plurality of hyperopic-correcting lenses is at least +0.2 D less than the first add power of the at least one of the plurality of myopic-correcting lenses.
6. The contact lens system of clause 5, wherein:
   the at least one of the plurality of myopic-correcting lenses comprises:
      one or more mid-add power myopic-correcting lenses comprises the respective myopic power profile providing a mid-add label add power between +1.5 diopters (D) and +1.99 D;
      one or more high-add power myopic-correcting lenses comprises the respective myopic power profile providing a high-add label add power between +2.0 and +2.5 D;
   the at least one of the plurality of hyperopic-correcting lenses comprises:
      one or more mid-add power hyperopic-correcting lenses comprises the respective hyperopic power profile providing the mid-add label add power;
      one or more high-add power hyperopic-correcting lenses comprises the respective hyperopic power profile providing the high-add label add power;
   the second add power of the one or more mid-add power hyperopic-correcting lenses is at least +0.2 D diopters less than the first add power of the one or more mid-add power myopic-correcting lenses; and
   the second add power of the one or more high-add power hyperopic-correcting lenses is at least +0.2 D diopters less than the first add power of the one or more high-add power myopic-correcting lenses.
7. The contact lens system of clause 6, wherein:
   the second add power of the one or more mid-add power hyperopic-correcting lenses is at least +0.3 D diopters less than the first add power of the one or more mid-add power myopic-correcting lenses.
8. The contact lens system of clause 1, wherein:
   the second SPHA for each of the plurality of hyperopic-correcting lenses is the same.
9. The contact lens system of clause 1, wherein:
   for each of the plurality of myopic-correcting lenses:
      the first add optical zone is disposed around a first optical axis; and
      the first SPHA is a spherical aberration in the myopic power profile is a function of radius relative to first optical axis;
   for each of the plurality of hyperopic-correcting lenses:
      the second add optical zone is disposed around a second optical axis; and
      the second SPHA is a spherical aberration in the hyperopic power profile is a function of radius relative to second optical axis;
   the first SPHA of each of the plurality of myopic-correcting lenses is between −0.064 diopter (D)/millimeter (mm)² (D/mm²) and −0.096 D/mm²; and
   the second SPHA of each of the plurality of hyperopic-correcting lenses is between −0.073 D/mm² and −0.111 D/mm².
10. The contact lens systems of clause 1, wherein:
   the plurality of myopic-correcting lenses comprise one or more myopic-correcting lenses having the myopic power profile comprising a first label add power;
   the plurality of hyperopic-correcting lenses comprise one or more hyperopic-correcting lenses having the hyperopic power profile that comprising the first label add power;
   the first label add power of the one or more hyperopic-correcting lenses is reduced with respect to the first label add power of the one or more myopic-correcting lenses by between 0 and +0.50 diopter (D).
11. The contact lens system of clause 10, wherein:
   a depth-of-focus (DOF) of the one or more hyperopic-correcting lenses is changed with respect to a DOF of the one or more myopic-correcting lenses by between +0.05 D and −0.25 D.
12. The contact lens systems of clause 1, wherein:
   the plurality of myopic-correcting lenses comprises:
      one or more low-add myopic-correcting lenses of the plurality of myopic-correcting lenses having the myopic power profile comprising a low-add label add power between +0.5 diopter (D) and +1.49 D;
      one or more mid-add myopic-correcting lenses of the plurality of myopic-correcting lenses having the myopic power profile comprising a mid-add label add power between +1.5 D and +1.99 D;
      one or more high-add myopic-correcting lenses of the plurality of myopic-correcting lenses having the myopic power profile comprising a mid-add label add power between +2.0 D and +2.5 D diopters;
   the plurality of hyperopic-correcting lenses comprises:
      one or more low-add hyperopic-correcting lenses of the plurality of hyperopic-correcting lenses having the hyperopic power profile comprising the low-add label add power;
      one or more mid-add hyperopic-correcting lenses of the plurality of hyperopic-correcting lenses having the hyperopic power profile comprising the mid-add label add power;
      one or more high-add hyperopic-correcting lenses of the plurality of hyperopic-correcting lenses having the hyperopic power profile comprising the high-add label add power;
   the low-add label add power of the one or more low-add hyperopic-correcting lenses is reduced with respect to the low-add label add power of the one or more low-add myopic-correcting lenses between GD and +0.15 D;
   the mid-add label add power of the one or more mid-add hyperopic-correcting lenses is reduced with respect to the mid-add label add power of the one or more mid-add myopic-correcting lenses between +0.20 D and +0.50 D; and
   the high-add label add power of the one or more mid-add hyperopic-correcting lenses is reduced with respect to the high-add label add power of the one or more mid-add myopic-correcting lenses between +0.15 D and −0.0.15 D.
13. The contact lens system of clause 12, wherein:
   a low-add depth-of-focus (DOF) of the one or more low-add hyperopic-correcting lenses is changed with respect to a low-add DOF of the one or more low-add myopic-correcting lenses by between +0.10 D and −0.10 D;
   a mid-add DOF of the one or more mid-add hyperopic-correcting lenses is changed with respect to a mid-add DOF of the one or more mid-add myopic-correcting lenses by between +0.05 D and −0.25 D; and
   a high-add DOF of the one or more high-add hyperopic-correcting lenses is changed with respect to a high-add DOF of the one or more high-add myopic-correcting lenses by between +0.15 D and −0.15 D.
14. The contact lens system of clause 1, wherein:
   for each of the plurality of hyperopic-correcting lenses:
      the second add optical zone is disposed around a second optical axis; and
   the plurality of hyperopic-correction lenses each have the comprised from the group consisting of:
      a low-add hyperopic power profile comprising:
         the second add optical zone comprising a second, low-add add optical zone diameter having second, low-add add optical zone diameter between 0 and 0.23 mm; and the second transitional optical zone comprising:
         a first, second low-add transitional optical zone having a first radius relative to the second optical axis between 0.23 and 0.44 mm, and the second add power between +0.002 diopter (D) and +0.003 D;
         a second, second low-add transitional optical zone having a second radius relative to the second optical axis between 0.44 mm and 0.67 mm, and the second add power between +0.0005 D and +0.001 D;
         a third, second low-add transitional optical zone having a second radius relative to the second optical axis between 0.67 mm and 2.0 mm, and the second add power between +0.0005 D and +0.001 D; and
         a second low-add final, distance optical zone extrapolated paraxial power of between +0.336 D and +0.537 D relative to paraxial power of the refractive need;
   a mid-add hyperopic power profile comprising:
      the second add optical zone comprising a second, mid-add add optical zone diameter having second, mid-add add optical zone diameter between 0 mm and 0.73 mm; and
      the second transitional optical zone comprising:
         a first, second mid-add transitional optical zone having a first radius relative to the second optical axis between 0.73 mm and 0.98 mm, and the second add power between +0.343 D and +0.425 D;
         a second, second mid-add transitional optical zone having a second radius relative to the second optical axis between 0.98 mm and 1.38 mm, and the second add power between +0.262 D and +0.344 D; and
         a third, second mid-add transitional optical zone having a second radius relative to the second optical axis between 1.38 mm and 2.0 mm, and the second add power between +0.060 and +0.142 D; and
         a second mid-add final, distance optical zone extrapolated paraxial power of between +0.259 D and +0.460 D relative to the paraxial power of the refractive need; and
   a high-add hyperopic power profile comprising:
      the second add optical zone comprising a second, high-add add optical zone diameter having second, high-add add optical zone diameter between 0 mm and 0.59 mm; and
      the second transitional optical zone comprising:
         a first, second high-add transitional optical zone having a first radius relative to the second optical axis between 0.59 mm and 0.87 mm, and the second add power between +0.845 D and +1.045 D;
         a second, second high-add transitional optical zone having a second radius relative to the second optical axis between 0.87 mm and 1.33 mm, and the second add power between +0.646 D and +0.846 D; and
         a third, second high-add transitional optical zone having a second radius relative to the second optical axis between 1.33 mm and 2.0 mm, and the second add power between +0.149 D and +0.349 D; and
         a second high-add final, distance optical zone extrapolated paraxial power of between +0.428 D and +0.629 D relative to the paraxial power of the refractive need.
15. The contact lens system of clause 14, wherein:
   for each of the plurality of myopic-correcting lenses:
      the first add optical zone is disposed around a first optical axis; and
   the plurality of myopic-correction lenses each have the myopic power profile comprised from the group consisting of:
      a low-add myopic power profile comprising:
         the first add optical zone comprising a first, low-add add optical zone diameter having first, low-add add optical zone diameter between 0 mm and 0.23 mm; and
         the first transitional optical zone comprising:
         a first, first low-add transitional optical zone having a first radius relative to the first optical axis between 0.23 and 0.44 mm, and the first add power between +0.002 D and +0.003 D;
         a second, first low-add transitional optical zone having a first radius relative to the first optical axis between 0.44 mm and 0.67 mm, and the first add power between +0.002 D and +0.003 D;
         a third, first low-add transitional optical zone having a first radius relative to the first optical axis between 0.67 mm and 2.0 mm, and the first add power between +0.0005 D and +0.001 D; and
         a first low-add final, distance optical zone extrapolated paraxial power of between +0.336 D and +0.537 D relative to paraxial power of the refractive need;
      a mid-add myopic power profile comprising:
         the first add optical zone comprising a first, mid-add add optical zone diameter having first, mid-add add optical zone diameter between 0 mm and 0.78 mm; and
         the first transitional optical zone comprising:
         a first, first mid-add transitional optical zone having a first radius relative to the first optical axis between 0.78 mm and 1.06 mm, and the first add power between +0.343 D and +0.425 D;
         a first, first mid-add transitional optical zone having a first radius relative to the first optical axis between 1.06 mm and 1.49 mm, and the first add power between +0.262 D and +0.344 D; and
         a third, first mid-add transitional optical zone having a first radius relative to the first optical axis between 1.49 mm and 2.0 mm, and the first add power between +0.060 and +0.142 D; and
         a first mid-add final, distance optical zone extrapolated paraxial power of between +0.559 D and +0.760 D relative to the paraxial power of the refractive need; and
      a high-add myopic power profile comprising:
         the first add optical zone comprising a first, high-add add optical zone diameter having first, high-add add optical zone diameter between 0 mm and 0.64 mm; and
         the first transitional optical zone comprising:
         a first, first high-add transitional optical zone having a first radius relative to the first optical axis between 0.64 mm and 0.94 mm, and the first add power between +0.845 D and +1.045 D;
         a first, first high-add transitional optical zone having a first radius relative to the first optical axis between 0.94 mm and 1.43 mm, and the first add power between +0.646 D and +0.846 D; and
         a third, first high-add transitional optical zone having a first radius relative to the first optical axis between 1.43 mm and 2.0 mm, and the first add power between +0.149 D and +0.349 D; and
         a first high-add final, distance optical zone extrapolated paraxial power of between +0.628 D and +0.828 D relative to the paraxial power of the refractive need.
16. The contact lens system of clause 1,
   for each of the plurality of myopic-correcting lenses comprises:
      the first add optical zone has a first add zone diameter; and for each of the plurality of hyperopic-correcting lenses:
   the second add optical zone has a second add zone diameter that is at least 5% less than the first add zone diameter.
17. The contact lens system of clause 6, wherein:
   the first add zone diameter for each of the plurality of myopic-correcting lenses is based on a targeted average pupil diameter of a population of myopes; and
   the second add zone diameter for each of the plurality of hyperopic-correcting lenses is based on the targeted average pupil diameter of a population of hyperopes.
18. The contact lens system of clause 1, wherein:
   the hyperopic power profile for each of the plurality of hyperopic-correcting lenses corresponds to a unique hyperopic refractive error correction;
   the second SPHA for each of the plurality of hyperopic-correcting lenses is dependent on its hyperopic refractive error correction.
19. The contact lens system of clause 18, wherein:
   the second SPHA for the plurality of hyperopic-correcting lenses becomes more negative as the hyperopic refractive error correction of the plurality of hyperopic-correcting lenses increases in diopter.
20. The contact lens system of clause 18, wherein:
   the second SPHA for the plurality of hyperopic-correcting lenses becomes more negative monotonically as the hyperopic refractive error correction of the plurality of hyperopic-correcting lenses increases in diopter.
21. The contact lens system of clause 18, wherein:
   the second SPHA for the plurality of hyperopic-correcting lenses becomes more negative linearly as the hyperopic refractive error correction of the plurality of hyperopic-correcting lenses increases in diopter.
22. The contact lens system of clause 18, wherein:
   for each of the plurality of myopic-correcting lenses:
      the first add optical zone is disposed around a first optical axis; and
      the first SPHA is a spherical aberration in the myopic power profile is a function of radius relative to first optical axis;
   for each of the plurality of hyperopic-correcting lenses:
      the second add optical zone is disposed around a second optical axis; an
      the second SPHA is a spherical aberration in the hyperopic power profile is a function of radius relative to second optical axis;
   the first SPHA of each of the plurality of myopic-correcting lenses is between −0.064 diopter (D)/millimeter (mm)² and −0.096 D/mm².
   the second SPHA of each of the plurality of hyperopic-correcting lenses is between −0.053 D/mm² and −0.146 D/mm².
23. The contact lens system of clause 18, wherein for each of the plurality of hyperopic-correcting lenses:
   the second SPHA is dependent on its hyperopic refractive error correction as follows:
      a. low-add lens: SPHA in D/mm²=−0.003972*Rx−0.1118, where Rx is in diopters.
      b. mid-add lens: SPHA in D/mm²=−0.003884*Rx−0.0902, where Rx is in diopters.
      c. high-add lens: SPHA in D/mm²=−0.009384*Rx−0.0638, where Rx is in diopters.
24. The contact lens system of clause 18, wherein:
   the myopic power profile for each of the plurality of myopic-correcting lenses corresponds to a unique myopic refractive error correction; and
   the first SPHA for each of the plurality of myopic-correcting lenses is dependent on its myopic refractive error correction.
25. The contact lens system of clause 24, wherein:
   the first SPHA for the plurality of myopic-correcting lenses becomes more negative as the myopic refractive error correction of the plurality of myopic-correcting lenses increases in diopter.
26. The contact lens system of clause 25, wherein:
   the first SPHA for the plurality of myopic-correcting lenses that have a myopic refractive error correction of −2.5 diopters (D) or greater becomes more negative as the myopic refractive error correction of the plurality of myopic-correcting lenses increases in diopter.
27. The contact lens system of clause 25, wherein:
   the first SPHA for the plurality of myopic-correcting lenses becomes more negative monotonically as the myopic refractive error correction of the plurality of myopic-correcting lenses increases in diopter.
28. The contact lens system of clause 25, wherein:
   the first SPHA for the plurality of myopic-correcting lenses becomes more negative linearly as the myopic refractive error correction of the plurality of myopic-correcting lenses increases in diopter.
29. The contact lens systems of clause 18, wherein:
   the plurality of myopic-correcting lenses comprise one or more myopic-correcting lenses having the myopic power profile comprising a first label add power;
   the plurality of hyperopic-correcting lenses comprise one or more hyperopic-correcting lenses having the hyperopic power profile that comprising the first label add power; and
   the first label add power of the one or more hyperopic-correcting lenses is reduced with respect to the first label add power of the one or more myopic-correcting lenses by between 0 diopters (D) and +0.65 D.
30. The contact lens systems of clause 29, wherein:
   a depth-of-focus (DOF) of the one or more hyperopic-correcting lenses is changed with respect to a DOF of the one or more myopic-correcting lenses by between +0.30 D and −0.20 D.
31. The contact lens systems of clause 18, wherein:
   the plurality of myopic-correcting lenses comprises:
      one or more low-add myopic-correcting lenses of the plurality of myopic-correcting lenses having the myopic power profile comprising a low-add label add power between +0.5 diopters (D) and +1.49 D;
      one or more mid-add myopic-correcting lenses of the plurality of myopic-correcting lenses having the myopic power profile comprising a mid-add label add power between +1.5 D and +1.99 D;
      one or more high-add myopic-correcting lenses of the plurality of myopic-correcting lenses having the myopic power profile comprising a mid-add label add power +2.0 D and +2.5 D;
   the plurality of hyperopic-correcting lenses comprises:
      one or more low-add hyperopic-correcting lenses of the plurality of hyperopic-correcting lenses having the hyperopic power profile comprising the low-add label add power;
      one or more mid-add hyperopic-correcting lenses of the plurality of hyperopic-correcting lenses having the hyperopic power profile comprising the mid-add label add power;
      one or more high-add hyperopic-correcting lenses of the plurality of hyperopic-correcting lenses having the hyperopic power profile comprising the high-add label add power;
   the low-add label add power of the one or more low-add hyperopic-correcting lenses is reduced with respect to the low-add label add power of the one or more low-add myopic-correcting lenses between 0 D and +0.15 D;
   the mid-add label add power of the one or more mid-add hyperopic-correcting lenses is reduced with respect to the mid-add label add power of the one or more mid-add myopic-correcting lenses between +0.20 D and +0.50 D; and
   the high-add label add power of the one or more mid-add hyperopic-correcting lenses is reduced with respect to the high-add label add power of the one or more mid-add myopic-correcting lenses between +0.40 D and +0.65 D.
32. The contact lens systems of clause 31, wherein:
   a low-add depth-of-focus (DOF) of the one or more low-add hyperopic-correcting lenses is changed with respect to a low-add DOF of the one or more low-add myopic-correcting lenses by between +0.15 D and −0.10 D;
   a mid-add DOF of the one or more mid-add hyperopic-correcting lenses is changed with respect to a mid-add DOF of the one or more mid-add myopic-correcting lenses by between +0.05 D and −0.20 D; and
   a high-add DOF of the one or more high-add hyperopic-correcting lenses is changed with respect to a high-add DOF of the one or more high-add myopic-correcting lenses by between +0.30 D and −0.20 D.
33. The contact lens system of clause 18, wherein:
   for each hyperopic-correcting lens of the plurality of hyperopic-correcting lenses: the second add optical zone has a second add zone diameter that is dependent on the hyperopic refractive error correction of the hyperopic-correcting lenses.
34. The contact lens system of clause 33, wherein:
   the second add zone diameter for the plurality of hyperopic-correcting lenses continues to decrease as the hyperopic refractive error correction of the plurality of hyperopic-correcting lenses increases in diopter.
35. The contact lens system of clause 34, wherein:
   the second add zone diameter for the plurality of hyperopic-correcting lenses continues to decrease monotonically as the hyperopic refractive error correction of the plurality of hyperopic-correcting lenses increases in diopter.
36. The contact lens system of clause 34, wherein:
   the second add zone diameter for the plurality of hyperopic-correcting lenses continues to decrease linearly as the hyperopic refractive error correction of the plurality of hyperopic-correcting lenses increases in diopter.
37. The contact lens system of clause 34, wherein:
   the myopic power profile comprises the first add zone power profile and the myopic progressive power profile;
   the myopic power profile for each of the plurality of myopic-correcting lenses corresponds to a unique myopic refractive error correction; and
   the first add zone diameter for each of the plurality of myopic-correcting lenses is dependent on its myopic refractive error correction.
38. The contact lens system of clause 37, wherein:
   the first add zone diameter for the plurality of myopic-correcting lenses continues to increase as the myopic refractive error correction of the plurality of myopic-correcting lenses increases in diopter.
39. The contact lens system of clause 33, wherein:
   the second add zone diameter for each of plurality of hyperopic-correcting lenses is between 0 mm and 0.73 mm.
40. The contact lens system of clause 1, wherein:
   the first add optical zone comprises a first center-near add optical zone; and
   the second add optical zone comprises a second center-near add optical zone.
41. The contact lens system of clause 1, wherein:
   the plurality of myopic-correcting lenses each further comprise:
      a first distance optical zone surrounding the first transitional optical zone, the first distance optical zone having a myopic distance power profile; and
   the plurality of hyperopic-correcting lenses each further comprise:
      a second distance optical zone surrounding the second transitional optical zone, the second distance optical zone having a hyperopic distance power profile.
42. A contact lens system, comprising:
   a plurality of myopic-correcting lenses, each having a myopic power profile and each comprising:
      a first add optical zone of a first add zone diameter, the first add optical zone having a first add zone power profile comprising a myopic paraxial power selected to substantially correct myopic refractive error and a first add power; and
      a first transitional optical zone surrounding the first add optical zone, the first transitional optical zone having a myopic progressive power profile; and
   a plurality of hyperopic-correcting lenses, each having a hyperopic power profile and each comprising:
      a second add optical zone of a second add zone diameter, the second add optical zone having a second add zone power profile comprising a hyperopic paraxial power selected to substantially correct hyperopic refractive error and a second add power; and
      a second transitional optical zone surrounding the second add optical zone, the second transitional optical zone having a hyperopic progressive power profile; and
   wherein the second add zone diameter is at least 2% less than the first add zone diameter.
43. The contact lens system of clause 42, wherein:
   the first add zone diameter for each of the plurality of myopic-correcting lenses is based on a targeted average pupil diameter of a population of myopes; and
   the second add zone diameter for each of the plurality of hyperopic-correcting lenses is based on the targeted average pupil diameter of a population of hyperopes.
44. The contact lens system of clause 42, wherein:
   at least one of the plurality of myopic-correcting lenses has the respective myopic power profile providing a first label add power of at least +1.5 diopter (D);
   at least one of the plurality of myopic-correcting lenses has the respective hyperopic power profile providing the first label add power; and
   the second add power of the at least one of the plurality of hyperopic-correcting lenses is at least +0.2 D less than the first add power of the at least one of the plurality of myopic-correcting lenses.
45. The contact lens system of clause 44, wherein:
   the at least one of the plurality of myopic-correcting lenses comprises:
      one or more mid-add power myopic-correcting lenses comprises the respective myopic power profile providing a mid-add label add power between +1.5 diopters (D) and +1.99 D;
      one or more high-add power myopic-correcting lenses comprises the respective myopic power profile providing a high-add label add power between +2.0 D and +2.5 D;
   the at least one of the plurality of hyperopic-correcting lenses comprises:
      one or more mid-add power hyperopic-correcting lenses comprises the respective hyperopic power profile providing the mid-add label add power;
      one or more high-add power hyperopic-correcting lenses comprises the respective hyperopic power profile providing the high-add label add power;
   the second add power of the one or more mid-add power hyperopic-correcting lenses is at least 0.2 D less than the first add power of the one or more mid-add power myopic-correcting lenses; and
   the second add power of the one or more high-add power hyperopic-correcting lenses is at least 0.2 D less than the first add power of the one or more high-add power myopic-correcting lenses.
46. The contact lens system of clause 45, wherein:
   the second add power of the one or more mid-add power hyperopic-correcting lenses is at least +0.3 D diopters less than the first add power of the one or more mid-add power myopic-correcting lenses.
47. The contact lens system of clause 42, wherein:
   the second add zone diameter for each of the plurality of hyperopic-correcting lenses is the same.
48. The contact lens system of clause 42, wherein:
   the first add zone diameter for each of the plurality of myopic-correcting lenses is between 0 and 0.78 millimeters (mm); and
   the second add zone diameter for each of plurality of hyperopic-correcting lenses is between 0 and 0.73 mm.
49. The contact lens system of clause 42, wherein:
   the hyperopic power profile comprises the second add zone power profile and the hyperopic progressive power profile;
   the hyperopic power profile for each of the plurality of hyperopic-correcting lenses corresponds to a unique hyperopic refractive error correction; and
   the second add zone diameter for each of the plurality of hyperopic-correcting lenses is dependent on its hyperopic refractive error correction.
50. The contact lens system of clause 49, wherein:
   the second add zone diameter for the plurality of hyperopic-correcting lenses continues to decrease as the hyperopic refractive error correction of the plurality of hyperopic-correcting lenses increases in diopter.
51. The contact lens system of clause 50, wherein:
   the second add zone diameter for the plurality of hyperopic-correcting lenses continues to decrease monotonically as the hyperopic refractive error correction of the plurality of hyperopic-correcting lenses increases in diopter.
52. The contact lens system of clause 50, wherein:
   the second add zone diameter for the plurality of hyperopic-correcting lenses continues to decrease linearly as the hyperopic refractive error correction of the plurality of hyperopic-correcting lenses increases in diopter.
53. The contact lens system of clause 49, wherein:
   the myopic power profile comprises the first add zone power profile and the myopic progressive power profile;
   the myopic power profile for each of the plurality of myopic-correcting lenses corresponds to a unique myopic refractive error correction; and
   the first add zone diameter for each of the plurality of myopic-correcting lenses is dependent on its myopic refractive error correction.
54. The contact lens system of clause 53, wherein:
   the first add zone diameter for the plurality of myopic-correcting lenses continues to increase as the myopic refractive error correction of the plurality of myopic-correcting lenses increases in diopter.
55. The contact lens system of clause 53, wherein:
   the first add zone diameter for the plurality of myopic-correcting lenses continues to increase monotonically as the myopic refractive error correction of the plurality of myopic-correcting lenses increases in diopter.
56. The contact lens system of clause 55, wherein:
   the first add zone diameter for the plurality of myopic-correcting lenses continues to increase linearly as the myopic refractive error correction of the plurality of myopic-correcting lenses increases in diopter.
57. The contact lens system of clause 49, wherein:
   the first add zone diameter for each of the plurality of myopic-correcting lenses is between 0 and 0.78 millimeters (mm); and
   the second add zone diameter for each of plurality of hyperopic-correcting lenses is between 0 mm and 0.73 mm.
58. The contact lens system of clause 42, wherein:
   the first add optical zone comprises a first center-near add optical zone; and
   the second add optical zone comprises a second center-near add optical zone.
59. The contact lens system of clause 42, wherein:
   the plurality of myopic-correcting lenses each further comprise:
      a first distance optical zone surrounding the first transitional optical zone, the first distance optical zone having a myopic distance power profile; and
   a plurality of hyperopic-correcting lenses each further comprise:
      a second distance optical zone surrounding the second transitional optical zone, the second distance optical zone having a hyperopic distance power profile.
60. A contact lens system, comprising:
   a plurality of hyperopic-correcting lenses each having a hyperopic power profile and each comprising:
      a second add optical zone having a second add zone power profile comprising a hyperopic paraxial power selected to substantially correct hyperopic refractive error and a second add power;
      a second transitional optical zone surrounding the second add optical zone, the second transitional optical zone having a hyperopic progressive power profile; and
      the hyperopic power profile comprising the second add zone power profile and the hyperopic progressive power profile, the hyperopic power profile having a second SPHA;
   wherein:
      the hyperopic power profile for each of the plurality of hyperopic-correcting lenses corresponds to a unique hyperopic refractive error correction; and
      the second SPHA for each of the plurality of hyperopic-correcting lenses is dependent on its hyperopic refractive error correction.
61. The contact lens system of clause 60, wherein:
   the second SPHA of each of the plurality of hyperopic-correcting lenses is between ten percent (10%) and twenty percent (20%) less than the first SPHA of each of the plurality of myopic-correcting lenses.
62. The contact lens system of clause 60, wherein:
   the second SPHA of each of the plurality of hyperopic-correcting lenses is targeted to an average second ocular SPHA of a population of hyperopes.
63. The contact lens system of clause 60, wherein:
   the second SPHA for the plurality of hyperopic-correcting lenses becomes more negative as the hyperopic refractive error correction of the plurality of hyperopic-correcting lenses increases in diopter.
64. The contact lens system of clause 60, wherein:
   the second SPHA for the plurality of hyperopic-correcting lenses becomes more negative monotonically as the hyperopic refractive error correction of the plurality of hyperopic-correcting lenses increases in diopter.
65. The contact lens system of clause 60, wherein:
   the second SPHA for the plurality of hyperopic-correcting lenses becomes more negative linearly as the hyperopic refractive error correction of the plurality of hyperopic-correcting lenses increases in diopter.
66. The contact lens system of clause 60, wherein:
   for each of the plurality of hyperopic-correcting lenses:
      the second add optical zone is disposed around a second optical axis; an
      the second SPHA is a spherical aberration in the hyperopic power profile is a function of radius relative to second optical axis; and
   the second SPHA of each of the plurality of hyperopic-correcting lenses is between −0.053 D/mm² and −0.146 D/mm².
67. The contact lens system of clause 60, wherein for each of the plurality of hyperopic-correcting lenses:
   the second SPHA is dependent on its hyperopic refractive error correction as follows:
   d. low-add lens: SPHA in D/mm²=−0.003972*Rx−0.1118, where Rx is in diopters.
   e. mid-add lens: SPHA in D/mmz=−0.003884*Rx−0.0902, where Rx is in diopters.
   f. high-add lens: SPHA in D/mm²=−0.009384*Rx−0.0638, where Rx is in diopters.
68. The contact lens system of clause 60, wherein:
   for each hyperopic-correcting lens of the plurality of hyperopic-correcting lenses:
      the second add optical zone has a second add zone diameter that is dependent on the hyperopic refractive error correction of the hyperopic-correcting lenses.
69. The contact lens system of clause 68, wherein:
   the second add zone diameter for the plurality of hyperopic-correcting lenses continues to decrease as the hyperopic refractive error correction of the plurality of hyperopic-correcting lenses increases in diopter.
70. The contact lens system of clause 69, wherein:
   the second add zone diameter for the plurality of hyperopic-correcting lenses continues to decrease monotonically as the hyperopic refractive error correction of the plurality of hyperopic-correcting lenses increases in diopter.
71. The contact lens system of clause 69, wherein:
   the second add zone diameter for the plurality of hyperopic-correcting lenses continues to decrease linearly as the hyperopic refractive error correction of the plurality of hyperopic-correcting lenses increases in diopter.
72. The contact lens system of clause 60, wherein:
   the second add zone diameter for each of plurality of hyperopic-correcting lenses is between 0 mm and 0.73 mm.
73. The contact lens system of clause 60, wherein:
   for each of the plurality of hyperopic-correcting lenses:
      the second add optical zone is disposed around a second optical axis; and
   the plurality of hyperopic-correction lenses each have the comprised from the group consisting of:
      a low-add hyperopic power profile comprising:
         the second add optical zone comprising a second, low-add add optical zone diameter having second, low-add add optical zone diameter between 0 and 0.23 mm; and
         the second transitional optical zone comprising:
         a first, second low-add transitional optical zone having a first radius relative to the second optical axis between 0.23 and 0.44 mm, and the second add power between +0.002 diopter (D) and +0.003 D;
         a second, second low-add transitional optical zone having a second radius relative to the second optical axis between 0.44 mm and 0.67 mm, and the second add power between +0.0005 D and +0.001 D;
         a third, second low-add transitional optical zone having a second radius relative to the second optical axis between 0.67 mm and 2.0 mm, and the second add power between +0.0005 D and +0.001 D; and
         a second low-add final, distance optical zone extrapolated paraxial power of between +0.336 D and +0.537 D relative to paraxial power of the refractive need;
      a mid-add hyperopic power profile comprising:
         the second add optical zone comprising a second, mid-add add optical zone diameter having second, mid-add add optical zone diameter between 0 mm and 0.73 mm; and
         the second transitional optical zone comprising:
         a first, second mid-add transitional optical zone having a first radius relative to the second optical axis between 0.73 mm and 0.98 mm, and the second add power between +0.343 D and +0.425 D;
         a second, second mid-add transitional optical zone having a second radius relative to the second optical axis between 0.98 mm and 1.38 mm, and the second add power between +0.262 D and +0.344 D; and
         a third, second mid-add transitional optical zone having a second radius relative to the second optical axis between 1.38 mm and 2.0 mm, and the second add power between +0.060 and +0.142 D; and
         a second mid-add final, distance optical zone extrapolated paraxial power of between +0.259 D and +0.460 D relative to the paraxial power of the refractive need; and
      a high-add hyperopic power profile comprising:
         the second add optical zone comprising a second, high-add add optical zone diameter having second, high-add add optical zone diameter between 0 mm and 0.59 mm; and
         the second transitional optical zone comprising:
         a first, second high-add transitional optical zone having a first radius relative to the second optical axis between 0.59 mm and 0.87 mm, and the second add power between +0.845 D and +1.045 D;
         a second, second high-add transitional optical zone having a second radius relative to the second optical axis between 0.87 mm and 1.33 mm, and the second add power between +0.646 D and +0.846 D; and
         a third, second high-add transitional optical zone having a second radius relative to the second optical axis between 1.33 mm and 2.0 mm, and the second add power between +0.149 D and +0.349 D; and
         a second high-add final, distance optical zone extrapolated paraxial power of between +0.428 D and +0.629 D relative to the paraxial power of the refractive need.
74. The contact lens system of clause 60, wherein the second add optical zone comprises a second center-near add optical zone.
75. The contact lens system of clause 60, wherein:
   the plurality of hyperopic-correcting lenses each further comprise:
      a second distance optical zone surrounding the second transitional optical zone, the second distance optical zone having a hyperopic distance power profile.
76. A contact lens system, comprising:
   a plurality of hyperopic-correcting lenses, each having a hyperopic power profile and each comprising:
      a second add optical zone having a second add-zone diameter and a second add zone power profile comprising a hyperopic paraxial power selected to substantially correct hyperopic refractive error and a second add power; and
      a second transitional optical zone surrounding the second add optical zone, the second transitional optical zone having a hyperopic progressive power profile;
   wherein:
      the hyperopic power profile for each of the plurality of hyperopic-correcting lenses corresponds to a unique hyperopic refractive error correction; and
      the second add-zone diameter for each of the plurality of hyperopic-correcting lenses is dependent on its hyperopic refractive error correction.
77. The contact lens system of clause 76, wherein:
   the second add zone diameter for each of the plurality of hyperopic-correcting lenses is based on the targeted average pupil diameter of a population of hyperopes.
78. The contact lens system of clause 76, wherein:
   the second add zone diameter for the plurality of hyperopic-correcting lenses continues to decrease as the hyperopic refractive error correction of the plurality of hyperopic-correcting lenses increases in diopter.
79. The contact lens system of clause 78, wherein:
   the second add zone diameter for the plurality of hyperopic-correcting lenses continues to decrease monotonically as the hyperopic refractive error correction of the plurality of hyperopic-correcting lenses increases in diopter.
80. The contact lens system of clause 78, wherein:
   the second add zone diameter for the plurality of hyperopic-correcting lenses continues to decrease linearly as the hyperopic refractive error correction of the plurality of hyperopic-correcting lenses increases in diopter.
81. The contact lens system of clause 76, wherein:
   the second add zone diameter for each of plurality of hyperopic-correcting lenses is between 0 mm and 0.73 mm.
82. The contact lens system of clause 76, wherein:
   for each of the plurality of hyperopic-correcting lenses:
      the second add optical zone is disposed around a second optical axis; and
   the plurality of hyperopic-correction lenses each have the comprised from the group consisting of:
      a low-add hyperopic power profile comprising:
         the second add optical zone comprising a second, low-add add optical zone diameter having second, low-add add optical zone diameter between 0 and 0.23 mm; and
         the second transitional optical zone comprising:
         a first, second low-add transitional optical zone having a first radius relative to the second optical axis between 0.23 and 0.44 mm, and the second add power between +0.002 diopter (D) and +0.003 D;
         a second, second low-add transitional optical zone having a second radius relative to the second optical axis between 0.44 mm and 0.67 mm, and the second add power between +0.0005 D and +0.001 D;
         a third, second low-add transitional optical zone having a second radius relative to the second optical axis between 0.67 mm and 2.0 mm, and the second add power between +0.0005 D and +0.001 D; and
         a second low-add final, distance optical zone extrapolated paraxial power of between +0.336 D and +0.537 D relative to paraxial power of the refractive need;
      a mid-add hyperopic power profile comprising:
         the second add optical zone comprising a second, mid-add add optical zone diameter having second, mid-add add optical zone diameter between 0 mm and 0.73 mm; and
         the second transitional optical zone comprising:
         a first, second mid-add transitional optical zone having a first radius relative to the second optical axis between 0.73 mm and 0.98 mm, and the second add power between +0.343 D and +0.425 D;
         a second, second mid-add transitional optical zone having a second radius relative to the second optical axis between 0.98 mm and 1.38 mm, and the second add power between +0.262 D and +0.344 D; and
         a third, second mid-add transitional optical zone having a second radius relative to the second optical axis between 1.38 mm and 2.0 mm, and the second add power between +0.060 and +0.142 D; and
         a second mid-add final, distance optical zone extrapolated paraxial power of between +0.259 D and +0.460 D relative to the paraxial power of the refractive need; and
      a high-add hyperopic power profile comprising:
         the second add optical zone comprising a second, high-add add optical zone diameter having second, high-add add optical zone diameter between 0 mm and 0.59 mm; and
         the second transitional optical zone comprising:
         a first, second high-add transitional optical zone having a first radius relative to the second optical axis between 0.59 mm and 0.87 mm, and the second add power between +0.845 D and +1.045 D;
         a second, second high-add transitional optical zone having a second radius relative to the second optical axis between 0.87 mm and 1.33 mm, and the second add power between +0.646 D and +0.846 D; and
         a third, second high-add transitional optical zone having a second radius relative to the second optical axis between 1.33 mm and 2.0 mm, and the second add power between +0.149 D and +0.349 D; and
         a second high-add final, distance optical zone extrapolated paraxial power of between +0.428 D and +0.629 D relative to the paraxial power of the refractive need.
83. The contact lens system of clause 76, wherein:
   the first add optical zone comprises a first center-near add optical zone; and
   the second add optical zone comprises a second center-near add optical zone.
84. The contact lens system of clause 76, wherein:
   the plurality of myopic-correcting lenses each further comprise:
      a first distance optical zone surrounding the first transitional optical zone, the first distance optical zone having a myopic distance power profile; and
   the plurality of hyperopic-correcting lenses each further comprise:
      a second distance optical zone surrounding the second transitional optical zone, the second distance optical zone having a hyperopic distance power profile.

What is claimed is:

1. A contact lens system, comprising:
a plurality of myopic-correcting lenses, each having a myopic power profile and each comprising:
a first add optical zone having a first add zone power profile comprising a myopic paraxial power selected to substantially correct myopic refractive error and a first add power; and
a first transitional optical zone surrounding the first add optical zone, the first transitional optical zone having a myopic progressive power profile; and
the myopic power profile comprising the first add zone power profile and the myopic progressive power profile, the myopic power profile includes a first spherical aberration (SPHA); and
a plurality of hyperopic-correcting lenses, each having a hyperopic power profile and each comprising:
a second add optical zone having a second add zone power profile comprising a hyperopic paraxial power selected to substantially correct hyperopic refractive error and a second add power; and
a second transitional optical zone surrounding the second add optical zone, the second transitional optical zone having a hyperopic progressive power profile;
the hyperopic power profile comprising the second add zone power profile and the hyperopic progressive power profile, the hyperopic power profile having a second SPHA;
wherein the second SPHA of each of the plurality of hyperopic-correcting lenses is at least ten percent (10%) less than the first SPHA of each of the plurality of myopic-correcting lenses.

2. The contact lens system of claim 1, wherein:
the second SPHA of each of the plurality of hyperopic-correcting lenses is between ten percent (10%) and twenty percent (20%) less than the first SPHA of each of the plurality of myopic-correcting lenses.

3. The contact lens system of claim 1, wherein:
the first SPHA of each of the plurality of myopic-correcting lenses is targeted to an average first ocular SPHA of a population of myopes; and
the second SPHA of each of the plurality of hyperopic-correcting lenses is targeted to an average second ocular SPHA of a population of hyperopes.

4. The contact lens system of claim 3, wherein:
the first SPHA of each of the plurality of myopic-correcting lenses is a first residual SPHA from the first ocular SPHA for the targeted average SPHA of the population of myopes;
the second SPHA of each of the plurality of hyperopic-correcting lenses is a second residual SPHA from the second ocular SPHA for the targeted average SPHA of the population of hyperopes; and
the first residual SPHA is the second residual SPHA.

5. The contact lens system of claim 1, wherein:
at least one of the plurality of myopic-correcting lenses has the respective myopic power profile providing a first label add power of at least +1.5 diopter (D);
at least one of the plurality of hyperopic-correcting lenses has the respective hyperopic power profile providing the first label add power; and
the second add power of the at least one of the plurality of hyperopic-correcting lenses is at least +0.2 D less than the first add power of the at least one of the plurality of myopic-correcting lenses.

6. The contact lens system of claim 5, wherein:
the at least one of the plurality of myopic-correcting lenses comprises:
one or more mid-add power myopic-correcting lenses comprises the respective myopic power profile providing a mid-add label add power between +1.5 diopters (D) and +1.99 D;
one or more high-add power myopic-correcting lenses comprises the respective myopic power profile providing a high-add label add power between +2.0 and +2.5 D;
the at least one of the plurality of hyperopic-correcting lenses comprises:
one or more mid-add power hyperopic-correcting lenses comprises the respective hyperopic power profile providing the mid-add label add power;
one or more high-add power hyperopic-correcting lenses comprises the respective hyperopic power profile providing the high-add label add power;
the second add power of the one or more mid-add power hyperopic-correcting lenses is at least +0.2 D diopters less than the first add power of the one or more mid-add power myopic-correcting lenses; and
the second add power of the one or more high-add power hyperopic-correcting lenses is at least +0.2 D diopters less than the first add power of the one or more high-add power myopic-correcting lenses.

7. The contact lens system of claim 6, wherein:
the second add power of the one or more mid-add power hyperopic-correcting lenses is at least +0.3 D diopters less than the first add power of the one or more mid-add power myopic-correcting lenses.

8. The contact lens system of claim 1, wherein:
the second SPHA for each of the plurality of hyperopic-correcting lenses is the same.

9. The contact lens system of claim 1, wherein:
for each of the plurality of myopic-correcting lenses:
the first add optical zone is disposed around a first optical axis; and
the first SPHA is a spherical aberration in the myopic power profile is a function of radius relative to first optical axis;
for each of the plurality of hyperopic-correcting lenses:
the second add optical zone is disposed around a second optical axis; and
the second SPHA is a spherical aberration in the hyperopic power profile is a function of radius relative to second optical axis;
the first SPHA of each of the plurality of myopic-correcting lenses is between −0.064 diopter (D)/millimeter (mm)² (D/mm²) and −0.096 D/mm²; and
the second SPHA of each of the plurality of hyperopic-correcting lenses is between −0.073 D/mm² and −0.111 D/mm².

10. The contact lens systems of claim 1, wherein:
the plurality of myopic-correcting lenses comprise one or more myopic-correcting lenses having the myopic power profile comprising a first label add power;
the plurality of hyperopic-correcting lenses comprise one or more hyperopic-correcting lenses having the hyperopic power profile that comprising the first label add power;
the first label add power of the one or more hyperopic-correcting lenses is reduced with respect to the first label add power of the one or more myopic-correcting lenses by between 0 and +0.50 diopter (D).

11. The contact lens system of claim 10, wherein:
a depth-of-focus (DOF) of the one or more hyperopic-correcting lenses is changed with respect to a DOF of the one or more myopic-correcting lenses by between +0.05 D and −0.25 D.

12. The contact lens systems of claim 1, wherein:
the plurality of myopic-correcting lenses comprises:
one or more low-add myopic-correcting lenses of the plurality of myopic-correcting lenses having the myopic power profile comprising a low-add label add power between +0.5 diopter (D) and +1.49 D;
one or more mid-add myopic-correcting lenses of the plurality of myopic-correcting lenses having the myopic power profile comprising a mid-add label add power between +1.5 D and +1.99 D;
one or more high-add myopic-correcting lenses of the plurality of myopic-correcting lenses having the myopic power profile comprising a mid-add label add power between +2.0 D and +2.5 D diopters;
the plurality of hyperopic-correcting lenses comprises:
one or more low-add hyperopic-correcting lenses of the plurality of hyperopic-correcting lenses having the hyperopic power profile comprising the low-add label add power;
one or more mid-add hyperopic-correcting lenses of the plurality of hyperopic-correcting lenses having the hyperopic power profile comprising the mid-add label add power;
one or more high-add hyperopic-correcting lenses of the plurality of hyperopic-correcting lenses having the hyperopic power profile comprising the high-add label add power;
the low-add label add power of the one or more low-add hyperopic-correcting lenses is reduced with respect to the low-add label add power of the one or more low-add myopic-correcting lenses between 0 D and +0.15 D;
the mid-add label add power of the one or more mid-add hyperopic-correcting lenses is reduced with respect to the mid-add label add power of the one or more mid-add myopic-correcting lenses between +0.20 D and +0.50 D; and
the high-add label add power of the one or more mid-add hyperopic-correcting lenses is reduced with respect to the high-add label add power of the one or more mid-add myopic-correcting lenses between +0.15 D and −0.0.15 D.

13. The contact lens system of claim 1, wherein:
for each of the plurality of hyperopic-correcting lenses:
the second add optical zone is disposed around a second optical axis; and
the plurality of hyperopic-correction lenses each have the comprised from the group consisting of:
a low-add hyperopic power profile comprising:
the second add optical zone comprising a second, low-add add optical zone diameter having second, low-add add optical zone diameter between 0 and 0.23 mm; and
the second transitional optical zone comprising:
a first, second low-add transitional optical zone having a first radius relative to the second optical axis between 0.23 and 0.44 mm, and the second add power between +0.002 diopter (D) and +0.003 D;
a second, second low-add transitional optical zone having a second radius relative to the second optical axis between 0.44 mm and 0.67 mm, and the second add power between +0.0005 D and +0.001 D;
a third, second low-add transitional optical zone having a second radius relative to the second optical axis between 0.67 mm and 2.0 mm, and the second add power between +0.0005 D and +0.001 D; and
a second low-add final, distance optical zone extrapolated paraxial power of between +0.336 D and +0.537 D relative to paraxial power of the refractive need;
a mid-add hyperopic power profile comprising:
the second add optical zone comprising a second, mid-add add optical zone diameter having second, mid-add add optical zone diameter between 0 mm and 0.73 mm; and
the second transitional optical zone comprising:
a first, second mid-add transitional optical zone having a first radius relative to the second optical axis between 0.73 mm and 0.98 mm, and the second add power between +0.343 D and +0.425 D;
a second, second mid-add transitional optical zone having a second radius relative to the second optical axis between 0.98 mm and 1.38 mm, and the second add power between +0.262 D and +0.344 D; and
a third, second mid-add transitional optical zone having a second radius relative to the second optical axis between 1.38 mm and 2.0 mm, and the second add power between +0.060 and +0.142 D; and
a second mid-add final, distance optical zone extrapolated paraxial power of between +0.259 D and +0.460 D relative to the paraxial power of the refractive need; and
a high-add hyperopic power profile comprising:
the second add optical zone comprising a second, high-add add optical zone diameter having second, high-add add optical zone diameter between 0 mm and 0.59 mm; and
the second transitional optical zone comprising:
a first, second high-add transitional optical zone having a first radius relative to the second optical axis between 0.59 mm and 0.87 mm, and the second add power between +0.845 D and +1.045 D;
a second, second high-add transitional optical zone having a second radius relative to the second optical axis between 0.87 mm and 1.33 mm, and the second add power between +0.646 D and +0.846 D; and
a third, second high-add transitional optical zone having a second radius relative to the second optical axis between 1.33 mm and 2.0 mm, and the second add power between +0.149 D and +0.349 D; and
a second high-add final, distance optical zone extrapolated paraxial power of between +0.428 D and +0.629 D relative to the paraxial power of the refractive need.

14. The contact lens system of claim 13, wherein:
for each of the plurality of myopic-correcting lenses:
the first add optical zone is disposed around a first optical axis; and
the plurality of myopic-correction lenses each have the myopic power profile comprised from the group consisting of:
a low-add myopic power profile comprising:
the first add optical zone comprising a first, low-add add optical zone diameter having first, low-add add optical zone diameter between 0 mm and 0.23 mm; and
the first transitional optical zone comprising:
a first, first low-add transitional optical zone having a first radius relative to the first optical axis between 0.23 and 0.44 mm, and the first add power between +0.002 D and +0.003 D;
a second, first low-add transitional optical zone having a first radius relative to the first optical axis between 0.44 mm and 0.67 mm, and the first add power between +0.002 D and +0.003 D;
a third, first low-add transitional optical zone having a first radius relative to the first optical axis between 0.67 mm and 2.0 mm, and the first add power between +0.0005 D and +0.001 D; and
a first low-add final, distance optical zone extrapolated paraxial power of between +0.336 D and +0.537 D relative to paraxial power of the refractive need;
a mid-add myopic power profile comprising:
the first add optical zone comprising a first, mid-add add optical zone diameter having first, mid-add add optical zone diameter between 0 mm and 0.78 mm; and
the first transitional optical zone comprising:
a first, first mid-add transitional optical zone having a first radius relative to the first optical axis between 0.78 mm and 1.06 mm, and the first add power between +0.343 D and +0.425 D;
a first, first mid-add transitional optical zone having a first radius relative to the first optical axis between 1.06 mm and 1.49 mm, and the first add power between +0.262 D and +0.344 D; and
a third, first mid-add transitional optical zone having a first radius relative to the first optical axis between 1.49 mm and 2.0 mm, and the first add power between +0.060 and +0.142 D; and
a first mid-add final, distance optical zone extrapolated paraxial power of between +0.559 D and +0.760 D relative to the paraxial power of the refractive need; and
a high-add myopic power profile comprising:
the first add optical zone comprising a first, high-add add optical zone diameter having first, high-add add optical zone diameter between 0 mm and 0.64 mm; and
the first transitional optical zone comprising:
a first, first high-add transitional optical zone having a first radius relative to the first optical axis between 0.64 mm and 0.94 mm, and the first add power between +0.845 D and +1.045 D;
a first, first high-add transitional optical zone having a first radius relative to the first optical axis between 0.94 mm and 1.43 mm, and the first add power between +0.646 D and +0.846 D; and
a third, first high-add transitional optical zone having a first radius relative to the first optical axis between 1.43 mm and 2.0 mm, and the first add power between +0.149 D and +0.349 D; and
a first high-add final, distance optical zone extrapolated paraxial power of between +0.628 D and +0.828 D relative to the paraxial power of the refractive need.

15. The contact lens system of claim 1, wherein:
the hyperopic power profile for each of the plurality of hyperopic-correcting lenses corresponds to a unique hyperopic refractive error correction;
the second SPHA for each of the plurality of hyperopic-correcting lenses is dependent on its hyperopic refractive error correction.

16. The contact lens system of claim 15, wherein:
for each of the plurality of myopic-correcting lenses:
the first add optical zone is disposed around a first optical axis; and
the first SPHA is a spherical aberration in the myopic power profile is a function of radius relative to first optical axis;
for each of the plurality of hyperopic-correcting lenses:
the second add optical zone is disposed around a second optical axis; an
the second SPHA is a spherical aberration in the hyperopic power profile is a function of radius relative to second optical axis;
the first SPHA of each of the plurality of myopic-correcting lenses is between −0.064 diopter (D)/millimeter (mm)² and −0.096 D/mm².
the second SPHA of each of the plurality of hyperopic-correcting lenses is between −0.053 D/mm² and −0.146 D/mm².

17. The contact lens system of claim 15, wherein for each of the plurality of hyperopic-correcting lenses:
the second SPHA is dependent on its hyperopic refractive error correction as follows:
a. low-add lens: SPHA in D/mm²=−0.003972*Rx−0.1118, where Rx is in diopters.
b. mid-add lens: SPHA in D/mm²=−0.003884*Rx−0.0902, where Rx is in diopters.
c. high-add lens: SPHA in D/mm²=−0.009384*Rx−0.0638, where Rx is in diopters.

18. The contact lens systems of claim 15, wherein:
the plurality of myopic-correcting lenses comprise one or more myopic-correcting lenses having the myopic power profile comprising a first label add power;
the plurality of hyperopic-correcting lenses comprise one or more hyperopic-correcting lenses having the hyperopic power profile that comprising the first label add power; and
the first label add power of the one or more hyperopic-correcting lenses is reduced with respect to the first label add power of the one or more myopic-correcting lenses by between 0 diopters (D) and +0.65 D.

19. The contact lens systems of claim 18, wherein:
a depth-of-focus (DOF) of the one or more hyperopic-correcting lenses is changed with respect to a DOF of the one or more myopic-correcting lenses by between +0.30 D and −0.20 D.

20. The contact lens systems of claim 15, wherein:
the plurality of myopic-correcting lenses comprises:
one or more low-add myopic-correcting lenses of the plurality of myopic-correcting lenses having the myopic power profile comprising a low-add label add power between +0.5 diopters (D) and +1.49 D;
one or more mid-add myopic-correcting lenses of the plurality of myopic-correcting lenses having the myopic power profile comprising a mid-add label add power between +1.5 D and +1.99 D;
one or more high-add myopic-correcting lenses of the plurality of myopic-correcting lenses having the myopic power profile comprising a mid-add label add power+2.0 D and +2.5 D;
the plurality of hyperopic-correcting lenses comprises:
one or more low-add hyperopic-correcting lenses of the plurality of hyperopic-correcting lenses having the hyperopic power profile comprising the low-add label add power;
one or more mid-add hyperopic-correcting lenses of the plurality of hyperopic-correcting lenses having the hyperopic power profile comprising the mid-add label add power;
one or more high-add hyperopic-correcting lenses of the plurality of hyperopic-correcting lenses having the hyperopic power profile comprising the high-add label add power;
the low-add label add power of the one or more low-add hyperopic-correcting lenses is reduced with respect to the low-add label add power of the one or more low-add myopic-correcting lenses between 0 D and +0.15 D;
the mid-add label add power of the one or more mid-add hyperopic-correcting lenses is reduced with respect to the mid-add label add power of the one or more mid-add myopic-correcting lenses between +0.20 D and +0.50 D; and
the high-add label add power of the one or more mid-add hyperopic-correcting lenses is reduced with respect to the high-add label add power of the one or more mid-add myopic-correcting lenses between +0.40 D and +0.65 D.

21-29. (canceled)
